(19) United States
(12) Patent Application Publication
(10) Pub. No.: US 2008/0019367 A1
(43) Pub. Date: Jan. 24, 2008

(54) Communication Device, Communication Setting Method, Communication Setting Program And Recording Medium On Which Is Recorded A Communication Setting Program

(76) Inventors: Satoshi Ito, Nara (JP); Takeshi Kokado, Kyoto (JP)

Correspondence Address: WENDEROTH, LIND & PONACK L.L.P., 2033 K. STREET, NW, SUITE 800, WASHINGTON, DC, 20006, US

(21) Appl. No.: 11/597,813

(22) PCT Filed: Jun. 28, 2005
(86) PCT No.: PCT/JP05/11789

§ 371 Date: Nov. 28, 2006

(30) Foreign Application Priority Data
Jun. 30, 2004 (JP) 2004-194001
Jul. 27, 2004 (JP) 2004-218671
Mar. 23, 2005 (JP) 2005-083904

(51) Int. Cl. H04L 12/56

(52) U.S. Cl. 370/392

(57) ABSTRACT

It is an object of the present invention to provide a communication device capable of performing router settings even in a household home network comprising a plurality of routers in multiple stages. The present invention provides a communication device comprising internal address acquisition means for acquiring the internal address of each router, and external address acquisition means for acquiring the external address of each router, wherein external address acquisition means repeats the process of accessing a router based on the acquired internal address and acquiring the external address of the router, and internal address acquisition means repeats the process of acquiring the internal address of a router positioned more toward the wide area network than the router having such external address based on the external address acquired by external address acquisition means.

### TECHNICAL FIELD

The present invention relates to a communication device, communication setting method, communication setting program and recording medium on which is recorded a communication setting program for performing router settings for each equipment in a household or corporate local area network (“home network”).

### BACKGROUND ART

The information society has developed rapidly in recent years, and there are cases where within the configuration of a household or corporate local area network (LAN), a plurality of networks exist, including wired and wireless LANs. To connect such a plurality of networks, a plurality of routers may be needed that are connected to two networks and carry out routing.

In such a home network, settings for communication equipments and settings etc. for routers (also called network settings) are needed in cases where communication equipments are to be connected wirelessly or when enabling access from the Internet. There is the problem that executing such router settings requires specialized knowledge, and it is difficult for general users to do.

Using an Internet Gateway Device (IGD) or other broadband router compatible with universal plug and play (UPnP) is known as a method for solving such a problem.

Further, Patent Document 1 (JP 2002-111665 A) is known as a method for obtaining the address of a router on a path in a network comprising a plurality of routers.

Further, Patent Document 2 discloses art for obtaining an address of a communication equipment connected in a state enabling communication with a router on a network comprising a plurality of routers. Each router in the network has path information. A communication device connected to a communication equipment via a router obtains such path information from a router, and obtains the address of a communication equipment not directly connected to itself.

Patent Document 1: JP 2002-111665 A

Patent Document 2: JP 2002-111668 A

### DISCLOSURE OF THE INVENTION

However, the above method of using UPnP is based on the assumption that the communication devices are connected via a single router in the home network. For this reason, the method of using UPnP cannot be applied to settings of a home network comprising multiple routers.

Further, in the method disclosed in Patent Document 1, a router's IP address can be learned, but information cannot be learned about the requestee for making settings with respect to a router (e.g., port, URL) for the purpose of router settings, and thus such method cannot be applied to a home network.

As discussed above, settings for home network comprising multiple routers are difficult. For example, even with a method as disclosed in document 2, in the case of a home network where a communication device and communication equipment are connected via multiple routers, the exchange of path information such as routing information protocol (RIP) used between home routers does not work effectively. For this reason, it is difficult for a communication device to obtain communication equipment path information from routers within a home network.

The present invention was conceived in light of the above problems, and it is an object of the present invention to provide, for a home network comprising multiple routers, a communication device, a communication setting method, a communication setting program and a recording medium on which is recorded a communication setting program, for enabling a communication device to make router settings.

It is a further object of the present invention to provide, in a home network comprising multiple routers, a communication device, a communication setting method, a communication setting program and a recording medium on which is recorded a communication setting program, for enabling the configuration of communication equipments connected to each router to be learned.

To solve the above problems, a first aspect of the present invention provides a communication device in a home network connected to a wide area network and comprising a plurality of routers connected in multiple stages. Such a communication device comprises the following constitutional elements.
internal address acquisition means for acquiring a router home network address (“internal address”);
external address acquisition means for acquiring a router wide area network address (“external address”).

External address acquisition means repeats the process of accessing a router based on the internal address that internal address acquisition means has acquired, and acquiring the external address of such router, and internal address acquisition means repeats the process of acquiring, based on the external address acquired by external address acquisition means, the internal address of a router positioned more toward the wide area network than the router having said external address.

With such a configuration, based on a router external address, the internal address of a router more toward the wide area network than the router is acquired to learn the router configuration. As a result, router configuration can be learned without preparing router discovery packets in which the allowed hop count number is varied or transmitting the prepared packets into a home network.

Further, because there is no forwarding of router discovery packets in which the allowed hop count number has been varied, even when a home network comprises a router that does not decrement the allowed hop count number when forwarding a router discovery packet, the home network router configuration can be learned. Further, because there is no receiving of a router response packet in response to a router discovery packet, even when a router that filters a router response packet is included, the home network router configuration can be learned.

More specifically, to a first router directly connected to a communication device, a router discovery packet in which the allowed hop count number is set at 1 is transmitted. A router response packet having the internal address of the first router is transmitted from the first router in response thereto. The communication device acquires the internal address of the first router from the router response packet. Further, the communication device executes Get External IP Address with respect to the first router to acquire the external address of the first router. Next, the communication device acquires the internal address of a second router positioned more toward the wide area network based on the external address of the first router. Then, the communication device accesses the second router using the acquired internal address to acquire the external address. With repetition of the foregoing, the home network router configuration can be learned.

A second aspect of the present invention provides a communication device according to the first aspect of the invention, further comprising router discovery packet preparation means for preparing a router discovery packet wherein the allowed hop count number is a variable; router discovery packet transmission means for transmitting the router discovery packet so as to pass through a plurality of routers in the home network; router response packet reception means for receiving, in response to the router discovery packet, a plurality of router response packets having the respective router addresses from the plurality of routers; and router address acquisition means for extracting the respective router address from the router response packet.

A router receives a router discovery packet from the communication device. Here, the router discovery packet is set so that the allowed hop count number is a variable. The router having received a router discovery packet transmits a router discovery packet to a router positioned more toward the wide area network. The router then decrements the set allowed hop count number by one and transmits the router discovery packet to the next connected router. A router stops transmitting the router discovery packet to the wide area network when the allowed hop count number is “0” and transmits a router response packet to the communication device that is the router discovery packet source. Through reception of such router response packet, the communication device can easily learn the home network router configuration. Thus, the communication device is capable of easily learning router configuration not only by internal and external address acquisition means but also by transmission of a router discovery packet in which the allowed hop count number is a variable.

When a method for learning the router configuration by changing the allowed hop count number is used, there may be a case where router configuration cannot be accurately learned if there is a router that does not decrement the allowed hop count number or a router that filters a router response packet. However, such problem can be solved when using both a method for learning router configuration by using a variable as the allowed hop count number and a method for learning router configuration by internal and external address acquisition means. The problem can be also solved by, for example, the following methods.

First, it is preferable that router response packet reception means further determine whether a router response packet has been received corresponding to the allowed hop count number set by router discovery packet preparation means; router address acquisition means further comprises external address acquisition means for, when determination is made that router response packet reception means has not received a router response packet, extracting a router internal address from the router response packet corresponding to the maximum allowed hop count number from among the received router response packets, and accessing a router based on the extracted internal address to acquire the external address thereof; and based on the external address that external address acquisition means has acquired, router address acquisition means repeatedly acquires the internal address of routers positioned more toward the wide area network than the router having the external address, and outputs the acquired internal addresses to relay information setting means.

The communication device is configured such that the allowed hop count number is set as a variable and router discovery packets are sequentially transmitted and router response packets are sequentially received from routers, thereby allowing high-speed router address acquisition. Meanwhile, when a router response packet has not been received, the communication device extracts an internal address from the router response packets that have been received in the same manner as above. Based on the extracted internal address, the external address of the router is acquired. Further, the communication device repeats the process of acquiring, based on an acquired external address, the internal address of routers more toward the wide area network. With such a constitution, even in a home network comprising a router that forwards a router discovery packet to a subsequent router without decrementing the allowed hop count number, or a router that filters a router response packet from a router, the home network router configuration can be learned, enabling relay information settings to be made.

Secondly, in a preferable configuration, there is further provided comparison means for comparing internal and external addresses; router discovery packet preparation means prepares a first router discovery packet for causing a first router to respond and having the allowed hop count number set at 1, and a second router discovery packet for causing a second router positioned more toward the wide area network than the first router to respond and having the allowed hop count number incremented by 1; router response packet reception means receives a first router response packet corresponding to the first router discovery packet and a second router response packet corresponding to the second router discovery packet; router address acquisition means extracts a first internal address from the first router response packet, and extracts a second internal address from the second router response packet; external address acquisition means accesses a router based on the first internal address to acquire a first external address of the router; comparison means compares the second internal address and first external address; when comparison means determines that there is inconsistency between the two address spaces, based on the first external address acquired corresponding to the first value of the allowed hop count number, router address acquisition means acquires a third internal address of a router positioned more toward the wide area network than the router having the external address; external address acquisition means accesses a router based on the third internal address to acquire a third external address of the router; and comparison means compares the second internal address and third external address to determine whether there is inconsistency between the two address spaces; by repetition of the foregoing processes, the internal addresses of routers existing between the first router and second router are acquired and each acquired internal address is output to processing requestee acquisition means.

In such manner, determination is made of match/non-match between an internal address extracted from the router response packet and the external address acquired based on the internal address of a prior stage router, thereby determining validity of the internal address extracted from the router response packet. Where there is match, it can be confirmed that the internal address extracted from the router response packet is the correct address for the communication device to access the router. As a result, even when a home network comprises a router that forwards a router discovery packet to a subsequent router without decrementing the allowed hop count number, the communication device is capable of learning the home network router configuration and making relay information settings.

A third aspect of the present invention provides a communication device according to the first aspect of the invention, further comprising relay information setting means for accessing a router based on an acquired internal address to perform relay information settings for relaying communications with another communication device connected via routers connected in multiple stages.

The communication device acquires router internal address from a router response packet, and accesses a router based on the internal address to perform relay information settings and acquire the external address. As a result, relay information settings can be performed for each router on the home network.

A fourth aspect of the present invention provides a communication device according to the first aspect of the invention, further comprising second determination means for determining whether an external address newly acquired by external address acquisition means is a global address which is the external address of a gateway connecting the home network and wide area network, wherein when the external address is a global address, internal address acquisition means stops newly acquiring internal addresses, and external address acquisition means stops newly acquiring external addresses.

In this case, settings can be performed only for routers existing in the domestic home network.

A fifth aspect of the present invention provides a communication device according to the first aspect of the invention, wherein internal address acquisition means prepares as a router internal address a test address constituting an external address acquired by external address acquisition means partially changed; and external address acquisition means accesses a router positioned more toward the wide area network than the router having the external address based on the test address to acquire the external address of the router.

By changing an acquired router external address, a communication device can effectively acquire the internal address of a router positioned more toward the wide area network.

It is preferable that internal address acquisition means prepare the test address by substituting the lowest significant 8 bits of the external address that external address acquisition means has acquired with a specific value.

Generally, many commercial routers are configured such that the lowest significant 8 bits of the internal address is set at “1” or “254” as a default setting. Further, even when a user changes the setting, it is often set at a specific value such as 64, 128 or the like. Therefore, by trying to access a router using an address starting from such a test address having such a specific value, high-speed acquisition of a router address can be performed.

A sixth aspect of the present invention provides a communication device according to the first aspect of the invention, further comprising equipment discovery packet preparation means for preparing an equipment discovery packet for detecting a communication equipment connected to any given router based on an acquired external address; equipment discovery packet transmission means for transmitting the equipment discovery packet to at least one communication equipment; equipment response packet reception means for receiving, in response to the device discovery packet, from at least one communication equipment an response packet having an address of the communication equipment; and equipment address acquisition means for extracting an equipment address from the equipment response packet.

It will be appreciated that the communication device is capable of easily learning the router configuration in a home network, without preparing a router discovery packet in which the allowed hop count number has been changed or transmitting the same to the home network. Further, the communication device is capable of acquiring an address of a communication equipment connected to a router. Therefore, the communication device is capable of learning the configuration of communication equipments connected to a router even in a home network comprising multiple routers.

A seventh aspect of the present invention provides a communication device according to the sixth aspect of the invention, further comprising communication setting means for accessing a communication equipment based on an extracted equipment address to perform settings for communicating with the communication equipment at either the communication equipment or own communication device.

The communication device, even in a home network constituting multiple routers, performs various settings for accessing the communication equipment and relaying the communications thereof.

An eighth aspect of the present invention provides a communication device according to the sixth aspect of the invention, further comprising an equipment learning unit for accessing a communication equipment based on the extracted equipment address to learn address and properties information of the communication equipment.

In this case, the type of communication equipment or the status thereof can be apprehended from the communication equipment address and properties.

A ninth aspect of the present invention provides a communication device according to the eighth aspect of the invention, further comprising a display for displaying address and property information of the communication equipment acquired by the equipment learning unit.

In this case, the acquired information of the router and communication equipment is displayed on the display, thereby facilitating user confirmation.

A tenth aspect of the present invention provides a communication device according to the first aspect of the invention in a first home network comprising a plurality of routers connected in multiple stages further comprising: a router configuration information transmission unit for transmitting router configuration information of some of the plurality of routers connected in multiple stages, including the router to which the communication device itself is connected, to another communication device in the first home network or another communication device in a second home network connected with the first home network via a wide area network; and a communication determination unit that receives router configuration information of other routers from among such plurality of routers from such another communication device, and based on its own communication device router configuration information and the received router configuration information, determines whether communications can be made with the other communication device, wherein router configuration information is based on the internal address acquired by internal address acquisition means and/or external address acquired by external address acquisition means of each communication device.

With this communication device, the router configuration can be learned even in a network comprising multiple routers, thereby enabling NAT and firewall settings and other communication path settings. With a communication path thus set, even when one or both of the communication devices is connected in a home network via multiple routers, P2P communication between communication devices can be made.

It will be appreciated that a preferable constitution further comprises router discovery packet preparation means for preparing a router discovery packet having a variable as the allowed hop count number, router discovery packet transmission means for transmitting the router discovery packet to a plurality of routers in the home network, router response packet reception means for receiving a plurality of router response packets each having a respective router address from the plurality of routers in response to the router discovery packets, and router address acquisition means for extracting the respective router address from a router response packet, wherein, based on the router addresses of the plurality of routers, the router configuration information acquisition unit acquires router configuration information of said some routers.

A router, having received a router discovery packet in which the allowed hop count number is a variable, transmits the router discovery packet toward the wide area network. At this time, the router transmits the router discovery packet to a subsequently connected router, having decremented the set allowed hop count number by 1. A router stops transmission of the router discovery packet toward the wide area network when the allowed hop count number becomes “0” and transmits a router response packet to the communication device that was the router discovery packet source. As a result, the communication device is capable of easily learning the home network router configuration. Therefore, the communication device is capable of accessing the learned routers to perform router settings so as to enable communications with another communication device connected via routers in multiple stages.

Further, it is preferable that there be provided internal address acquisition means for acquiring the home network address of each router (“internal address”), external address acquisition means for acquiring the wide area network address of each router (“external address”), and relay information setting means for accessing a router based on an acquired internal address to perform relay information settings for relaying communications with another communication device connected via routers connected in multiple stages, wherein external address acquisition means repeats the process of accessing a router based on the internal address that internal address acquisition means has acquired and acquiring a router external address, internal address acquisition means repeats the process of acquiring the internal address of a router positioned more toward the wide area network than the router having such external address based on the external address acquired by external address acquisition means, and based on the acquired internal and/or external addresses, the router configuration information acquisition unit acquires router configuration information of some of the routers.

With such a configuration, based on the external address of a router on the communication device side, the internal address of the router farther out on the home network is acquired to learn router configuration. As a result, router configuration can be acquired without preparing a router discovery packet in which the allowed hop count number has been changed, or transmitting the prepared packet to the home network.

Because there is no forwarding of a router discovery packet in which the allowed hop count number has been changed, even in a home network comprising a router not performing processing for decrementing the allowed hop count number when a router discovery packet is forwarded, the home network router configuration can be learned. Further, because there is no receiving of a router response packet in response to the router discovery packet, even when a router that filters a router response packet is included, the home network router configuration can be learned.

An 11^{th} aspect of the present invention provides a communication device according to the tenth aspect of the invention, further comprising relay information setting means for, based on the router configuration information, performing relay information settings for relaying communications with another communication device with respect to each router.

Relay information setting means accesses the learned router to perform relay information settings, thereby enabling the communication device to communicate with another communication device connected via routers connected in multiple stages.

A 12^{th} aspect of the present invention provides a communication device according to the 11^{th} aspect of the invention, wherein the router configuration information comprises router addresses constituting internal and/or external addresses of routers positioned between the communication device and the border router connecting networks at the border between the home network and wide area network; and the communication determination unit determines, in order, starting from router addresses more toward the wide area network, match/non-match between router addresses contained in its own router configuration information and router addresses contained in the router configuration information of another communication device, and comprises branch address extraction means for extracting the address at the branch point of communication paths at which non-match was initially determined, and the extracted branch address is used to determine whether communications can be made with the other communication device.

Determination is made as to whether communication path settings have been executed for the routers below the branch, thereby enabling determination as to whether communication can be made. Therefore, communications can be made with another communication device connected via routers connected in multiple stages.

A 13^{th} aspect of the present invention provides a communication device according to the 11^{th} aspect of the invention, wherein the router configuration information comprises router addresses constituting internal and/or external addresses of routers positioned between the communication device and the border router connecting networks at the border between the home network and wide area network; the communication determination unit determines in order, starting from router addresses more toward the wide area network, match/non-match between router addresses contained in its own router configuration information and router addresses contained in the router configuration information of another communication device, and comprises branch address extraction means for extracting an address at the branch point of communication paths at which non-match was initially determined, and branch address transmission means for transmitting the extracted branch address to relay information setting means; based on its own router configuration information, relay information setting means accesses the router corresponding to the branch address and a router positioned between such router and its own communication device and performs relay information settings; and branch address transmission means correlates relay information of the router corresponding to the branch address with such branch address and transmits the same to the other communication device performing communications.

Based on the router configuration information that router configuration information acquisition means has acquired, relay information setting means makes relay information settings with respect to each router for relaying communications with the other communication device; the router configuration information comprises router addresses of each router within the home network from the communication device to the border router at the network border connecting the home network and wide area network, and a port number set as relay information. Here, it is preferable that the communication determination unit determine in order, starting from a router address on the wide area network, match/non-match between router addresses contained in its own router configuration information and the router addresses contained in the router configuration information of the other communication device, comprise branch address extraction means for extracting the address, contained in the router configuration information of the other communication device, at the branch point of communication paths at which non-match was initially determined and a port number for relay information set for the router corresponding to the address, and using the address at the branch point and port number extracted by branch address extraction means perform communications with the other communication device.

With the above constitution, after router settings are made, a branch point can be found. Therefore, communications can be made with another communication device connected via routers connected in multiple stages.

A 14^{th} aspect of the present invention provides a communication device in a home network connected to a wide area network and comprising a plurality of routers connected in multiple stages. The communication device comprises the following constitutional elements:
router discovery packet preparation means for preparing a router discovery packet having a variable as the allowed hop count number;
router discovery packet transmission means for transmitting the router discovery packet so as to pass through the plurality of routers in the home network;
router response packet reception means for receiving, in response to router discovery packets, a plurality of router response packets each having a respective router address from the plurality of routers;
router address acquisition means for extracting router addresses from the router response packets; and
processing requestee acquisition means for accessing a router based on an extracted router address to acquire information of a processing requestee for performing relay information settings.

A router receives a router discovery packet in which the allowed hop count number has been set as a variable from a communication device. The router having received the router discovery packet transmits the router discovery packet toward a router positioned more toward the wide area network. At this time, the router transmits the router discovery packet to a subsequently connected router having decremented the set allowed hop count number by one. A router stops transmitting the router discovery packet to a wide area network when the allowed hop count number becomes “0” and transmits a router response packet to the communication device that is the router discovery packet source. Through receipt of such router response packet, a communication device is capable of easily learning the home network router configuration. Thus, the communication device is capable of accessing the router of the learned address to acquire requestee information for making router relay information settings (port number, URL or the like). The communication device can, for example, access a router based on acquired requestee information and make router settings so that communication can be made with another communication device connected via routers connected in multiple stages.

A specific explanation will be given of a case where, for example, the allowed hop count number is set at 1, 2. When a communication device transmits to a router a router discovery packet in which the allowed hop count number is set at 1, a router response packet having the internal address of a first router is transmitted from the first router directly connected to the communication device to the communication device. Here, the internal address is the home network address of a router, and the communication device is accessible to each router based on the internal address. Here, the communication device extracts the internal address of the first router from the router response packet, and accesses the first router based on the internal address to perform NAT settings. For example, NAT settings are performed with respect to port number of the communication device itself at time of access, IP address of the communication device, and port number of the first router.

Further, by transmission to a router of a router discovery packet in which the allowed hop count number has been set at 2, the communication device acquires the internal address of a second router from the communication device, connected via the first router. The communication device is also capable of accessing the second router to perform NAT settings. For example, NAT settings are performed with respect to the external address of the first router, the port number of the first router, the port number of the second router and the like. Here, Get External IP Address is executed with respect to the first router, thereby enabling acquisition of the external address of the first router. By means of the foregoing, router configuration in a home network comprising multiple routers can be learned. Further, based on the learned router configuration, communications can be established with another communication device connected via multiple routers.

A 15^{th} aspect of the present invention provides a communication device according to the 14^{th} aspect of the invention, comprising relay information setting means for making access based on the requestee information acquired by processing requestee acquisition means and performing relay information settings for relaying communications with another communication device connected via routers connected in multiple stages.

The communication device is capable of accessing a router based on the requestee information, and making relay information settings for routers in the home network.

A 16^{th} aspect of the present invention provides a communication device according to the 15^{th} aspect of the invention, wherein the router address is a home network address (“internal address”); there is further provided external address acquisition means for accessing a router based on the internal address and acquiring such router's wide area network address (“external address”); and router address acquisition means repeats the process of acquiring, based on the external address acquired by external address acquisition means, the internal address of a router positioned more toward the wide area network than the router having such external address and outputs the acquired internal address to processing requestee acquisition means.

The communication device is capable of acquiring a router internal address using a router discovery packet, or acquiring a router external address from the internal address of a router positioned in the home network, and then acquiring the internal address of a router positioned farther out on wide area network than such external address. As a result, the home network router configuration can be learned, and relay information settings can be made.

Further, when the external address and internal address are to be acquired in order, even in a home network comprising a router that forwards a router discovery packet to a subsequent router ignoring and not decrementing the allowed hop count number, or a router that filters a router response packet from the router, the home network router configuration can be learned, enabling relay information settings. The above problem can be solved by, for example, the following method.

First, it is preferable that the communication device be configured such that when a router response packet has not been received, an internal address is extracted from a received router response packet. A router external address is then acquired based on the extracted internal address. Further, the process for acquiring the internal address of a router more towards the wide area network based on an acquired external address is repeated. As a result, router configuration can be learned in a home network comprising a router that forwards a router discovery packet to a subsequent router without decrementing the allowed hop count number, or a router that filters a router response packet from the router, enabling relay information settings.

Second, it is preferable that determination be made of match/non-match of the internal address extracted from a router response packet with the external address acquired based on the internal address of the previous router. As a result, determination can be made of the validity of the internal address extracted from the router response packet. If there is match, the internal address extracted from the router response packet can be confirmed as the correct address for the communication device to access the router. Therefore, even in a home network comprising a router that forwards a router discovery packet to a subsequent router without decrementing the allowed hop count number, the communication device is capable of learning the home network router configuration, enabling relay information settings.

A 17^{th} aspect of the present invention provides a communication device according to the 14^{th} aspect of the invention, wherein the router address is the internal address; there is further provided first determination means for determining whether the internal address is a global address used in the wide area network; and when the internal address is a global address, relay information setting means stops the setting of relay information settings for the router.

When the acquired internal address is a global address, router detection in the home network is ended. Therefore, relay information settings is performed only on routers in the home network.

An 18^{th} aspect of the present invention provides a communication device according to the 14^{th} aspect of the invention, wherein the router address is the internal address; there is further provided first determination means for determining whether the internal address is a global address used in a wide area network; and when the internal address is a global address, router discovery packet preparation means stops preparing router discovery packets with an allowed hop count number larger than the allowed hop count number set with respect to the router having the global address.

When the acquired internal address is a global address, router detection in the home network is ended. As a result, to routers outside of the home network, unneeded transmission of packets in which the allowed hop count number has been changed can be avoided.

In a preferable configuration, there is further provided storage means for storing a correlation table in which the allowed hop count number and hop count number identifiers for identifying allowed hop count number are correlated, router discovery packet preparation means prepares a router discovery packet having a hop count number identifier correlating to the allowed hop count number, router response packet reception means, in response to the plurality of router discovery packets, receives a plurality of router response packets having the respective router addresses of the plurality of routers and the hop count number identifiers, and router address acquisition means specifies the allowed hop count number from the correlation table based on the hop count number identifier of the received router response packet.

Conventional router response packets do not include information regarding allowed hop count number. For this reason, to learn which router a router response packet is from, it is necessary to wait for a response, i.e., until a router response packet is sent in response to a router discovery packet, or until timeout is detected. Therefore, it takes considerable time to learn addresses of routers on the path. However, with the above constitution, a communication device is capable of learning which router the router response packet is from based on the hop count number identifier in the router response packet. Therefore, even when a plurality of router response packets has been received, which router the response is from can be learned. For this reason, the communication device transmits one after another router discovery packets in which the allowed hop count number has been changed, allowing high speed acquisition of router addresses and home network router configuration.

Further, relay information settings for routers in case of using the UPnP IGD specification must be able to handle dynamic settings as in, for example, setting relay information at a stage when a specific application starts up in the communication device. As described above, a communication device, by acquiring router addresses and router configuration in the home network at a high speed, can handle dynamic relay information settings for each router.

Further, in a preferable configuration, router discovery packet preparation means uses TTL (Time To Live) as the allowed hop count number, and prepares, as router discovery packets, UDP packets including source port number or destination port number changed in correspondence with the TTL; router discovery packet transmission means transmits the plurality of UDP packets; in response to the UDP packets, router response packet reception means receives, as router response packets, ICMP Time Exceeded Message packets including the respective router addresses of the plurality of routers and either the source port number or the destination port number; and router address acquisition means identifies TTL based on the source port number or destination port number of the received ICMP Time Exceeded Message packet.

A communication device is capable of learning which router a router response packet is from based on the source port number or the destination port number in the ICMP Time Exceeded Message. Therefore, even when a plurality of ICMP Time Exceeded Messages have been received, which router they are from can be learned. For this reason, the communication device transmits one after another UDP packets in which TTL has been changed, allowing high speed acquisition of home network router address and configuration. Further, the communication device acquires router configuration etc. at a high speed, enabling it to handle dynamic relay information settings for each router.

Further, in a preferable configuration, router discovery packet preparation means uses TTL (Time To Live) as the allowed hop count number, and as a router discovery packet, prepares an ICMP echo request packet including identifier information changed in correspondence with the TTL or the sequence numbers; router discovery packet transmission means transmits a plurality of ICMP echo request packets; in response to the ICMP echo request packets, router response packet reception means receives, as router response packets, ICMP Time Exceeded Message packets containing the router addresses of the plurality of routers and either identifier information or sequence numbers; and router address acquisition means identifies TTL based on the identifier information or sequence numbers of the received ICMP Time Exceeded Message.

The communication device is capable of learning which router a router response packet is from based on the identifier information or sequence numbers in the ICMP Time Exceeded Message. Therefore, even when a plurality of ICMP Time Exceeded Messages have been received, which router they are from can be learned. For this reason, the communication device transmits one after another ICMP echo request packets in which TTL has been changed, allowing high speed acquisition of home network router address and configuration.

Further, it is preferable that relay information setting means perform address translation settings enabling translation of a router wide area network side port number, and the IP address and/or port number of a router positioned more toward the home network side than such router or of its own communication device.

In this case, address translation settings can be made for each router even in a domestic home network comprising multiple routers, and settings for access from the wide area network to a communication device in the home network can be made from the communication device.

It is preferable that relay information setting means make packet filter settings with respect to the router for deciding whether to receive or discard a packet from the wide area network.

In this case, packet filter settings can be made with respect to each router even in a home network comprising a plurality of routers, and settings can be made from a communication device for access to the communication terminal from the wide area network. Therefore, communication device security can be improved.

A 19^{th} aspect of the present invention provides a communication device according to the 14^{th} aspect of the invention in a first home network comprising a plurality of routers connected in multiple stages further comprising: a router configuration information transmission unit for transmitting router configuration information of some of the plurality of routers connected in multiple stages that include the router to which the communication device itself is connected to another communication device in the first home network or another communication device in a second home network connected with the first home network via the wide area network; and a communication determination unit for receiving router configuration information of some other routers from among such plurality of routers from such other communication device, and based on its own router configuration information and the received router configuration information, determining whether communications can be made with the other communication device, wherein router configuration information is based on router addresses acquired by router address acquisition means.

With this communication device, router configuration is learned even in a network comprising multiple routers, thereby enabling NAT, firewall settings and other communication path settings. By setting a communication path in this manner, even when one or both of the communication devices are connected in a home network via multiple routers, P2P communication between the communication devices can be performed.

In a preferred configuration, there are further provided router discovery packet preparation means for preparing router discovery packets having a variable as the allowed hop count number, router discovery packet transmission means for transmitting router discovery packets to a plurality of routers in the home network, router response packet reception means for, in response to the router discovery packets, receiving a plurality of router response packets having the respective router addresses from the plurality of routers, and router address acquisition means for extracting router addresses from the router response packets; and the router configuration information acquisition unit acquires router configuration information of said some routers based on the router addresses of the plurality of routers.

A router, having received a router discovery packet in which the allowed hop count number is a variable from the communication device, transmits the router discovery packet toward the wide area network. At this time, the router transmits the router discovery packet to the next router, having decremented the set allowed hop count number by one. A router stops transmitting the router discovery packet to the wide area network when the allowed hop count number becomes “0” and transmits a router response packet to the communication device which is the router discovery packet source. As a result, the communication device is capable of easily learning the home network router configuration. Therefore, the communication device accesses the learned router, and makes router settings enabling communication with another communication device connected via routers connected in multiple stages.

In another preferable constitution there are further provided internal address acquisition means for acquiring a router home network address (“internal address”), external address acquisition means for acquiring the wide area network address of each router (“external address”), and relay information setting means for accessing a router based on an acquired internal address and making relay information settings for relay communications with another communication device connected via routers connected in multiple stages; external address acquisition means repeats the process of accessing a router based on the internal address that internal address acquisition means has acquired and acquiring router external address; internal address acquisition means repeats the process of acquiring the internal address of a router positioned more toward the wide area network than the router having the external router based on the external address that external address acquisition means has acquired; and the router configuration information acquisition unit acquires the router configuration information of said some routers based on the acquired internal address and/or external address.

With the above constitution, based on the external address of the communication device side router, the internal address of a router more to the outside of the home network is acquired, enabling router configuration to be learned. Therefore, the router configuration can be acquired without preparing a router discovery packet in which the allowed hop count number is varied or transmitting the prepared packet into the home network.

Further, because there is no forwarding of a router discovery packet in which the allowed hop count number is varied, even in a home network comprising a router not decrementing the allowed hop count number when a router discovery packet is forwarded, the home network router configuration can be learned. Further, because there is no receiving of a router response packet in response to the router discovery packet, even when a router that filters a router response packet is included, the home network router configuration can be learned.

A 20^{th} aspect of the present invention provides a communication device according to the 19^{th} aspect of the invention, further comprising relay information setting means for making relay information settings with respect to each router for relaying communications with another communication device, based on the router configuration information.

Relay information setting means accesses the learned routers to perform relay information settings, thereby allowing the communication device to communicate with another communication device connected via routers connected in multiple stages.

A 21^{st} aspect of the present invention provides a communication device according to the 20^{th} aspect of the invention, wherein the router configuration information comprises router addresses of routers within the home network from the communication device to the border router connecting the wide area network and the home network; and the communication determination unit comprises branch address extraction means for, in order from router addresses more toward the wide area network, determining match/non-match between router addresses contained in its own router configuration information and router addresses contained in the router configuration information of another communication device, extracting the address at the branch point of the communication path at which non-match was initially determined, and using the extracted branch address to determine whether communication can be made with the other communication device.

With respect to the routers below the branch, determination is made of whether communication path settings have been executed, thereby determining whether communication can be made. Therefore, communication can be made with another communication device connected via routers connected in multiple stages.

A 22^{nd} aspect of the present invention provides a communication device according to the 20^{th} aspect of the invention, wherein the router configuration information comprises router addresses of routers within the home network from the communication device to the border router connecting the wide area network and the home network; the communication determination unit comprises branch address extraction means for, in order from router addresses more toward the wide area network, determining match/non-match between router addresses contained in its own router configuration information and router addresses contained in the router configuration information of another communication device, extracting an address at a branch point of the communication path at which non-match was initially determined, and branch address transmission means for transmitting the extracted branch address to relay information setting means; based on its own router configuration information, relay information setting means accesses a router corresponding to the branch address and a router positioned between such router and its own communication device and sets relay information; and branch address transmission means correlates relay information of the router corresponding to the branch address and branch address and communicates with the other communication device.

Based on the router configuration information that router configuration information acquisition means has acquired, relay information setting means performs relay information settings, with respect to each router, for relaying communications with another communication device; and the router configuration information comprises router address and port number set as relay information of each router positioned between the communication device to a border router connecting networks at the border between the home network and wide area network. Here, in a preferable configuration, starting from router addresses more toward the wide area network, the communication determination unit determines match/non-match between router addresses contained in its own router configuration information and router addresses contained in the router configuration information of another communication device, comprises branch address extraction means for extracting the address, contained in the router configuration information of another communication device, at the branch point of the communication path at which non-match was initially determined, and a relay information port number set for the router corresponding to the address, and uses the address and port number at the branch point that branch address extraction means has extracted to perform communications with the other communication device.

With the above constitution, after router settings have been made, a branch point can be found. Therefore, communications can be made with another communication device connected via routers connected in multiple stages.

A 23^{rd} aspect of the present invention provides a communication device in a home network connected to a wide area network and comprising a plurality of routers connected in multiple stages. Here, the communication device comprises the following constitutional elements.
router discovery packet preparation means for preparing a router discover packet having a variable as the allowed hop count number;
router discovery packet transmission means for transmitting the router discovery packet to a plurality of routers in the home network;
router response packet reception means for receiving, in response to the router discovery packet, a plurality of router response packets containing the respective router addresses from the plurality of routers;
router address acquisition means for extracting the respective router address from the router response packet;
equipment discovery packet preparation means for preparing an equipment discovery packet for detecting a communication equipment connected to any given router based on the extracted router address;
equipment discovery packet transmission means for transmitting the equipment discovery packet to at least one communication equipment;
equipment response packet reception means for receiving, in response to the equipment discovery packet, an equipment response packet having an equipment address of the communication equipment from at least one communication equipment; and
equipment address acquisition means for extracting an equipment address from the equipment response packet.

A communication device transmits router discovery packets in which the allowed hop count number is a variable to acquire router addresses of routers in the home network. Further, the communication device can transmit an equipment discovery packet based on a router address to acquire an address of a communication equipment connected to the router. Therefore, for example, even in a home network comprising multiple routers, the communication device is capable of making various settings for accessing a communication equipment to relay communications with such communication equipment.

A 24^{th} aspect of the present invention provides a communication device according to the 23^{rd} aspect of the invention, further comprising communication setting means for accessing a communication equipment based on the extracted equipment address to make settings, at either the communication equipment or the communication device itself, for communicating with such communication equipment.

With such a constitution, even in a home network comprising multiple routers, a communication device is capable of accessing the communication equipment to make various settings for relaying communications with such communication equipment.

A 25^{th} aspect of the present invention provides a communication device according to the 23^{rd} aspect of the invention, wherein the router address is an internal address; there is further provided a first determination means for determining whether the internal address is a global address; when the internal address is a global address, the following are stopped: equipment discovery packet preparation by equipment discovery packet preparation means; equipment response packet reception by equipment response packet reception means; equipment address extraction by equipment address acquisition means; and settings for communicating with the communication equipment by communication setting means.

With such a constitution, only a communication equipment in a home network is accessed, enabling stable relay information settings.

A 26^{th} aspect of the present invention provides a communication device according to the 23^{rd} aspect of the invention, wherein equipment discovery packet preparation means prepares a plurality of equipment discovery packets containing as an equipment address a test address that is a partially changed an extracted router address; and equipment address acquisition means extracts the equipment addresses from the plurality of equipment response packets corresponding to the plurality of equipment discovery packets prepared based on the test address.

The equipment address of a communication equipment connected to a router is determined based on the router address, so that rather than randomly deciding equipment address, equipment address can be easily conjectured.

In a preferable constitution, communication setting means, with respect to the communication equipment, makes wireless communication settings including at least one of wireless channel used in communications, encryption information and authentication.

In this case, even in a domestic home network comprising a plurality of routers, settings can be made for wireless access.

Further, it is preferable that communication setting means extract from the communication equipment information for performing wireless communications including at least one of the wireless channel to be used for communication, encryption information and authentication information, and make settings for wireless communications by its own communication device.

In this case, even in a domestic home network comprising a plurality of routers, settings can be made for wireless access.

A 27^{th} aspect of the present invention provides a communication device according to the 23^{rd} aspect of the invention, further comprising an equipment learning unit for accessing a communication equipment based on the extracted equipment address to learn address and property information of the communication equipment.

In this case, type of communication equipment and status thereof can be recognized from its address and properties.

A 28^{th} aspect of the present invention provides a communication device according to the 27^{th} aspect of the invention, further comprising a display for displaying communication equipment address and property information acquired by the equipment learning unit.

In this case, acquired router and communication equipment information is displayed on the display, facilitating easy confirmation by a user.

A 29^{th} aspect of the present invention provides a communication method for a communication device in a home network connected to a wide area network and comprising a plurality of routers connected in multiple stages, such method comprising: an internal address acquisition step for acquiring a router home network address (“internal address”) and an external address acquisition step for acquiring a wide area network address (“external address”) of each router, wherein in the external address acquisition step, the process of acquiring, based on the internal address acquired in the internal address acquisition step, the external address of a router is repeated, and in the internal address acquisition step, the process of acquiring, based on the external address acquired in the external address acquisition step, the internal address of a router positioned more toward the wide area network than the router having the external address is repeated.

The present invention demonstrates effects identical to those of the first aspect of the present invention.

A 30^{th} aspect of the present invention provides a communication program executed by a communication device in a home network connected to the wide area network and comprising a plurality of routers connected in multiple stages, such program causing the communication device to function as internal address acquisition means for acquiring a router home network address (“internal address”) and as external address acquisition means for acquiring a router wide area network address (“external address”), wherein external address acquisition means repeats the process of accessing a router based on the internal address acquired by internal address acquisition means and acquiring the external address of the router; and internal address acquisition means repeats the process of acquiring the internal addresses of routers positioned more toward the wide area network than the router having such external address based on the external address acquired by external address acquisition means.

The present invention demonstrates effects identical to those of the first aspect of the present invention.

A 31^{st} aspect of the present invention provides a computer readable recording medium on which is recorded a communication program executed by a communication device in a home network connected to a wide area network and comprising a plurality of routers connected in multiple stages, such program causing execution of an internal address acquisition step for acquiring a router home network address (“internal address”) and an external address acquisition step for acquiring a router wide area network address (“external address”), wherein external address acquisition means repeats the process of accessing a router based on the internal address acquired by internal address acquisition means and acquiring the external address of the router; and internal address acquisition means repeats the process of acquiring the internal address of a router positioned more toward the wide area network than the router having such external address based on the external address acquired by external address acquisition means.

The present invention demonstrates effects identical to those of the first aspect of the present invention.

A 32^{nd} aspect of the present invention provides a communication method for a communication device connected to a wide area network and comprising a plurality of routers connected in multiple stages comprising: a router discovery packet preparation step for preparing a router discovery packet having a variable as the allowed hop count number; a router discovery packet transmission step for transmitting the router discovery packet so as to pass through a plurality of routers in the home network; a router response packet reception step for receiving, in response to the router discovery packet, a plurality of router response packets having the respective router addresses from the plurality of routers; a router address acquisition step for extracting the respective router address from the router response packet; and a processing requestee acquisition step for accessing a router based on the extracted router address to acquire information of processing requestee for relay information settings.

The present invention demonstrates effects identical to those of the 14^{th} aspect of the present invention.

A 33^{rd} aspect of the present invention provides a communication program executed by a communication device in a home network connected to a wide area network and comprising a plurality of routers connected in multiple stages and causing the communication device to function as: router discovery packet preparation means for preparing a router discovery packet having a variable as the allowed hop count number; router discovery packet transmission means for transmitting the router discovery packet so as to pass through a plurality of routers in the home network; router response packet reception means for receiving, in response to the router discovery packet, a plurality of router response packets having the respective router address from the plurality of routers; router address acquisition means for extracting the respective router address from the router response packet; and processing requestee acquisition means for accessing a router based on the extracted router address to acquire information of a requestee for relay information setting.

The present invention demonstrates effects identical to those of the 14^{th} aspect of the present invention.

A 34^{th} aspect of the present invention provides a computer readable recording medium on which is recorded a communication program executed by a communication device in a home network connected to a wide area network and comprising a plurality of routers connected in multiple stages, such program comprising: a router discovery packet preparation step for preparing a router discovery packet having a variable as the allowed hop count number; a router discovery packet transmission step for transmitting the router discovery packet so as to pass through a plurality of routers in the home network; a router response packet reception step for receiving, in response to the router discovery packet, a plurality of router response packets containing the respective router addresses from the plurality of routers; a router address acquisition step for extracting the respective router address from the router response packet; and a processing requestee acquisition step for accessing a router based on the extracted router address to acquire information of a requestee for relay information setting.

The present invention demonstrates effects identical to those of the 14^{th} aspect of the present invention.

A 35^{th} aspect of the present invention provides a communication method in a home network connected to a wide area network and comprising a plurality of routers connected in multiple stages comprising: a router discovery packet preparation step for preparing a router discovery packet having a variable as the allowed hop count number; a router discovery packet transmission step for transmitting the router discovery packet to a plurality of routers in the home network; a router response packet reception step for receiving, in response to the router discovery packet, a plurality of router response packets having the respective router addresses from the plurality of routers; a router address acquisition step for extracting the respective router address from the router response packet; an equipment discovery packet preparation step for preparing an equipment discovery packet for detecting a communication equipment connected to any given router based on the extracted router addresses; an equipment discovery packet transmission step for transmitting the equipment discovery packet to at least one communication equipment; an equipment response packet reception step for receiving, in response to the equipment discovery packet, from at least one communication equipment an equipment response packet having the equipment address of the communication equipment; and an equipment address acquisition step for extracting an equipment address from the equipment response packet.

The present invention demonstrates effects identical to those of the 23^{rd} aspect of the present invention.

A 36^{th} aspect of the present invention provides a communication program executed by a communication device in a home network connected to a wide area network and comprising a plurality of routers connected in multiple stages causing the communication device to function as: router discovery packet preparation means for preparing a router discovery packet having a variable as the allowed hop count number; router discovery packet transmission means for transmitting the router discovery packet to a plurality of routers in the home network; router response packet reception means for receiving, in response to the router discovery packet, a plurality of router response packets having the respective router addresses from the plurality of routers; router address acquisition means for extracting the respective router address from the router response packet; equipment discovery packet preparation means for preparing an equipment discovery packet for detecting a communication equipment connected to any given router based on the extracted router address; equipment discovery packet transmission means for transmitting the equipment discovery packet to at least one communication equipment; equipment response packet reception means for receiving, in response to the equipment discovery packet, an equipment response packet having an equipment address of a communication equipment from at least one communication equipment; and equipment address acquisition means for extracting an equipment address from the equipment response packet.

The present invention demonstrates effects identical to those of the 23^{rd} aspect of the present invention.

A 37^{th} aspect of the present invention provides a computer readable recording medium on which is recorded a communication program executed by a communication device in a home network connected to a wide area network and comprising a plurality of routers connected in multiple stages causing execution of: a router discovery packet preparation step for preparing a router discovery packet having a variable as the allowed hop count number; a router discovery packet transmission step for transmitting the router discovery packet to a plurality of routers in the home network; a router response packet reception step for receiving, in response to the router discovery packet, a plurality of router response packets having the respective router addresses from the plurality of routers; a router address acquisition step for extracting the respective router address from the router response packet; an equipment discovery packet preparation step for preparing an equipment discovery packet for detecting a communication equipment connected to any given router based on the extracted router address; an equipment discovery packet transmission step for transmitting the equipment discovery packet to at least one communication equipment; an equipment response packet reception step for receiving, in response to the equipment discovery packet, from at least one communication equipment an equipment response packet having the equipment address of the communication equipment; and an equipment address acquisition step for extracting an equipment address from the equipment response packet.

The present invention demonstrates effects identical to those of the 23^{rd} aspect of the present invention.

With the present invention, even in a home network comprising multiple routers, a communication device is capable of performing router settings.

### BRIEF DESCRIPTION OF THE DRAWINGS

FIG. 1 is a block diagram of a home network according to a first embodiment of the present invention;

FIG. 2 is a block diagram of a communication device according to the first embodiment of the present invention;

FIG. 3 is a diagram of a discovery packet format using UDP;

FIG. 4 is a diagram for explaining the relationship between the TTL and UDP of a discovery packet;

FIG. 5 is a flowchart for explaining a discovery packet transmission processing sequence according to the first embodiment of the present invention;

FIG. 6 is a diagram for explaining the flow of acquiring and setting router address according to the first embodiment of the present invention;

FIG. 7 is a diagram for explaining packet format of an ICMP Time Exceeded packet;

FIG. 8 is a flowchart for explaining a sequence for receiving a response to a discovery packet according to the first embodiment of the present invention;

FIG. 9 is a diagram of a discovery packet format using an ICMP echo request;

FIG. 10 is a diagram for explaining the relationship between the TTL and ICMP echo of a discovery packet;

FIG. 11 is a block diagram of a home network according to a second embodiment of the present invention;

FIG. 12 is a block diagram of a communication device according to the second embodiment of the present invention;

FIG. 13 shows the learning of a wireless AP address and wireless settings according to the second embodiment of the present invention;

FIG. 14 is a flowchart for explaining the processing sequence for transmitting a discovery packet according to the second embodiment of the present invention;

FIG. 15 is a flowchart for explaining the processing sequence for transmitting a wireless AP discovery packet according to the second embodiment of the present invention;

FIG. 16 is a diagram for explaining the relationship between a router address and destination addresses of a wireless AP discovery packet;

FIG. 17 is a flowchart explaining a sequence for receiving a response to a router discovery packet according to the second embodiment of the present invention;

FIG. 18 is a diagram for explaining learning and setting of a router address using a discovery packet according to a third embodiment of the present invention

FIG. 19 is a block diagram of a communication device according to the third embodiment of the present invention;

FIG. 20 is a flowchart for explaining a sequence for receiving a response to a router discovery packet according to the third embodiment of the present invention;

FIG. 21 is a flowchart for explaining the processing sequence for transmitting a router discovery packet according to the third embodiment of the present invention;

FIG. 22 is a diagram for explaining the relationship between a WAN address of a router and destination addresses for higher level router discovery packets;

FIG. 23 is a diagram for explaining how wireless AP address is learned and wireless settings according to a fourth embodiment of the present invention;

FIG. 24 is a block diagram of a communication device according to the fourth embodiment of the present invention;

FIG. 25 is a flowchart for explaining a sequence for receiving a response to a router discovery packet according to the fourth embodiment of the present invention;

FIG. 26 is a flowchart for explaining the processing sequence for transmitting a router discovery packet according to the fourth embodiment of the present invention;

FIG. 27 is a flowchart for explaining a wireless AP discovery packet transmission processing sequence according to the fourth embodiment of the present invention;

FIG. 28 is a diagram of a home network comprising routers that filter ICMP messages;

FIG. 29 is a block diagram of a communication device according to a fifth embodiment of the present invention;

FIG. 30 is a flowchart for explaining the processing sequence for transmitting a first discovery packet according to the fifth embodiment of the present invention;

FIG. 31 is a flowchart for explaining the processing sequence when timeout is detected according to the fifth embodiment of the present invention;

FIG. 32 is a flowchart for explaining the processing sequence for transmitting a router discovery packet according to the fifth embodiment of the present invention;

FIG. 33 is a flowchart for explaining a sequence for receiving a discovery packet response according to the fifth embodiment of the present invention;

FIG. 34 is a diagram for explaining learning of router address and making of router settings according to the fifth embodiment of the present invention;

FIG. 35 is a diagram for explaining a home network comprising a router that does not process TTL;

FIG. 36 is a block diagram of a communication device according to a sixth embodiment of the present invention;

FIG. 37 is a flowchart for explaining the processing sequence for transmitting a first discovery packet according to the sixth embodiment of the present invention;

FIG. 38 is a flowchart for explaining the processing sequence for transmitting a router discovery packet according to the sixth embodiment of the present invention;

FIG. 39 is a flowchart explaining a sequence for receiving a response to a discovery packet according to the sixth embodiment of the present invention;

FIG. 40 is a diagram for explaining learning of router address and making of router settings according to the sixth embodiment of the present invention;

FIG. 41 is a diagram for explaining network configuration according to a seventh embodiment of the present invention;

FIG. 42 is a block diagram of a user terminal according to the seventh embodiment of the present invention;

FIG. 43 is a diagram for explaining the processing sequence for transmitting a message in case of a P2P connection according to the seventh embodiment of the present invention;

FIG. 44 is a diagram for explaining the processing sequence for acquiring home network configuration information according to the seventh embodiment of the present invention;

FIG. 45 is a diagram of an address information message transmitted through address information exchange according to the seventh embodiment of the present invention;

FIG. 46 is a diagram of a communication path setting (NAT setting) sequence according to the seventh embodiment of the present invention;

FIG. 47 is a diagram of communication path setting executed by a user terminal according to the seventh embodiment of the present invention;

FIG. 48 is a diagram of the processing sequence for confirming a P2P communication path connection according to the seventh embodiment of the present invention (in a case where connection can be made from both user terminals);

FIG. 49 is a diagram of the processing sequence for confirming a P2P communication path connection according to the seventh embodiment of the present invention (in a case where connection can be made only from a terminal 1);

FIG. 50 is a diagram of the processing sequence for confirming a P2P communication path connection according to the seventh embodiment of the present invention (in a case where connection can be made only from a terminal 2);

FIG. 51 is a flowchart for explaining the processing sequence for determining a communication path according to the seventh embodiment of the present invention;

FIG. 52 is a diagram for explaining an example 1 of a network wherein P2P connection is made via the Internet according to the seventh embodiment of the present invention;

FIG. 53 is a diagram for explaining an example 2 of a network wherein P2P connection is made via the Internet according to the seventh embodiment of the present invention;

FIG. 54 is a diagram for explaining an example 1 of a network wherein P2P connection is made under the same router according to the seventh embodiment of the present invention;

FIG. 55 is a diagram for explaining an example 2 of a network wherein P2P connection is made under the same router according to the seventh embodiment of the present invention;

FIG. 56 is a diagram for explaining an example 3 of a network wherein P2P connection is made under the same router according to the seventh embodiment of the present invention;

FIG. 57 is a diagram for explaining an example 4 of a network wherein P2P connection is made under the same routers according to the seventh embodiment of the present invention;

FIG. 58 is a diagram for explaining an example 5 of a network wherein P2P connection is made under the same routers according to the seventh embodiment of the present invention;

FIG. 59 is a diagram of address exchange message expansion according to the seventh embodiment of the present invention;

FIG. 60 is a block diagram of a home network relating to an eighth embodiment of the present invention;

FIG. 61 is a functional block diagram for explaining communication device configuration;

FIG. 62 is an example of a flowchart for explaining communication device operations;

FIG. 63 is a diagram for explaining a method for router detection;

FIG. 64 is a diagram for explaining a method for detecting a communication equipment connected to a router;

FIG. 65 is a diagram for explaining a specific configuration example of a home network;

FIG. 66 is one example of network configuration displayed by a communication device display;

FIG. 67 is a block diagram of an entire communication device according to a ninth embodiment of the present invention;

FIG. 68 is a functional block diagram explaining communication device configuration;

FIG. 69 is an example of a flowchart for explaining communication device operations;

FIG. 70 is a diagram for explaining a method for detecting a router;

FIG. 71 is a diagram for explaining a specific configuration example of a home network;

FIG. 72 is one example of network configuration displayed by a communication device display;

FIG. 73 is a block diagram of a home network relating to a tenth embodiment of the present invention;

FIG. 74 is a functional block diagram for explaining communication device configuration;

FIG. 75 is one example of a flowchart explaining communication device operations;

FIG. 76 is a block diagram of a network comprising a router that filters a packet; and

FIG. 77 is a block diagram of a network comprising a router that does not process TLL.

### BEST MODE TO CARRY OUT THE INVENTION

Outline of the Invention

The communication device of the present invention is capable of discovering routers in a home network in a case where communication devices are connected under the control of multiple routers. The communication device first transmits a router discovery packet to each router. At this time, the router discovery packet contains a variable to be decremented each time the packet is forwarded from router to router. When the variable becomes 0, the router that received the router discovery packet returns a router response packet to the communication device that is a source. With such a constitution, the communication device is capable of learning router configuration (router addresses and connection order) even when routers are connected in multiple stages in a home network. The communication device then accesses the routers based on the acquired router addresses to acquire information of a requestee for making settings with respect to a router.

Accessing requestee information enables instructions to be given for router settings for the routers connected in multiple stages in the home network. As a result, the communication device is capable of performing communications with another communication device in the home network via the routers for which router settings have been performed, and/or with another communication device in the wide area network connected to the home network.

In another method for learning routers connected in multiple stages in a home network, a router discovery packet is transmitted from a communication device to acquire the home network address of a router directly connected to the communication device. The communication device then accesses the router based on the home network address to acquire a wide area network address of the router. Here, the home network address is a router address for the communication device to access the router. The wide area network address is a router address as seen from the wide area network when communication is relayed by router from the wide area network to the communication device. Based on the wide area network address acquired as above, a new home network address is conjectured. The communication device repeats the process of accessing a router based on a conjectured home network address to acquire the wide area network address of routers, thereby learning router configuration. In the following embodiment, explanation will be given of an example where a wide area network connected to a home network is the Internet, a home network address is a LAN (Local Area Network) address, and a wide area network address is a WAN (Wide Area Network) address.

### FIRST EMBODIMENT

### In Case of Using a Traceroute

Below, an explanation will be given of a first embodiment of the present invention with reference to the drawings.

Overall Constitution

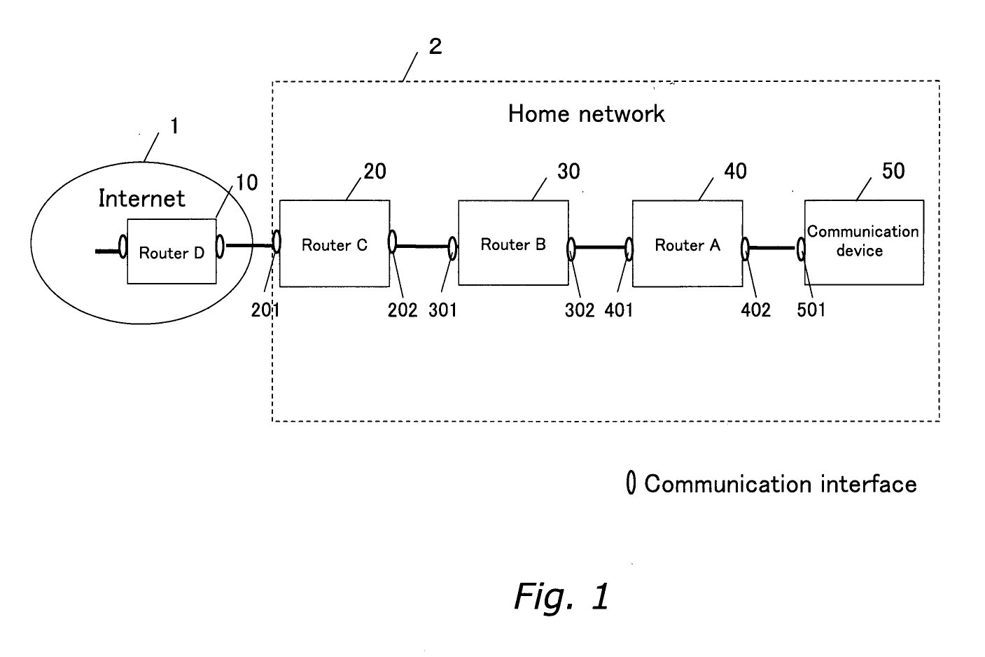

FIG. 1 shows the constitution of a home network according to a first embodiment of the present invention. In FIG. 1, an Internet 1 and home network 2 are connected to each other. The Internet 1 comprises a router 10D. The home network 2 comprises multiple routers including routers 20C, 30B, and 40A. The router 20C is disposed at the border with the Internet, and the router 30B and router 40A are disposed in the order given. A communication device 50 constituted by a user-operable PC or the like is connected to the router 40A. The communication device 150 comprises a communication interface 501.

The router 20C comprises a LAN side communication interface 202 and WAN side communication interface 201; a local address is allocated to the LAN side communication interface, and a global address is allocated to the WAN side communication interface. The router 30B comprises a LAN side communication interface 302 and WAN side communication interface 301, and the router 40A comprises a LAN side communication interface 402 and WAN side communication interface 401. Here, when the router 20C uses the global address to connect to the router 10D on the Internet 1 with which communications are to be made, connection between the home network 2 and Internet 1 is established.

Communication Device Configuration

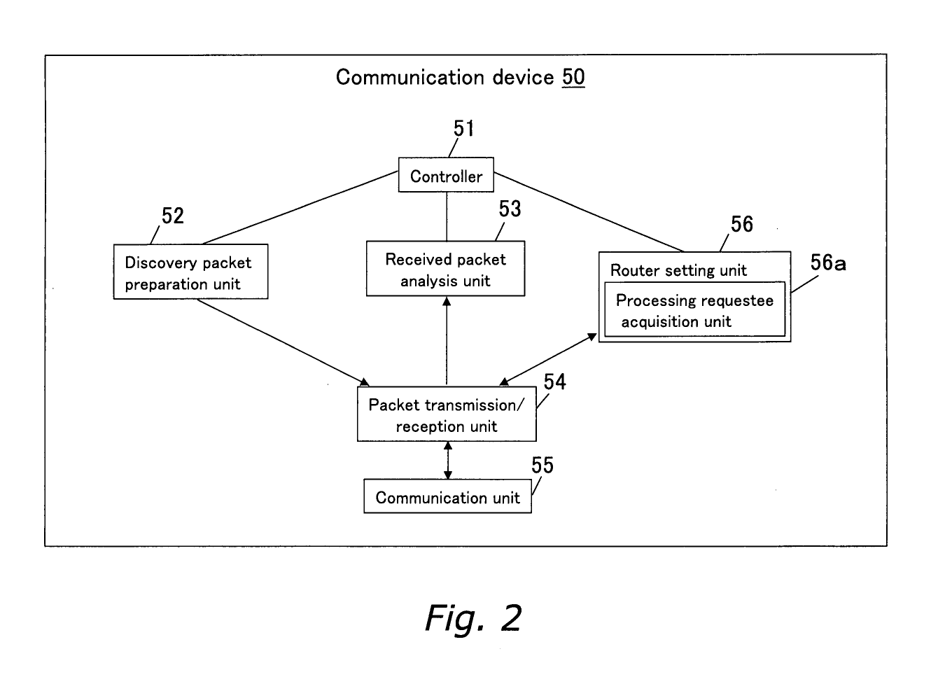

FIG. 2 shows, in an embodiment of the present invention, the configuration of the communication device 50 executing router settings in a home network.

This communication device 50 comprises a controller 51, discovery packet preparation unit 52, received packet analysis unit 53, packet transmission/reception unit 54, communication unit 55, and router setting unit 56. The controller 51 gives instructions to the functional units. The discovery packet preparation unit 52 prepares packets for discovering routers (“router discovery packet”), and gives instructions for transmission. The received packet analysis unit 53 analyzes the router discovery packets transmitted from the routers, and acquires an address of each router to learn router configuration. The packet transmission/reception unit 54 gives instructions for packet transmission to the communication unit 55, analyzes the packets received by the communication unit 55, and delivers the same to a functional unit corresponding to the received packets. The communication unit 55 comprises a communication interface function enabling packet transmission/reception to and from the network. The router setting unit 56 executes settings for the routers in the home network. The router setting unit 56 also comprises a processing requestee acquisition unit 56a for accessing the routers based on the acquired addresses to acquire a requestee for making NAT settings or the like with respect to a router.

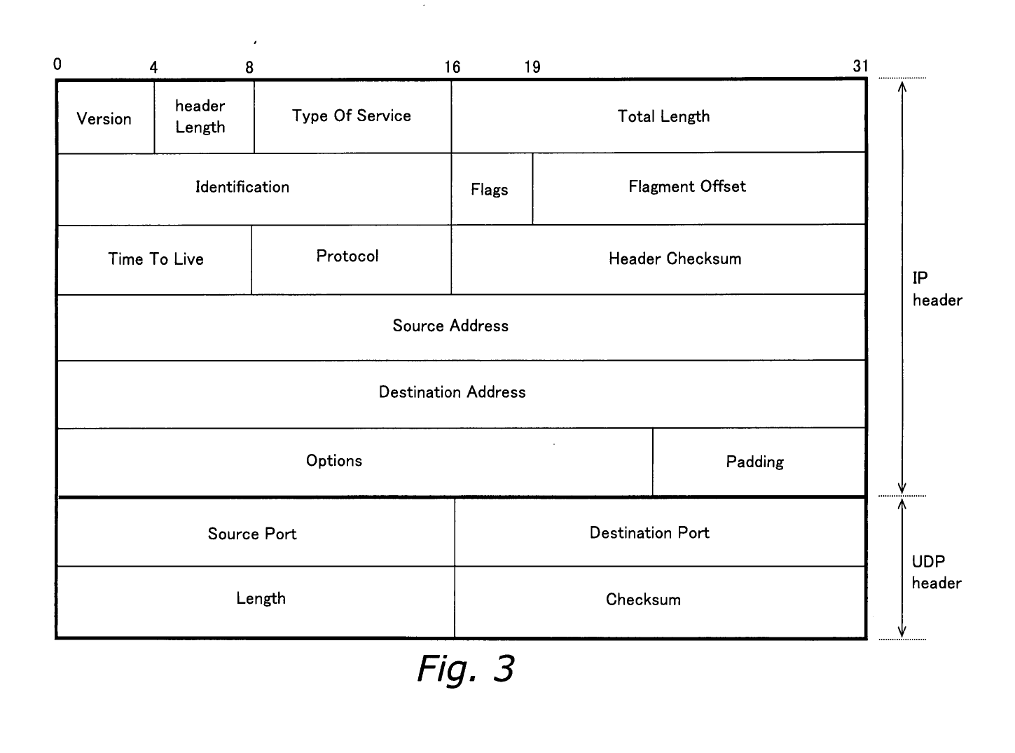

The router discovery packet preparation unit 52 prepares a packet, for example, as follows. FIG. 3 shows a router discovery packet in case of using UDP (User Datagram Protocol). The discovery packet preparation unit 52 changes the TTL (Time To Live) field in FIG. 3 in order, starting from 1, and at the same time, prepares a packet while incrementing the destination port number of a UDP header starting from 10001, in the same manner as the TTL. If through preparation of such a packet the destination port number can be confirmed, the TTL designated at time of transmission can be identified.

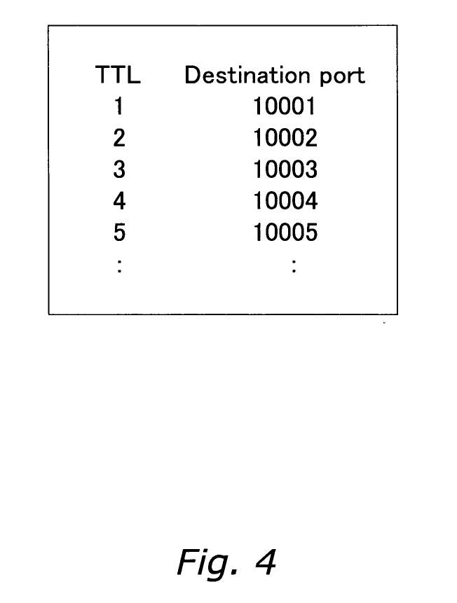

FIG. 4 shows one example of TTL and destination port numbers of a router discovery packet. The destination port numbers in this drawing embody one example, and no limitations are placed thereupon with respect to the destination port number as long as the TTL can be identified simply from destination port numbers. The discovery packet preparation unit 52 comprises a storage unit (not shown in the drawing) for storing a correlation table shown in FIG. 4, and identifies TTL based on this storage unit.

Router Setting Operations

An explanation will be given of operations of the communication device 50 connected to the home network 2 thus configured and executing router settings.

(1) Router Discovery Packet Transmission Processing

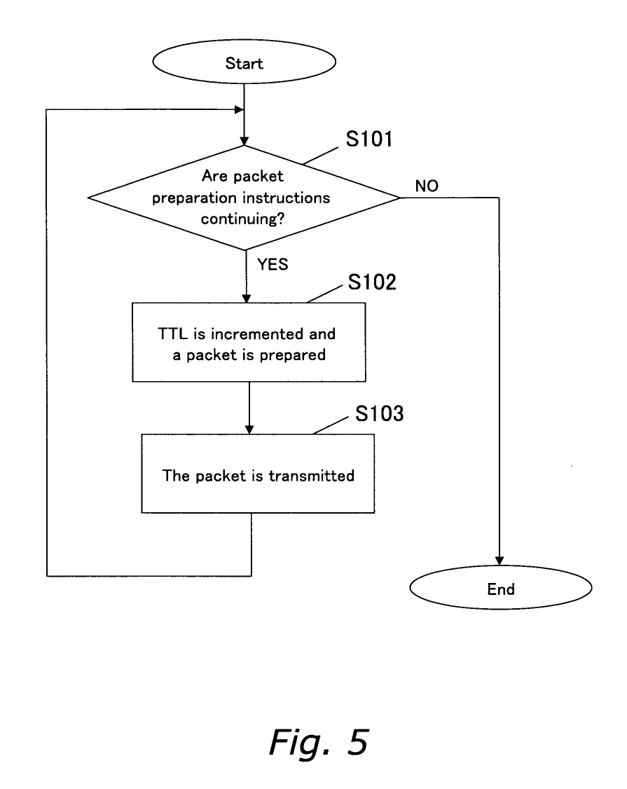

First, router discovery packet transmission processing will be explained. FIG. 5 shows a processing sequence for transmitting a router discovery packet executed by the communication device 50. The router discovery packet transmission processing is executed as described below.

When the controller 51 gives instructions for discovery packet preparation, the communication device 50 starts the processing sequence for transmitting a router discovery packet.

In step S101, the discovery packet preparation unit 52 of the communication device 50 determines whether the packet preparation instructions from the controller 51 are continuing.

The discovery packet preparation unit 52 ends the sequence when determination is made that instructions for packet preparation have not been given from the controller 51. Here, after instructions for packet preparation, the controller 51 gives instructions for stop when the specific conditions explained below in the processing of reception of packets from routers have been satisfied.

In step S102, when determination is made that the packet preparation instructions are continuing, the discovery packet preparation unit 52 prepares a router discovery packet in which the TTL has been incremented in order, starting from 1.

In step S103, the discovery packet preparation unit 52, when it has prepared a router discovery packet, instructs the packet transmission/reception unit 54 to transmit the packet. The packet transmission/reception unit 54 transmits the router discovery packet via the communication unit 55.

Here, the discovery packet preparation unit 52 can be configured so as to transmit another router discovery packet before receiving a response from the router with respect to the transmitted router discovery packet. A conventional response packet in response to the router discovery packet contains no information for identifying the TTL. For this reason, to learn which router a router response packet is from, there is a need to wait until the router response packet in response to the router discovery packet returns, or until the timeout is detected. Therefore, learning the address of the router on the path takes considerable time. However, with the above constitution, the communication device is capable of learning which router the router response packet is from based on information such as a destination port number or the like in the router response packet. Therefore, even when a plurality of router response packets are received, which router the response is from can be learned. As a result, the communication device transmits one after another router discovery packets in which the TTL has been changed, allowing high-speed acquisition of home network router address and configuration. Further, router settings for routers in case of using the UPnP IGD specification need to be able to handle dynamic settings as when making router settings when a specific application starts up in the communication device. As described above, by acquiring at high speed home network router address and configuration, the communication device is able to handle dynamic router settings for routers.

The router discovery packet can be configured so as to perform transmission to a specific global address on the Internet.

The foregoing described the processing sequence for transmitting a router discovery packet executed by the communication device 50.

(2) ICMP Time Exceeded Packet Reception Processing

Next, an explanation will be given of processing for receiving an ICMP Time Exceeded packet transmitted from a router in response to a router discovery packet.

(2-1) Outline of ICMP Time Exceeded Packet Reception Processing

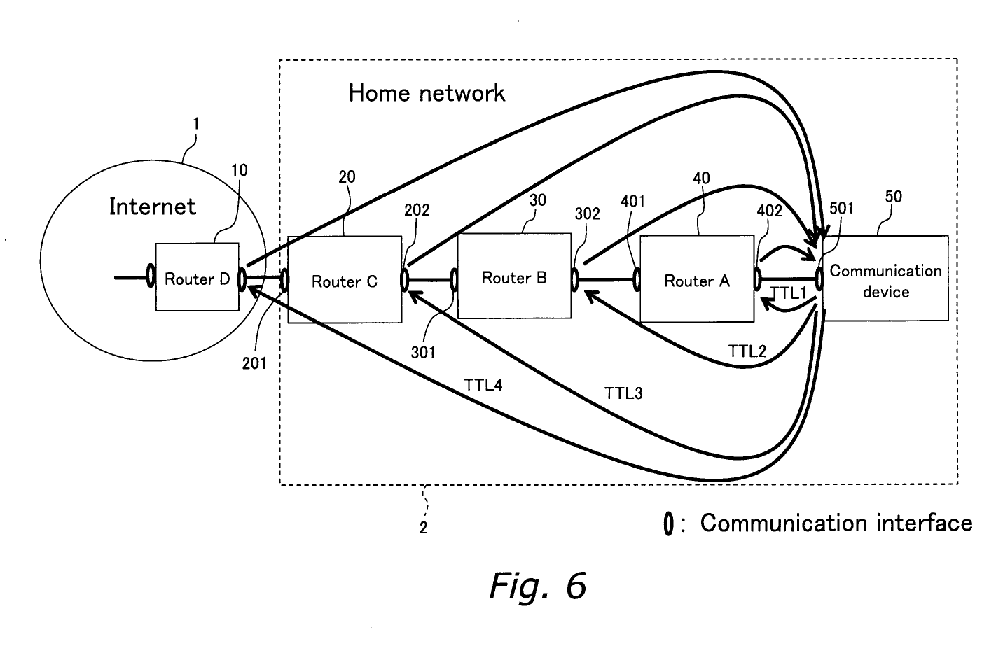

FIG. 6 shows the relationship between a router discovery packet and the corresponding ICMP Time Exceeded packet transmitted from a router. When the router discovery packet received from the communication device 50 (“LAN side”) is transmitted toward the direction outside of the home network (“WAN side”), each router decrements the TTL value by one and then sends the router discovery packet on. A router discards the packet without transmitting it toward the WAN side when the TTL has been decremented to 0, and transmits an ICMP Time Exceeded packet as a response packet to the communication device that was the source of the packet.

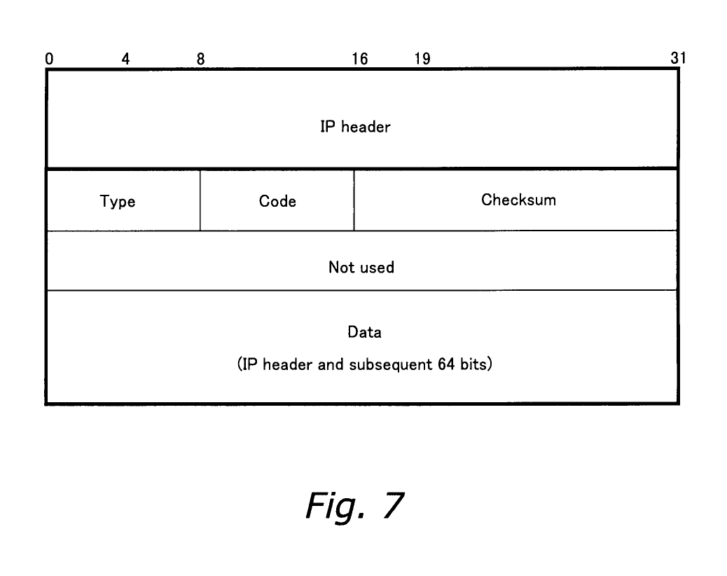

FIG. 7 shows an ICMP Time Exceeded packet. To the data in the ICMP Time Exceeded packet, the IP header of the discarded packet and the following 64 bit data are added. Therefore, when a router discovery packet in which TTL=1 is transmitted toward an address on the Internet, when the router 40A attempts to transmit the same to the WAN, TTL becomes 0. As a result, this router discovery packet is discarded, and then an ICMP Time Exceeded packet is transmitted from the router 40A to the communication device 50. The source address of this ICMP Time Exceeded packet becomes the LAN address of the router 40A. Therefore, by confirming the source address of the ICMP Time Exceeded packet, the communication device 50 acquires the LAN address of the router 40A.

In the same manner, when the communication device 50 transmits a router discovery packet in which TTL=2, the LAN address of the router 30B can be acquired. More specifically, router discovery packets in which the TTL has been respectively set at 3 and 4 are transmitted, enabling the communication device 50 to acquire the LAN addresses of both the routers 20C and 10D.

(2-2) Details of the ICMP Time Exceeded Packet Reception Processing

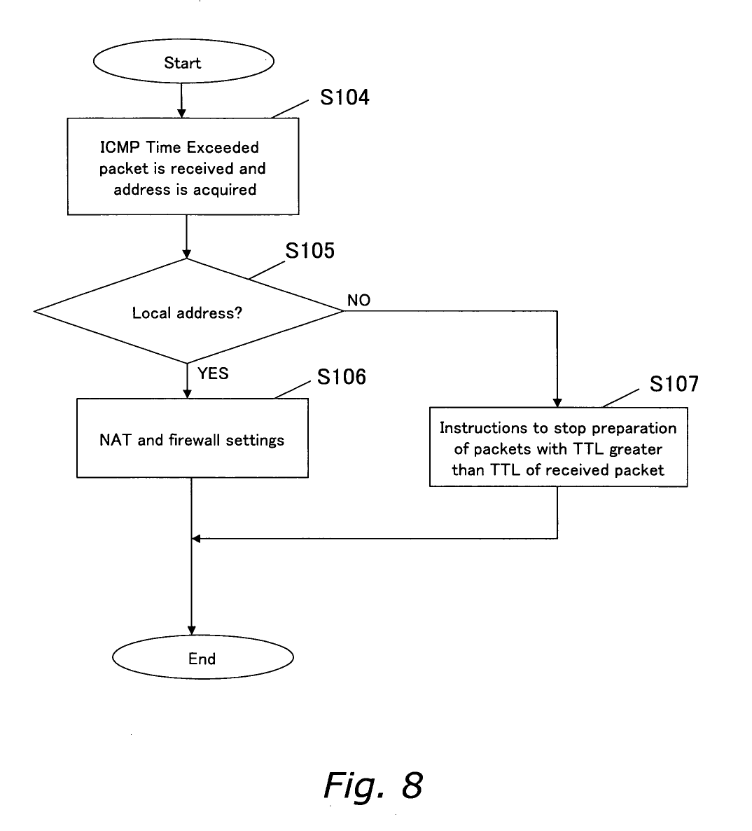

FIG. 8 shows the processing for receiving an ICMP Time Exceeded packet.

In step S104, when the communication unit 55 receives an ICMP Time Exceeded packet corresponding to a router discovery packet, the packet transmission/reception processing unit 54 transmits the received ICMP Time Exceeded packet to the received packet analysis unit 53.

The received packet analysis unit 53 extracts a destination port number contained in the data portion of the ICMP Time Exceeded packet, and identifies the TTL designated at time of router discovery packet transmission based on such information. At the same time, the received packet analysis unit 53 refers to the source address of the received ICMP Time Exceeded packet to acquire the LAN address of the router that transmitted the ICMP Time Exceeded packet.

For example, let us assume that the discovery packet preparation unit 52 prepares and transmits a router discovery packet using the UDP as shown in FIG. 3. At this time, when a destination port number contained in the data unit of the ICMP Time Exceeded packet is 10001, because it is known from FIG. 4 that this is an ICMP in response to the router discovery packet in which TTL=1, the received packet analysis unit 53 is capable of recognizing that the LAN address of the router 40A has been acquired. In the same manner, when a destination port number is 10002, because the received packet analysis unit 53 can judge that this is an ICMP in response to the router discovery packet in which TTL=2, the received packet analysis unit 53 can recognize that the LAN address of the router 30B has been acquired.

In step S105, the controller 51 of the communication device 50 determines whether the acquired address is a local address.

In step S106, when determination is made that a source address contained in the received ICMP Time Exceeded packet is a local address, the controller 51 of the communication device 50 instructs the router setting unit 56 to perform router settings. The processing requestee acquisition unit 56a of the router setting unit 56 that received the instruction accesses the router based on the acquired address, and as indicated by NAT settings using the UPnP IGD specifications (described below), first acquires a requestee for making router NAT settings or the like. Then, the router setting unit 56 accesses such requestee of such router (destination URL for an action request) to execute NAT and firewall settings.

In step S107, when determination is made that the source address contained in the received ICMP Time Exceeded packet is a global address, the controller 51 of the communication device 50 instructs the discovery packet preparation unit 52 to stop preparing discovery packets and ends processing. When the source address is a global address, router detection in the home network has ended. With such a constitution, the communication device 50 is prevented from uselessly transmitting a packet in which the TTL has been changed to a router outside the home network. Further, NAT and firewall settings can be performed only with respect to routers in the home network.

The reasons for performing NAT, firewall and other router settings by the router setting unit 56 as described above are as follows.

Communication is executed on the Internet using global addresses, whereas communication is executed in a home network using local addresses. For this reason, the communication device 50 in the home network 2 is prevented from directly communicating with a communication device on the Internet 1. NAT settings help solve the above problem. NAT settings are made for address translation. For example, when router settings are executed for all of the routers 20C, 30B, and 40A, a communication device on the Internet 1 outside of the home network 2 is capable of accessing the communication device 50 in the home network 2. However, there are cases where a firewall has been set for each router, and even when address translation is correctly set, due to the firewall, a packet may be discarded midway.

A typical example of firewall settings is packet filter settings; by making settings for routers in a home network up to the communication device 50 in the same manner as address translation settings, that is, by making settings permitting connection from the WAN side, the discarding of packets can be prevented.

Conventionally, a router has a Web-based user interface, and transmits an http message suitable for the LAN address of the router to perform NAT and packet filter settings. Further, NAT settings can be performed using the UPnP IGD specification.

NAT Settings Using the UPnP IGD Specification

Described below is one example of processing when making NAT settings using the UPnP IGD specification. Details of the UPnP IGD specification are described in UPnP FORUM material, Internet Gateway Device (IGD) V1.0 (obtained from: http://www.UPnP.org/standardizeddcps/igd.asp), and UPnP™ Device Architecture (obtained from: http://www.UPnP.org/download/UPnPDA10_{—}20000613.htm).

In a case where the received packet analysis unit 53 acquires the LAN address of the router 40A in response to transmission of a router discovery packet in which the TTL has been set at 1, the acquired LAN address is transmitted to the router setting unit 56 via the controller 51.

The processing requestee acquisition unit 56a of the router setting unit 56 of the communication device 50 transmits an M-Search request in unicast mode to the LAN address of the router 40A directly connected to the communication device 50. In the response packet to the transmitted M-Search request, there is indicated a URL for indicating the device regarding which a device description is to be acquired. The processing requestee acquisition unit 56a, having received the response packet via the communication unit 55 and the packet transmission/reception unit 54 of the communication device 50, acquires device description containing a device type, method for starting services and functions provided by the device, device state acquisition information and the like from the device from which this device description is acquired, and obtains URL information of the action request destination based thereupon.

The router setting unit 56 transmits an AddPortMapping action to the destination URL of the obtained action request to perform NAT settings with respect to the router 40A. As arguments designated at time of executing this action, a port number (Px) of the communication device 50, IP address of the communication device, and a port number of the router 40A used at time of access by the communication device on the Internet are designated.

When making NAT settings with respect to a port number (Px) of the communication device 50, typical examples includes designating a port number Px of the router 40A and executing NAT settings.

Next, when the received packet analysis unit 53 acquires the LAN address of the router 30B corresponding to TTL=2, the router setting unit 56 designates a WAN address and port number Px of the router 40A and a port number Px of the router 30B and executes AddPortMapping, thereby enabling NAT settings with respect to the router 30B. Here, the WAN address of the router 40A can be obtained by having the GetExternalIPAddress action transmitted to the router 40A.

In the same manner, when the received packet analysis unit 53 acquires the LAN address of the router 20C corresponding to TTL=3, the router setting unit 56 designates a WAN address and port number Px of the router 30B and a port number Px of the router 20C and executes the AddPortMapping, thereby enabling NAT settings with respect to the router 20C.

When a response packet from a router corresponding to TTL=2 or 3 is received before a response packet corresponding to TTL=1, an address for translation for performing NAT settings has not yet been acquired. Therefore, the router setting unit 56 executes NAT settings when the address of the router connected to the router LAN side corresponding to the received TTL is acquired. Let us assume, for example, that prior to the response packet of the router 40A corresponding to TTL=1, a response packet of the router 30B corresponding to TTL=2 is received. In this case, after a response packet has been received from the router 40A corresponding to TTL=1 and the WAN address of the router 40A has been acquired, NAT settings are executed with respect to the router 30B.

Effects

As described above, the communication device of the present invention is configured such that a router that received from the communication device a router discovery packet in which the TTL is a variable transmits the router discovery packet from the LAN side, that is, the communication device side, towards the WAN side, that is, towards the outside of the home network to a communication device. At this time, the router transmits the router discovery packet to the next router having decremented the set relay router number by only 1. A router stops transmitting the router discovery packet to the WAN side when the relay router number becomes “0,” and transmits a router response packet to the communication device that is the source of the router discovery packet. As a result, the communication device is capable of easily learning the home network router configuration. Further, the communication device accesses learned routers to perform router settings so as to allow communications with another communication device connected via routers connected in multiple stages.

Further, in this first embodiment, router discovery packet transmission is ended when a global address is acquired as a router LAN address. Alternatively, an upper limit can be provided for the TTL in the router discovery packet so as to end router discovery packet transmission when the TTL reaches the upper limit.

Further, in this first embodiment, an explanation was given of an example of a home network comprising three routers connected to one another, but such a configuration is merely one example. The present invention is similarly applicable to a home network comprising anywhere from one to N routers.

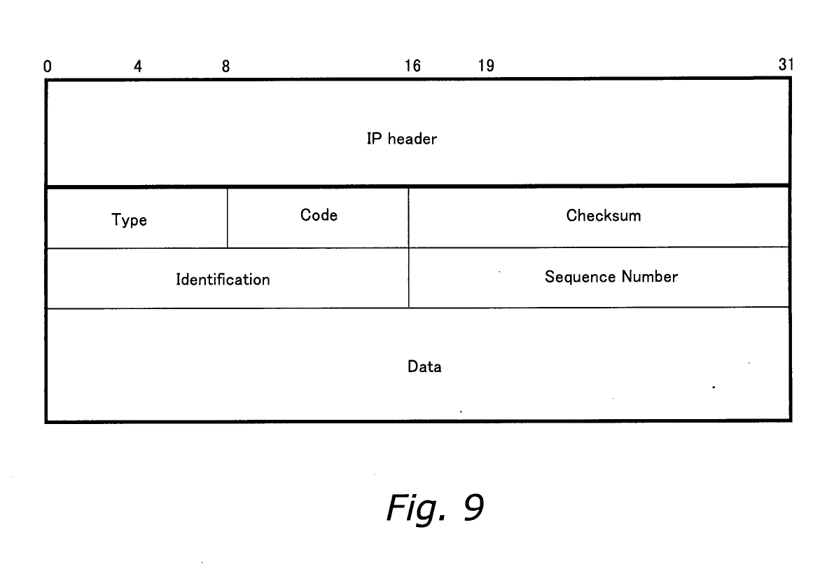

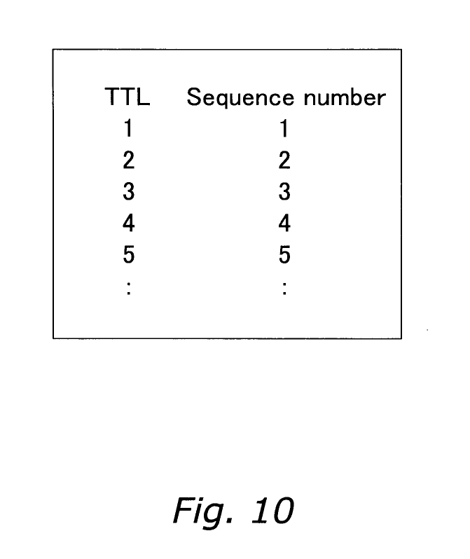

Further, in this first embodiment, a router discovery packet is configured so that the TTL and destination port number are changed, but the identical processing can be performed even when the TTL and destination IP address or source port number are changed. Further, the router discovery packet can be prepared as an ICMP echo request as shown in FIG. 9. Even when an ICMP echo request is used, the TTL can be similarly changed so as to allow the communication device to acquire from routers an ICMP Time Exceeded packet as shown in FIG. 7. When an ICMP echo request is used, the TTL as well as the sequence number, destination IP address or identifier can be changed so as to enable control identical to that of the router discovery packet using UDP. FIG. 10 shows an example of a case where the TTL and sequence number of the router discovery packet are correlated with each other. Here, values of the sequence number embody one example. No limitations are placed on such values as long as the TTL can be identified simply based on sequence numbers.

Further, in this first embodiment, the processing requestee acquisition unit 56a of the router setting unit 56 transmits an M-Search request in unicast mode. An example was described where a URL indicating the acquiree for the device description is obtained from the response, and based on this URL, information of a requestee for making relay information settings with respect to a router is obtained. However, the example of using UPnP represents but one embodiment of the present invention. The processing requestee acquisition unit 56a may be configured so as to learn information of the processing requestee using other methods based on the router LAN address. For example, the processing requestee acquisition unit 56a may be configured so that well-known information (e.g., well-known port number and well-known URP information) and the router LAN address are combined to create processing requestee information.

### SECOND EMBODIMENT

### A Case of Performing Wireless Network Settings

A second embodiment of the present invention will be explained with reference to the drawings.

Overall Constitution

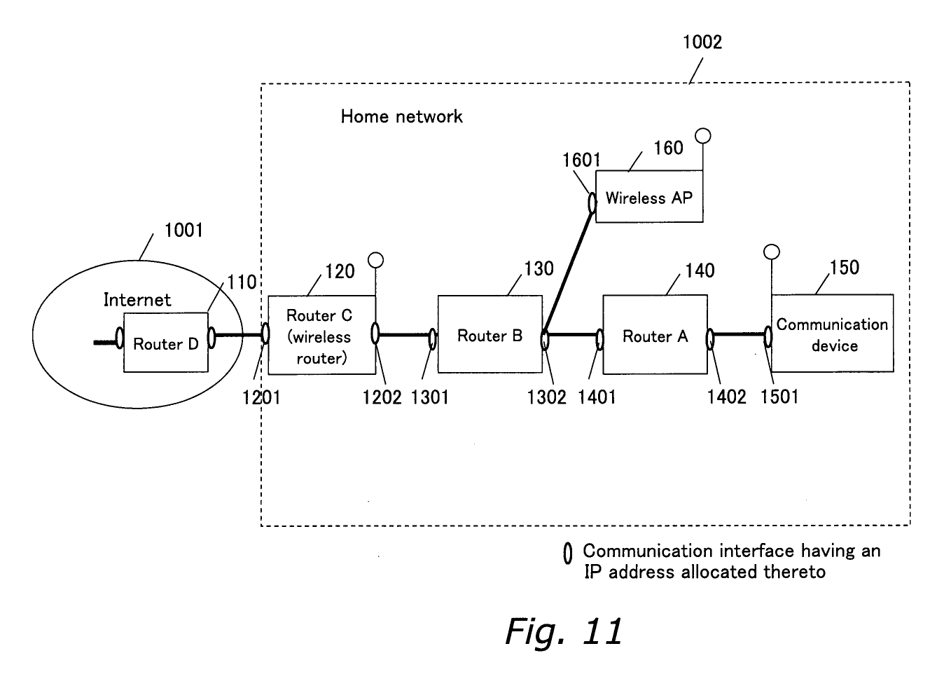

FIG. 11 shows the constitution of a home network according to a second embodiment of the present invention. In FIG. 11, an Internet 1001 and home network 1002 are connected to each other. The Internet 1001 comprises a router 110D. The home network 1002 comprises multiple routers including routers 120C, 130B, and 140A. The router 120C is disposed at the border with the Internet, and the router 130B and router 140A are disposed in such order. Here, the router 120C is a wireless router comprising a wireless AP (access point) function. Further, the router 130B has connected thereto a wireless AP 160, and the router 140A has connected thereto a communication device 150 constituted by a user-operable PC or the like. The communication device 150 comprises a wired communication interface 1501 and wireless communication interface 1502, and, as described below, performs settings for the wireless communication function of its own device and the wireless AP 160.

The router 120C comprises a LAN side communication interface 1202 and WAN side communication interface 1201; a local address is allocated to the LAN side communication interface, and a global address is allocated to the WAN side communication interface. The router 130B comprises a LAN side communication interface 1302 and WAN side communication interface 1301, and the router 140A comprises a LAN side communication interface 1402 and WAN side communication interface 1401. Here, when the router 120C uses the global address to connect the router 110D on the Internet 1001 that is to make communications, connection between the home network 1002 and Internet 1001 is established. Further, the wireless AP 160 comprises a communication interface 1601.

Communication Device Configuration

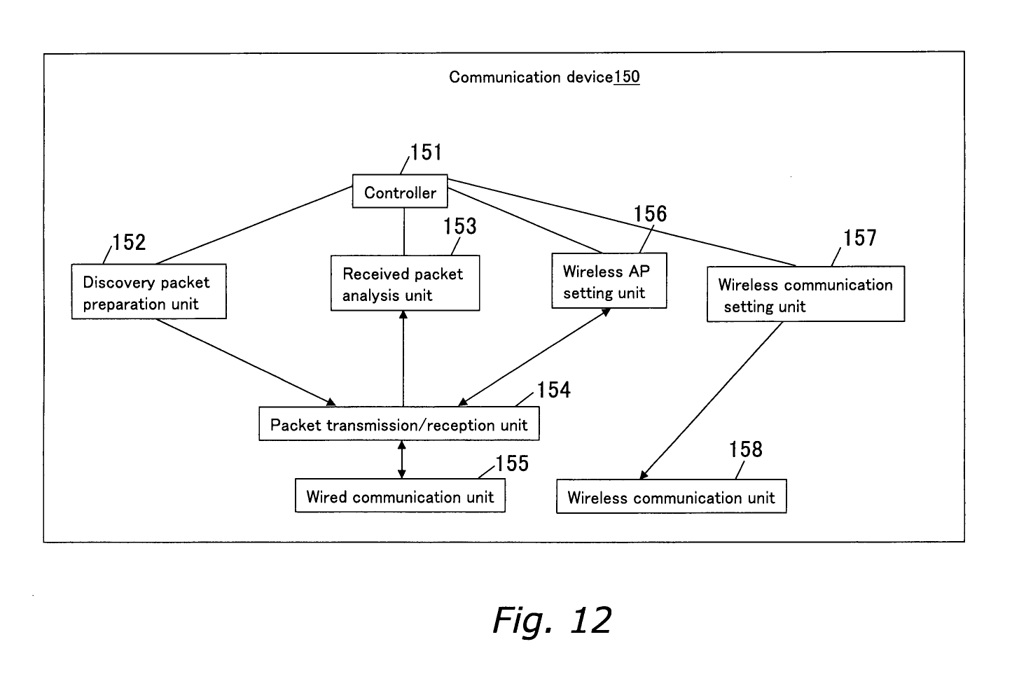

FIG. 12 shows a functional block diagram for explaining the configuration of the communication device 150. This communication device 150 comprises a controller 151, discovery packet preparation unit 152, received packet analysis unit 153, packet transmission/reception unit 154, communication unit 155, wireless AP setting unit 156, wireless communication setting unit 157, and wireless communication unit 158. The controller 151 gives instructions for processing to the functional units. The discovery packet preparation unit 152 prepares packets for discovering routers (“router discovery packet”) and gives instructions for transmission thereof. Further, the discovery packet preparation unit 152 prepares packets for discovering a communication equipment connected to a router (“equipment discovery packet”) and gives instructions for transmission thereof. The received packet analysis unit 153 analyzes packets transmitted from the routers in response to the router discovery packets, and acquires the address of each router to learn the router configuration. The packet transmission/reception unit 154 gives instructions for packet transmission processing to the communication unit 155, analyzes the packets received by the communication unit 155, and delivers the same to a functional unit corresponding to the received packet. The communication unit 155 has a communication interface function to enable packet transmission/reception to and from the network. The wireless AP setting unit 156 performs settings, to the wireless AP 160, of an encryption key, SSID or other identification information, wireless channel, authentication information and the like. The wireless communication setting unit 157 performs settings, with respect to the wireless communication unit 158 of its own device, of an encryption key, SSID or other identification information, wireless channel, authentication information and the like. The wireless communication unit 158 enables wireless communications.

Operations for Wireless Network Settings

An explanation will be given of operations of the communication device 150 connected to the home network 1002 thus configured and executing wireless network settings.

(1) Outline of the Processing

First, an explanation will be given of an outline of the steps for discovering the router address of each router, and using the discovered router addresses to discover a wireless AP 160.

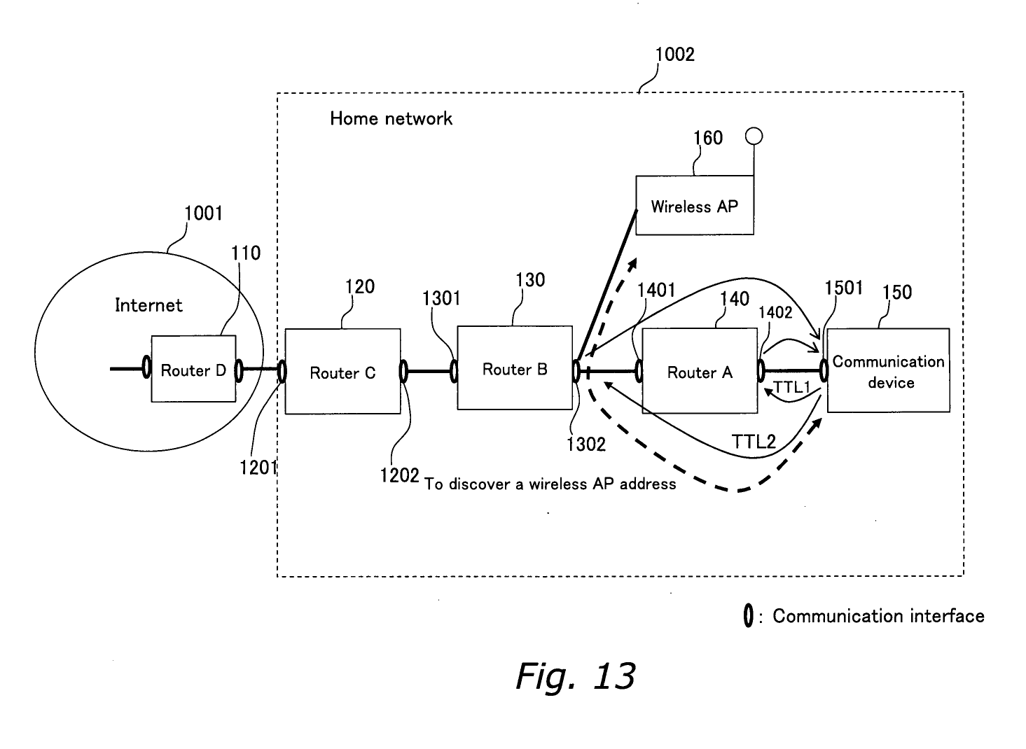

FIG. 13 shows steps for discovering router addresses, and using the discovered addresses to discover the wireless AP 160. First, the communication device 150 transmits router discovery packets in which the TTL have been changed, starting from 1. The communication device 150 in response to the router discovery packet receives an ICMP Time Exceeded packet corresponding to TTL=1. Further, as a response to the router discovery packet in which TTL=2, the communication device receives an ICMP Time Exceeded packet from the router 130B. The communication device 150 is capable of learning the LAN address of the router 130B based on the source address of the received ICMP Time Exceeded packet. Based on the obtained LAN address of the router 130B, the communication device 150 detects an equipment address of the wireless AP 160 belonging to the same network group. Further, the communication device 150 performs communication settings of the wireless AP 160, and/or performs wireless function settings of the communication device 150 by acquiring the setting information of the wireless AP 160.

(2) Router Discovery Packet Transmission Processing Sequence

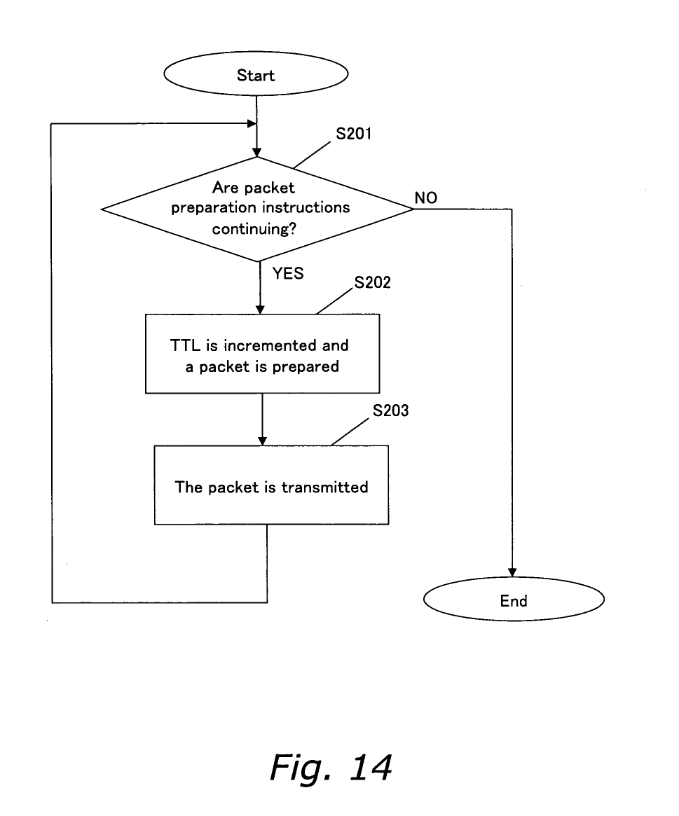

First, the processing sequence for transmitting a router discovery packet will be explained. FIG. 14 shows the processing sequence for transmitting router discovery packets in which the TTL has been changed, as executed by the discovery packet preparation unit 152.

When the controller 151 gives instructions for router discovery packet preparation, the communication device 150 starts the processing sequence for transmitting a router discovery packet.

In step S201, the discovery packet preparation unit 152 of the communication device 150 determines whether the packet preparation instructions from the controller 151 are continuing.

The discovery packet preparation unit 152 ends the sequence when determination is made that instructions for packet preparation have not been given. Here, after instructions for packet preparation, the controller 151 gives instructions for stop when the specific conditions explained below in the processing of reception of packets from routers are satisfied.

In step S202, when determination is made that the packet preparation instructions are continuing, the discovery packet preparation unit 152 prepares router discovery packets in which the TTL has been incremented in order, starting from 1.

In step S203, the discovery packet preparation unit 152, upon preparing a router discovery packet, gives instructions for transmitting the packet to the packet transmission/reception unit 154. The packet transmission/reception unit 154 transmits the router discovery packet via the communication unit 155.

This processing sequence for transmitting a router discovery packet is as in the sequence shown in FIG. 5 according to the first embodiment.

(3) Wireless AP discovery packet transmission processing

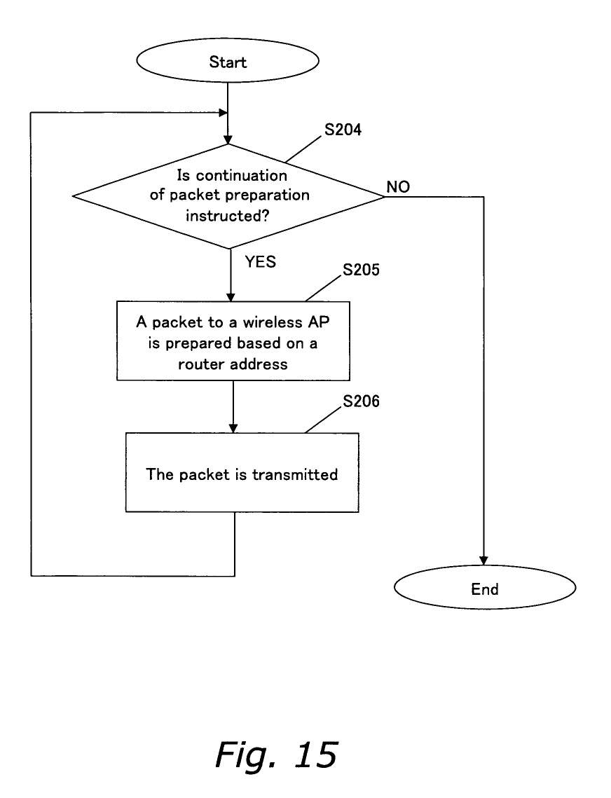

FIG. 15 shows a sequence executed by the discovery packet preparation unit 152, using an IP address of a router obtained in response to a transmitted router discovery packet to transmit a wireless AP discovery packet for detecting a wireless AP. The operations are explained below.

In step S204, first, the discovery packet preparation unit 152 of the communication device 150 determines whether the controller 151 has given instructions for wireless AP discovery packet preparation.

When determination is made that the wireless AP discovery packet preparation instructions are not continuing, the discovery packet preparation unit 152 stops preparing wireless AP discovery packets, and ends the processing.

In step S205, when determination is made that the controller 151 has given instructions for wireless AP discovery packet preparation, based on the IP address of the router for which instructions were given by the controller 151, the discovery packet preparation unit 152 of the communication device 150 conjectures a wireless AP address and prepares a wireless AP discovery packet.

The timing at which the controller 151 gives instructions to stop preparing wireless AP discovery packets will be described below in the section describing the processing sequence for receiving router and wireless AP discovery packets.

In step S206, the discovery packet preparation unit 152 conjectures an address of the wireless AP 160, and completes preparation of a wireless AP discovery packet; thereupon the packet transmission/reception unit 154 and wired communication unit 155 transmit the wireless AP discovery packet into the home network 1002.

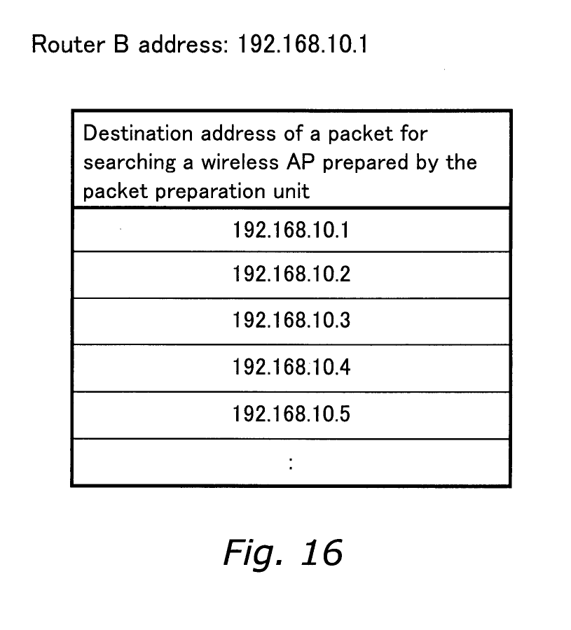

It step S205, the discovery packet preparation unit 152 conjectures the destination address of the wireless AP discovery packet by, for example, the following method. First, after address type (class A, class B, class C) is determined, bits in the address that are variable within the same network are selected, and those values are changed in order. FIG. 16 shows destination addresses for wireless AP discovery packets. The communication device gives instructions for preparing packets for these addresses so as to discover a wireless AP connected under the router having a class C address.

Here, in view of a case where a router whose LAN address has been determined has a wireless AP function, the communication device first transmits a wireless AP discovery packet to the address of this router.

Because a wireless AP usually has a Web-based user interface, a suitable http message is transmitted to the IP address of the wireless AP 160 as the content of the wireless AP discovery packet; through receipt of a response packet in response thereto, existence of the wireless AP 160 can be detected.

Further, the UPnP WLAN Access Point Device V1.0 specification (a detailed document can be obtained from: http://UPnP.org/standardizeddcps/wlanap.asp) can be used to detect the wireless AP 160.

More specifically, an M-Search request is transmitted in unicast mode to a conjectured address of the AP 160 to discover a WLAN Access Point device (while the formal UPnP specification is transmission of an M-Search request in multicast mode, most equipments are set so as to receive an M-Search in unicast mode as well).

Described above is the sequence for transmitting a wireless AP discovery packet executed by the discovery preparation unit 152. Here, the discovery packet preparation unit 152 can be configured so as to transmit a subsequent wireless AP discovery packet before waiting for a response from the wireless AP to the wireless AP discovery packet. Thus simultaneous transmission of a plurality of discovery packets enables high-speed detection of a wireless AP.

In the sequence for transmitting AP discovery packets, the communication device may use IP addresses of a plurality of routers (e.g., routers 140A, 130B, and 120C) and prepare wireless AP discovery packets in parallel so as to simultaneously perform processing for detection of a wireless AP under multiple routers.

(4) Processing for Receipt of a Response Packet to Packets

Next, an explanation will be given of processing for receipt of a response to a router discovery packet and wireless AP discovery packet.

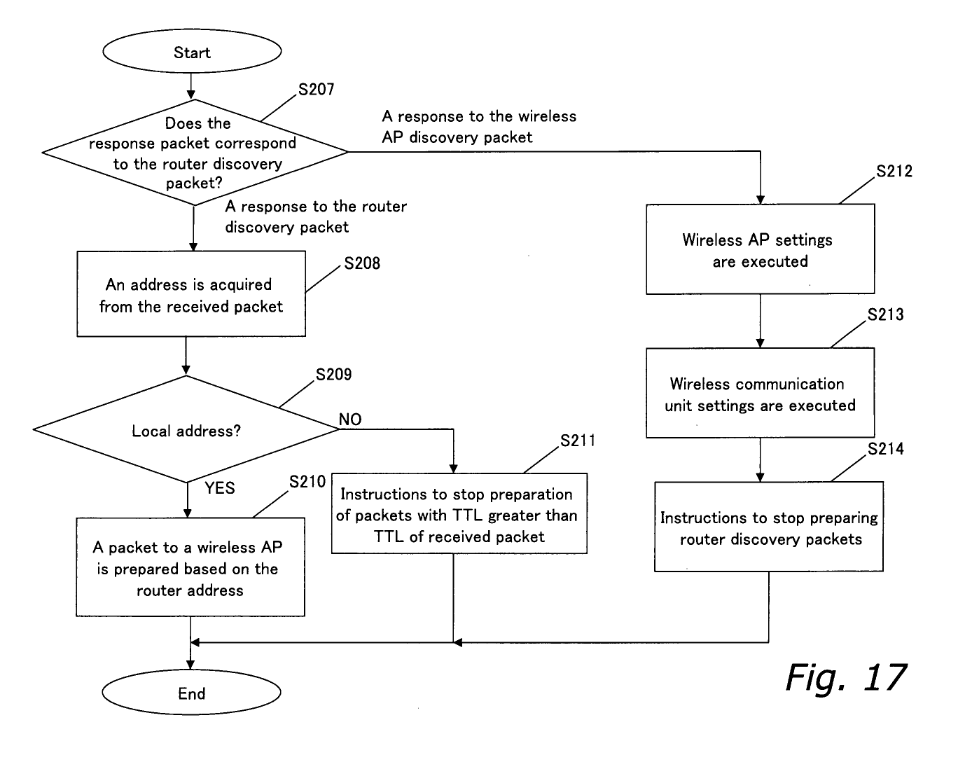

FIG. 17 shows a processing sequence for receipt of a response to a router discovery packet and wireless AP discovery packet. This reception processing sequence will be explained with reference to FIG. 17.

In step S207, first the wired communication unit 155, upon receiving from the home network 1002 a response packet corresponding to a router discovery packet or wireless AP discovery packet, delivers the received response packet to the packet transmission/reception unit 154. The packet transmission/reception unit 154 determines the content of the response packet, and upon determining that the same is a response packet to the router discovery packet or wireless AP discovery packet, delivers the packet information of the response packet to the received packet analysis unit 153.

The receive packet analysis unit 153, upon receiving the packet information of the response packet, determines whether the response packet is a response to a router discovery packet or a response to a wireless AP discovery packet.

Next, the communication device 150 performs processing that will be different depending on whether the response packet is a response to a router discovery packet or a response to a wireless AP discovery packet.

(4-1) Processing for Receipt of a Response Packet with Respect to a Router Discovery Packet

First, an explanation will be given of processing for receipt of a response packet in response to router discovery packet. When determination is made that a received packet is a response packet in response to a router discovery packet, the communication device 150 executes processes (S208, S209, S211) identical to S104-S107 of FIG. 8 explained in the first embodiment. The communication device 150, upon detecting the router LAN address, requests the discovery packet preparation unit 152 via the controller 151 to perform processing for preparation of a wireless AP discovery packet (S210). A more specific explanation is given below.

In step S208, the received packet analysis unit 153 extracts a destination port number contained in the data unit of the ICMP Time Exceeded packet, and identifies the TTL designated at time of transmission of the router discovery packet based on such information. The received packet analysis unit 153 extracts a source address from the ICMP Time Exceeded packet to acquire the LAN address of the router.

In step 209, the controller 151 of the communication device 150 determines whether the acquired router LAN address is a local address.

In step S210, when determination is made that the acquired LAN address of the router is a local address, the controller 151 of the communication device 150 instructs the discovery packet preparation unit 152 to prepare a wireless AP discovery packet. At this time, the controller 151 transmits the LAN side IP address of the router to the discovery packet preparation unit 152.

In step S211, when determination is made that the acquired LAN address of the router is a global address, the controller 151 of the communication device 150 instructs the discovery packet preparation unit 152 to stop preparing router discovery packets and ends the processing. When the LAN address is a global address, router detection in the home network is ended. As a result, control is performed in accordance with whether the acquired LAN address is a global address, allowing detection only of addresses of routers in the home network.

(4-2) Processing for Receipt of a Response Packet in Response to the Wireless AP Discovery Packet

Next, a process will be described in a case where the received response packet is a response to the wireless AP discovery packet.

In step S212, first, the received packet analysis unit 153 of the communication device 150 analyzes the content of a response packet in response to the wireless AP discovery packet. Here, the received packet analysis unit 153 acquires the equipment address of the wireless AP 160 and various information for establishing wireless communications from the response packet in response to the wireless AP discovery packet. The received packet analysis unit 153 outputs the equipment address of the wireless AP 160 and various information via the controller 151 to the wireless AP setting unit 156 and wireless communication setting unit 157. The wireless AP setting unit 156 uses the information obtained from the response packet to execute setting of the wireless AP 160. In other words, the wireless AP setting unit 156 accesses the wireless AP 160 based on the equipment address, and for the wireless AP 160, sets information for wireless communications such as an encryption key for wireless communications, communication channel, SSID (Service Set ID), MAC filtering (adding permission to the MAC of its own wireless communication unit 158) and performs settings so as to enable wireless communications by the wireless AP.

In step S213, the wireless communication setting unit 157 obtains information for wireless communications from the wireless AP 160 as necessary, and with respect to its own wireless communication unit 158, executes settings for wireless communications such as an encryption key for wireless communications, communication channel, SSID and the like.

In step S214, when settings have been completed, the controller 151 instructs the discovery packet preparation unit 152 to stop preparing wireless AP discovery packets and router discovery packets.

Described above are a method for setting a wireless AP and a method for obtaining information from a wireless AP, but because a wireless AP normally comprises a wired communication function and has therein a Web-based user interface, by transmission of a suitable http message to the IP address of a wired communication unit of a wireless AP, wireless communication information of a wireless AP can be set, and information set in advance can be obtained.

Further, the UPnP WLAN Access Point Device V1.0 specification (a detailed document can be obtained from: http://UPnP.org/standardizeddcps/wlanap.asp) may be used to set a wireless AP. More specifically, as a wireless AP discovery packet, an M-Search request is transmitted in unicast mode. A WLAN Access Point Device is discovered from the response packet and a device description and service description are acquired. Through the acquired information, the action request target is recognized and the action request is transmitted to a wireless AP. With such a constitution, wireless communication information of a wireless AP can be set, and/or information set in advance can be acquired.

Effects

As described above, the communication device is constituted so that router discovery packets in which the TTL is a variable are transmitted to acquire router addresses of routers in a home network. Further, the communication device can be configured so that equipment discovery packets are transmitted based on these router addresses to acquire addresses of communication equipments connected to the routers. As a result, even in a home network comprising multiple routers, the communication device is capable of performing various settings for accessing such communication equipment and establishing communications therewith.

According to this second embodiment, after a wireless AP is discovered, settings for the wireless AP 160 and wireless communication unit 158 are performed. Alternatively, information relating to wireless set for the wireless AP 160 in advance (encryption key, channel information, SSID and the like) can be read by the wireless communication unit 158 so that only processing for setting the wireless communication unit 158 based on the read information is performed. Another setting may be such that the wireless AP setting unit 156 performs setting of the wireless AP only.

Further, in this second embodiment, an explanation was given, with respect to a wireless AP initially discovered in the home network, of an example where the overall processing ends upon completion of settings; alternatively, after all the wireless APs 160 connected to the home network are discovered, a user is caused to select a wireless AP, and settings with respect to that wireless AP 160 are executed. In another alternative configuration, setting information is acquired from the selected wireless AP and settings for the wireless communication unit 158 are executed. Further, both of the above may be executed.

Further, an explanation was given, with respect to a wireless AP initially discovered in the home network, of an example where the overall processing ends upon completion of settings; alternatively, instead of ending processing after completing the settings of the initial wireless AP, a packet for discovering a wireless AP is transmitted to addresses of all possible wireless APs and settings are executed for all wireless APs in the home network.

### THIRD EMBODIMENT

### A Case of Using UPnP

A third embodiment of the present invention will be explained. In the first embodiment the TTL of a router discovery packet is changed to acquire the LAN addresses of routers, and based on such addresses, NAT and firewall settings are carried out with respect to the routers. On the other hand, in the third embodiment, first, the UPnP (Universal Plug and Play) IGD (Internet Gateway Device) specification or the like is used to acquire a router LAN address. Thereafter, a WAN address is acquired based on the router LAN address, and based on the acquired WAN address, an address of a higher level router is acquired. Router settings are made in this manner in the third embodiment. Regarding the UPnP IGD specification, detailed descriptions can be found in the publication of the UPnP FORUM, Universal Plug and Play Device Architecture Version 1.0.1 (the document is located at: http://www.UPnP.org/resources/documents.asp), and Internet Gateway Device (IGD) V1.0 (the document is located at: http://www.UPnP.org/standardizeddcps/igd.asp).

(Overall Constitution)

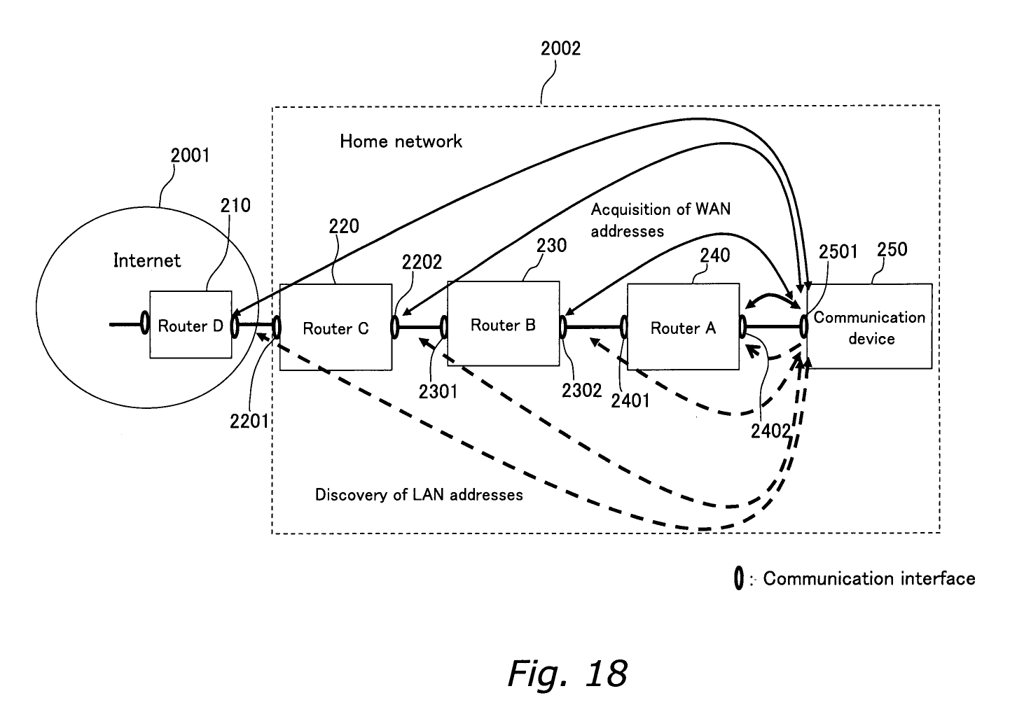

FIG. 18 is a block diagram of a home network according to the third embodiment of the present invention. An Internet 2001 and home network 2002 are connected to each other. The Internet 2001 comprises a router 210D. The home network 2002 comprises multiple routers including routers 220C, 230B, and 240A. The router 220C is disposed at the border with the Internet 2001, and the router 230B and router 240A are disposed in such order. The router 240A has connected thereto a communication device 250 constituted by a user-operable PC or the like. A communication device 250 comprises a communication interface 2501.

The router 220C comprises a LAN side communication interface 2202 and WAN side communication interface 2201, and a local area address is allocated to the LAN side communication interface, and a global address is allocated to the WAN side communication interface. The router 230B comprises a LAN side communication interface 2302 and WAN side communication interface 2301, and the router 240A comprises a LAN side communication interface 2402 and WAN side communication interface 2401. Here, when the router 220C uses the global address to connect the router 210D on the Internet 2001 to make communications, connection between the home network 2002 and Internet 2001 is established.

Communication Device Configuration

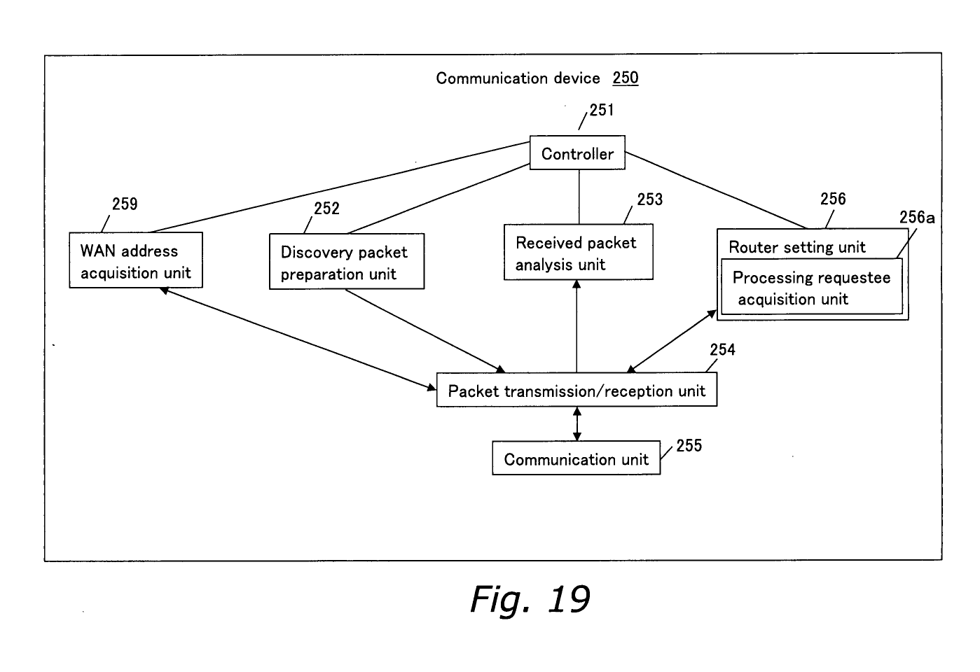

FIG. 19 is a block diagram of the communication device 250 according to the third embodiment. This communication device 250 comprises a controller 251, discovery packet preparation unit 252, received packet analysis unit 253, packet transmission/reception unit 254, communication unit 255, router setting unit 256, and WAN address acquisition unit 259. The controller 251 gives instructions for processing to the functional units. The discovery packet preparation unit 252 prepares packets for discovering routers (“router discovery packet”), and gives instructions for transmission. The received packet analysis unit 253 analyzes packets transmitted from the routers in response to the router discovery packets, and acquires the address of each router to learn router configuration. The packet transmission/reception unit 254 gives instructions for packet transmission processing to the communication unit 255, analyzes the packets received by the communication unit 255, and delivers the same to a functional unit corresponding to the received packet. The communication unit 255 has a built in communication interface function to enable packet transmission/reception to and from the network. The router setting unit 256 executes router settings in the home network. Further, the router setting unit 256 comprises a processing requestee acquisition unit 256a for accessing the routers based on the acquired addresses to acquire a requestee for making router NAT settings or the like. The WAN address acquisition unit 259 acquires a WAN address of a router using the UPnP IGD specification.

Router Setting Operations

An explanation will be given of operations of the communication device 250 connected to the home network 2002 thus set for executing router settings.

(1) Processing for Receipt of a Response Packet in Response to the Router Discovery Packet

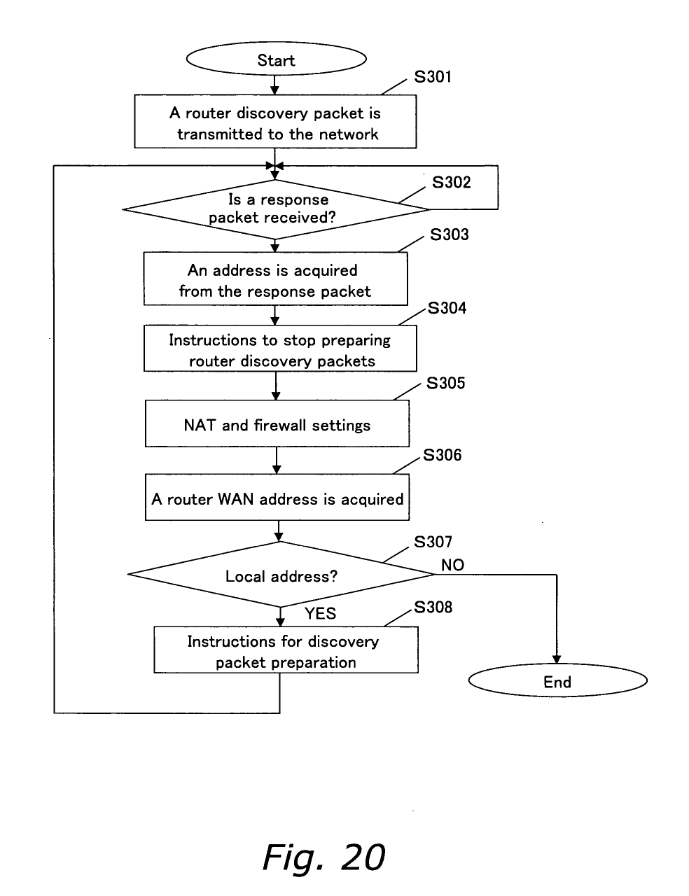

FIG. 20 shows the processing sequence for receiving a response packet of a router with respect to a router discovery packet. With reference to FIG. 20, an explanation will be given of the processing sequence for receiving a response packet in response to the router discovery packet.

In step S301, the controller 251 of the communication device 250 instructs the discovery packet preparation unit 252 to detect the routers in the network to which the communication device 250 is connected. The discovery packet preparation unit 252, having received the instruction, transmits in multicast mode a UPnP M-Search discovery message.

In step S302, the controller 251 of the communication device 250 determines whether a response packet has been received from a router with respect to the router discovery packet transmitted by the communication unit 255 and packet transmission/reception unit 254, and waits for receipt of the response packet.

In step S303, the received packet analysis unit 253 of the communication device 250, upon receiving a response packet from a router, analyzes the received packet to acquire the LAN address of the router. In a case where UPnP is used, the processing requestee acquisition unit 256a of the router setting unit 256 uses information contained in the response packet to acquire a device description and service description and information for action transmission together therewith. Examples of the information for action transmission include a destination for the action and the like.

In step S304, when the current received response packet is a response packet in response to a router discovery packet prepared and transmitted by the discovery packet preparation unit 252, the controller 251 of the communication device 250 instructs the discovery packet preparation unit 252 to stop the router discovery packet preparation.

In step S305, the router setting unit 256 of the communication device 250 accesses the router based on the router LAN address acquired from the response packet or the information acquired by the processing requestee acquisition unit 256a, and executes NAT and/or firewall settings in the same manner as in the first embodiment.

In step S306, the controller 251 of the communication device 250 transmits the LAN address acquired by the received packet analysis unit 253 to the WAN address acquisition unit 259, and gives instructions for acquisition of the WAN address of the detected router. The WAN address acquisition unit 259 acquires the router WAN address.

As one example of a method for acquiring a router WAN address, an explanation will be given of a case where the UPnP IGD specification is used. When the UPnP IGD specification is used, to the action destination obtained in step S303, a GetExternalIPAddress action is transmitted. Based on the response from the router with respect thereto, a router WAN address can be obtained.

Because a conventional router has a Web-based user interface, a router WAN address can be confirmed using this user interface. Alternatively, a suitable http message may be transmitted to the router and a response packet thereto is received so as to obtain a router WAN address.

In step S307, the controller 251 of the communication device 250 confirms whether the acquired WAN address of the router is a local address. When determination is made that the acquired WAN address of the router is a global address, the controller 251 of the communication device 250 specifies any higher level router as a router on the Internet and ends the processing. In other words, the processing is ended on the assumption that router settings have been completed for all routers in the home network 2002.

In step S308, when determination is made that the router WAN address is a local address, the controller 251 of the communication device 250 recognizes that above the discovered router there is another router in the home network. The controller 251 delivers the WAN address of the discovered router to the discovery packet preparation unit 252, and gives instructions for preparing a router discovery packet. Thereafter, the controller 251 of the communication device 250 again waits for receipt of a response packet with respect to the transmitted router discovery packet.

Here, as one example, a UPnP M-Search discovery message is transmitted in multicast and unicast modes to detect the router. Alternatively, as in the second embodiment, a suitable http message can be transmitted and the response thereof received so as to confirm that the respondent is a router. Further, there is usually match between an address of the router to which the communication device 250 is connected and the default GW address of the communication device 250, and between the address of the higher level router to which the router is connected and the default GW (Gateway) address of the WAN side interface of the router. For this reason, a suitable http message can be transmitted to the detected router, the default GW address of the router WAN side interface is acquired, and processing is executed starting from S305 using the acquired default GW address as the address of the higher level router (steps S301-S304 are omitted).

The foregoing is the processing sequence for receiving a router discovery packet.

(2) Router Discovery Packet Transmission Processing

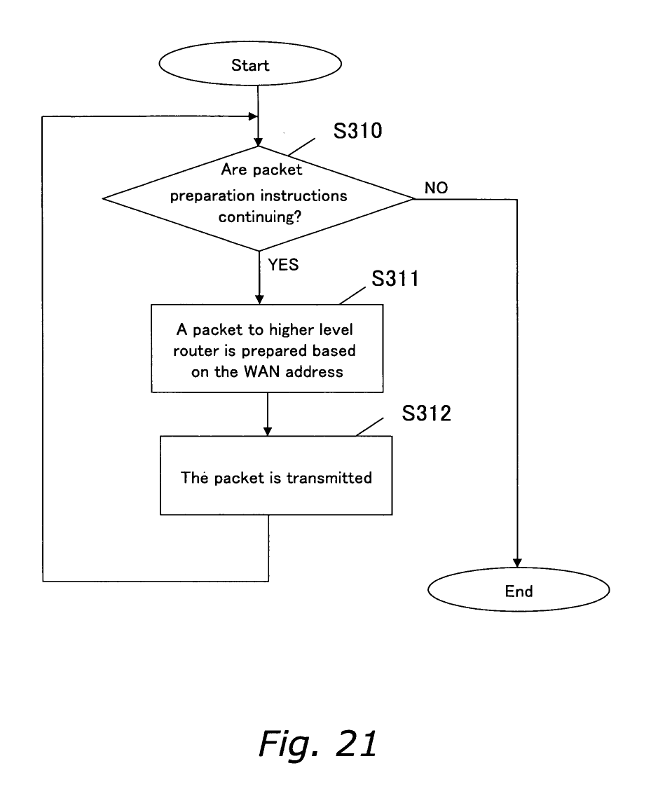

Next, with reference to FIG. 21, an explanation will be given of router discovery packet transmission processing executed by the discovery packet preparation unit 252.

In step S310, the communication device 250 determines whether router discovery packet preparation instructions by the controller 251 are continuing. The communication device 250, by executing this determination, detects a router in a state where router discovery packet preparation and response reception processing are independently operated, and when router discovery packets no longer need to be transmitted, this processing can be stopped.

When instructions have been given for router discovery packet preparation, the controller 251 of the communication device 250 transmits to the discovery packet preparation unit 252 the address that is the basis for preparing the router LAN address, that is, the router WAN address. The discovery packet preparation unit 252 acquires the WAN address of the router from the controller 251.

In step S311, the discovery packet preparation unit 252 of the communication device 250 conjectures the LAN address of the higher level router based on the WAN address received from the controller 251, and generates a router discovery packet based on the conjectured LAN address.

In step S312, the discovery packet preparation unit 252 of the communication device 250 transmits the generated router discovery packet via the packet transmission/reception unit 254 and communication unit 255 into the home network.

In a case of router discovery packet transmission processing using UPnP, with respect to the conjectured address, an M-Search request is transmitted in unicast mode (while according to the UPnP FORUM standards, an M-Search can be received only in multicast mode, most routers are able to receive an M-Search in unicast mode as well).

Because a conventional router has a Web-based user interface, as in the second embodiment and the like, a suitable http message is transmitted to a conjectured address, and a response packet thereto is received to detect the router.

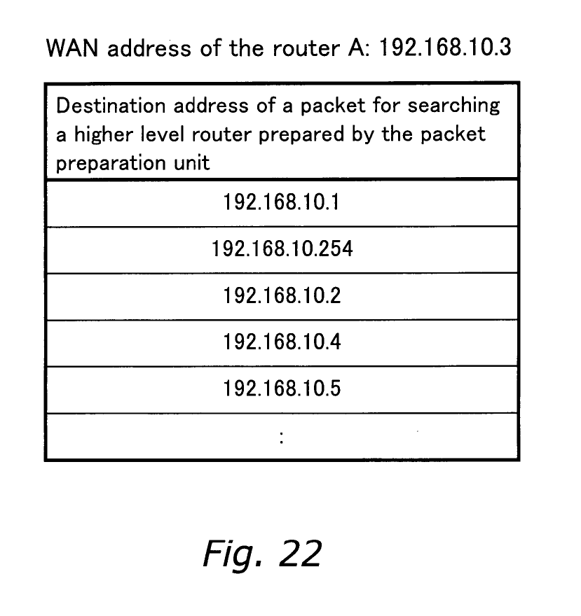

FIG. 22 shows an address of a higher level router conjectured by the discovery packet preparation unit 252. When a router is used in the state in which it was shipped from a plant, a class C local address is used as the router LAN address, and the lowest 8 bits thereof is 1 or 254. For this reason, the discovery packet preparation unit 252, when conjecturing the address of a higher level router, gives priority handling to a router WAN address acquired from the controller 251 in which the lowest 8 bits have been substituted by 1 or 254. The discovery packet preparation unit 252 prepares and transmits a router discovery packet to this substituted address. With this processing, the communication device 250 is capable of detecting a higher level router at a higher speed than randomly conjecturing an address. Further, even when a user changes a router LAN address, because the user often sets the address at a specific value such as 64, 128 or the like, router discovery packets are also preferentially transmitted to certain addresses in which the lowest 8 bits have been set to values that users frequently specify in the manner.

Further, the discovery packet preparation unit 252 may be configured so as to operate separately from the discovery packet reception processing, and to transmit a subsequent discovery packet before waiting for determination of the result of response to the transmitted router discovery packet. Execution of such transmission processing enables the high-speed discovery of a higher level router.

Effects

In this third embodiment, with the above constitution, based on a router WAN address, the router LAN address of a router more toward the Internet than the above router is acquired to learn the router configuration. Therefore, the router configuration can be acquired without preparing router discovery packets in which the TTL has been changed, or transmitting prepared packets into the home network.

Further, because there is no forwarding of router discovery packets in which the TTL has been changed, even when a home network comprises a router not performing decrementing of the TTL at time of forwarding a router discovery packet, the home network router configuration can be learned. Further, because there is no processing for receipt of a router response packet with respect to a router discovery packet, even when there is a router that filters a router response packet, the home network router configuration can be learned.

In the present embodiment, an explanation was given for an example wherein when a response to a router discovery packet is received, instructions are given for stopping router discovery packet preparation. Alternatively, instructions for stopping router discovery packet preparation may be given to all possible router addresses at time of router discovery packet transmissions. With such a constitution, even when a router is connected to multiple routers or the like (multihoming or the like), NAT and firewall settings can be accurately executed.

### FOURTH EMBODIMENT

### Wireless Settings Using UPnP

A fourth embodiment of the present invention will be explained with reference to the drawings. In the above second embodiment, the TTL of router discovery packets is changed to acquire router LAN addresses, a wireless AP is detected based on those addresses, and settings of its own wireless function and wireless AP are performed by the communication device 350. On the other hand, in this fourth embodiment, the WAN addresses of routers in the home network are acquired in the same manner as in the third embodiment, a wireless AP is discovered based on these addresses, and the communication device 350 performs settings for its own wireless communication function and for the wireless AP.

Overall Constitution

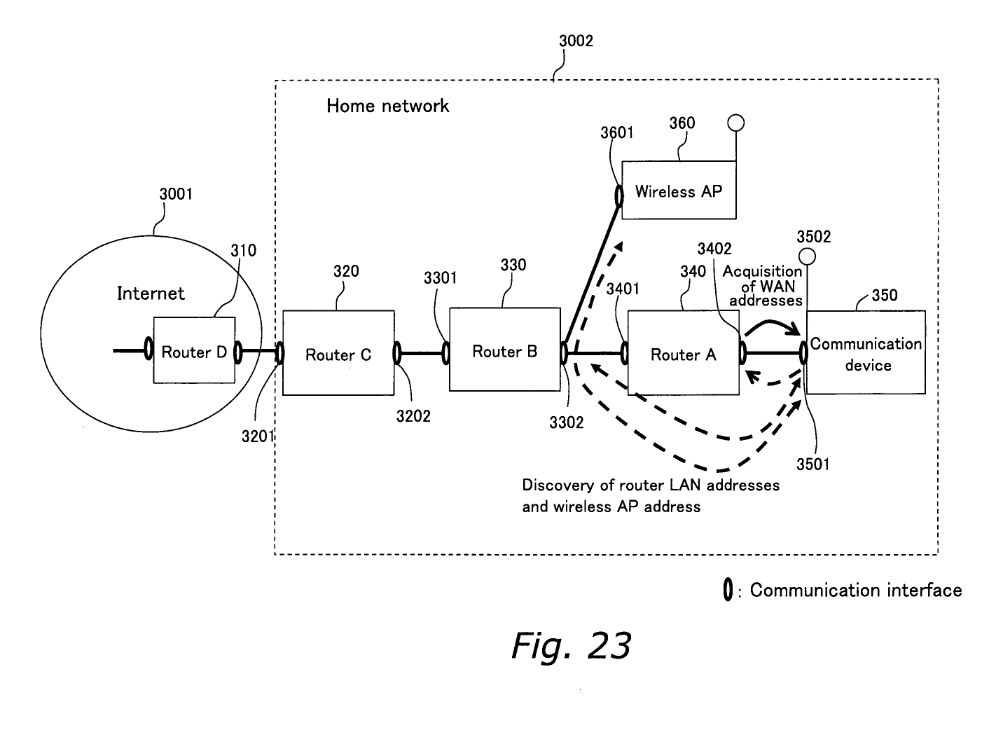

FIG. 23 is a block diagram of a home network according to an embodiment of the present invention. In FIG. 23, an Internet 3001 and home network 3002 are connected to each other. The Internet 3001 comprises a router 310D. The home network 3002 comprises multiple routers including routers 320C, 330B, and 340A. The router 320C is disposed at the border with the Internet, and the router 330B and router 340A are disposed in such order. Here, the router 320C is a wireless router comprising a wireless AP (access point) function. Further, the router 330B has connected thereto a wireless AP 360, and the router 340A has connected thereto a communication device 350 constituted by a user-operable PC or the like. The communication device 350 comprises a wired communication interface 3501 and wireless communication interface 3502, and performs wireless communication function settings of its own device and wireless AP 360 (described below).

The router 320C comprises a LAN side communication interface 3202 and WAN side communication interface 3201, and a local area address is allocated to the LAN side communication interface, and a global address is allocated to the WAN side communication interface. The router 330B comprises a LAN side communication interface 3302 and WAN side communication interface 3301, and the router 340A comprises a LAN side communication interface 3402 and WAN side communication interface 3401. Here, when the router 320C uses the global address to connect to the router 310D on the Internet 3001 that is to make communications, connection between the home network 3002 and Internet 3001 is established. Further, the wireless AP 360 comprises a communication interface 3601.

Communication Device Configuration

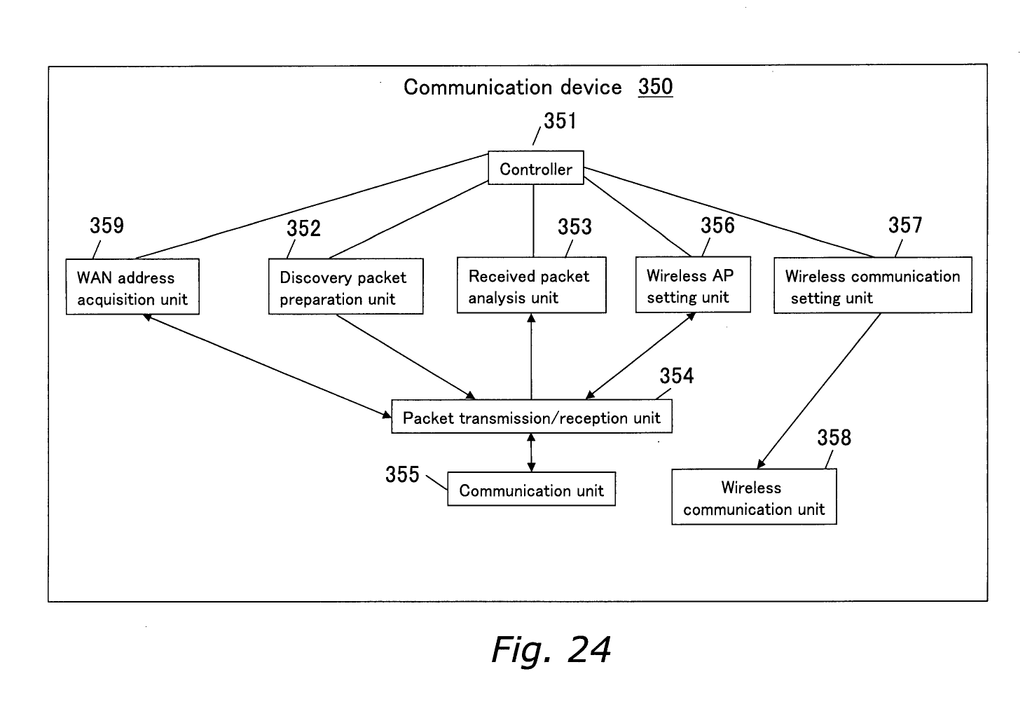

FIG. 24 shows a block diagram of the communication device 350 according to the fourth embodiment. This communication device 350 comprises a controller 351, discovery packet preparation unit 352, received packet analysis unit 353, packet transmission/reception unit 354, communication unit 355, wireless AP setting unit 356, wireless communication setting unit 357, wireless communication unit 358, and WAN address acquisition unit 359.

The controller 351 gives instructions for processing to the functional units. The discovery packet preparation unit 352 prepares packets for discovering routers (“router discovery packet”) and gives instructions for transmission. Further, the discovery packet preparation unit 352 prepares packets for discovering a communication equipment connected to a router (“equipment discovery packet”) and gives instructions for transmission. The received packet analysis unit 353 analyzes packets transmitted from the routers in response to the router discovery packets, and acquires the address of each router to learn the router configuration. The packet transmission/reception unit 354 gives instructions for packet transmission processing to the communication unit 355, analyzes the packets received by the communication unit 355, and delivers the same to a functional unit corresponding to the received packet. The communication unit 355 has a communication interface function to enable packet transmission/reception to and from the network. The wireless AP setting unit 356 performs settings, with respect to the wireless AP 360, of an encryption key, SSID or other identification information, wireless channel, authentication information and the like. The wireless communication setting unit 357 performs settings, with respect to the wireless communication unit 358 of its own device, for an encryption key, SSID or other identification information, wireless channel, authentication information and the like. The wireless communication unit 358 enables wireless communications. The WAN address acquisition unit 359 uses the UPnP IGD specification to acquire router WAN addresses.

Router and Wireless Network Setting Operations

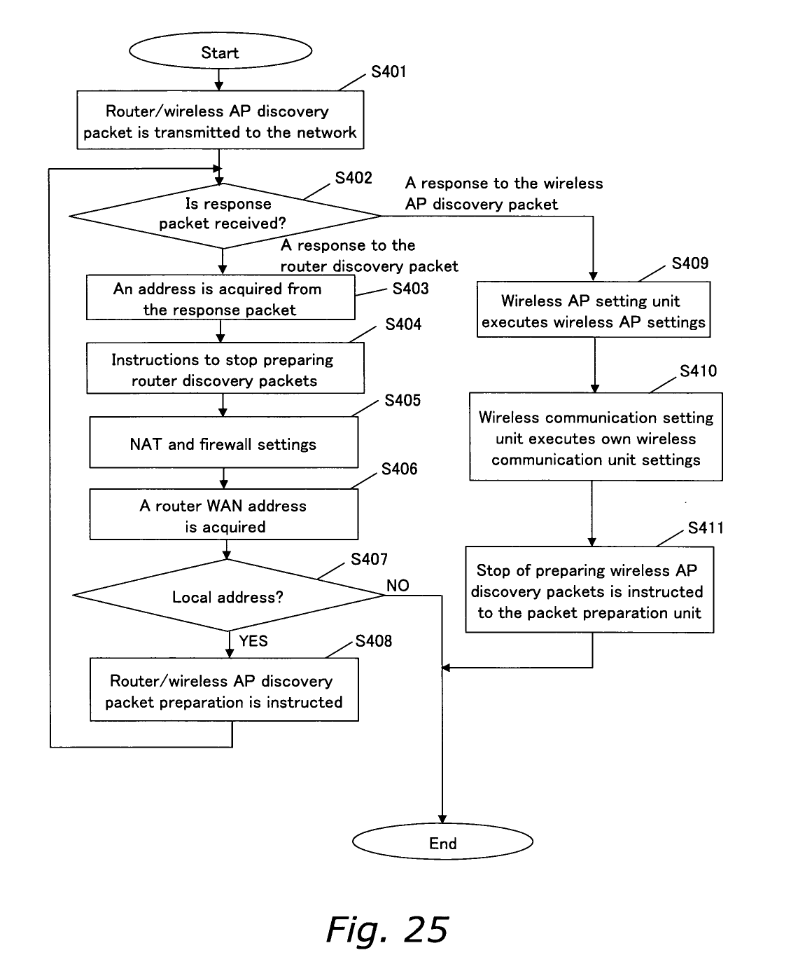

An explanation will be given of operations of the communication device 350 thus configured. FIG. 25 shows the processing sequence for receiving a response with respect to a router/wireless AP discovery packet. In the drawing, steps S401-S408 regarding router detection and NAT and firewall settings for a router are the same as in the third embodiment.

(1) Response Packet Reception Processing

In step S401, the controller 351 of the communication device 350 instructs the discovery packet preparation unit 352 to detect the router to which the communication device 350 is connected and wireless APs. The discovery packet preparation unit 352, having received the instructions, transmits in multicast mode a UPnP M-Search discovery message for detecting routers (IGD: Internet Gateway Device) and wireless APs (WLAN Access Point Device).

Described herein is one example in which the communication device 350 transmits in multicast mode a UPnP M-Search discovery message to detect routers. As in the third embodiment, the communication device 350 first conjectures addresses of routers and wireless APs, transmits suitable http messages in unicast mode, and receives response packets with respect to the http messages, thereby detecting routers and wireless APs.

In step S402, the controller 351 of the communication device 350 determines whether a response packet with respect to the router/wireless AP discovery packet prepared by the discovery packet preparation unit 352 has been received via the communication unit 355 and packet transmission/reception unit 354. Here, when a response packet has been received, determination is made whether the response packet is a response packet in response to a router discovery packet or a response packet in response to a wireless AP discovery packet.

Next, the communication device 350 performs processing that differs depending on whether the response packet is a response packet in response to a router discovery packet or a response to a wireless AP discovery packet.

(1-1) Processing for Receipt of a Response Packet in Response to a Router Discovery Packet

First, processing for receipt of a response packet to the router discovery packet will be explained. If a response packet in response to the router discovery packet has been received from a router, the communication device 350 executes processing (S403-S408) as in the third embodiment (described below).

In step S403, the received packet analysis unit 353 of the communication device 350 analyzes the received packet to acquire address information of the router. In case where UPnP is used, information written in the response packet is used, a device description and service description are acquired, and information for action transmission is also acquired. Examples of information for action transmission include an address to which the action is transmitted.

In step S404, when determination is made that the currently received packet is a response packet in response to a router discovery packet prepared and transmitted by the discovery packet preparation unit 352, the controller 351 of the communication device 350 instructs the discovery packet preparation unit 352 to stop preparing router discovery packets.

In step S405, the wireless AP setting unit 356 of the communication device 350 accesses the router based on the LAN address of the acquired router, and as in the first embodiment, executes NAT and/or firewall settings.

In step S406, the controller 351 of the communication device 350 instructs the WAN address acquisition unit 359 to acquire the WAN address of the detected router. The WAN address acquisition unit 359 executes processing for acquiring the router WAN address.

As one example of a method for acquiring the router WAN address, an explanation will be given of a case of using the UPnP IGD specification. When the UPnP IGD specification is used, to the action destination obtained in step S403, a GetExternalIPAddress action is transmitted. Based on the response packet from the router with respect thereto, the router WAN address can be obtained.

Because a conventional router has a Web-based user interface, the router WAN address can be confirmed by this user interface. For this reason, a suitable http message is transmitted to the router, and a response packet thereto is received so as to acquire the router WAN address.

In step S407, the controller 351 of the communication device 350 determines whether the WAN address of the acquired router is a local address or global address. When determination is made that the WAN address of the acquired router is a global address, the controller 351 of the communication device 350 assumes that the higher level router of this router is a router on the Internet and ends this processing. In other words, the processing is ended on the assumption that router settings have been completed for all of the routers in the home network 3002.

In step S408, when determination is made that the WAN address of the acquired router is a local address, the controller 351 of the communication device 350 recognizes that there still is a router higher than the detected router in the home network. The controller 351 delivers the WAN address of the detected router to the discovery packet preparation unit 352, and gives instructions for preparing a router discovery packet and wireless AP discovery packet. The controller 351 of the communication device 350 waits for receipt of another response packet in response to the router discovery packet or wireless AP discovery packet.

(1-2) Processing for Receipt of a Response Packet in Response to a Wireless AP Discovery Packet

Next, processing for receipt of a response packet from the wireless AP will be explained. When a response packet from the wireless AP has been received, the communication device 350 executes processes (S409-S411) corresponding to S212-S214 of the second embodiment.

In step S409, the received packet analysis unit 353 of the communication device 350 analyzes the received response packet. Here, the received packet analysis unit 353 acquires the equipment address of the wireless AP 360 and various information for establishing wireless communications from the response packet in response to the wireless AP discovery packet. The received packet analysis unit 353 outputs the equipment address of the wireless AP 360 and various information via the controller 351 to the wireless AP setting unit 356 and wireless communication setting unit 357. The wireless AP setting unit 356 uses the information obtained from the response packet and executes settings for the wireless AP 360. In other words, the wireless AP setting unit 356 accesses the wireless AP 360 based on the equipment address, and with respect to the wireless AP 360, makes settings for an encryption key for wireless communications, communication channel, SSID, MAC filtering (addition of permission for a MAC of its own wireless communication unit 358) and other information for wireless communications, and performs settings so as to enable the wireless AP to perform wireless communications.

In step S410, the wireless communication setting unit 357 of the communication device 350 acquires information for wireless communications from the wireless AP 360 as necessary. The wireless communication setting unit 357 then executes settings, with respect to the wireless communication unit 358 of its own communication device 350, for an encryption key for wireless communications, communication channel, SSID and other settings for wireless communications.

In step S411, when the settings have been completed, the controller 351 of the communication device 350 instructs the discovery packet preparation unit 352 to stop preparing wireless AP discovery packets and router discovery packets.

Described above are a method for setting a wireless AP and a method for obtaining information from a wireless AP, but because a wireless AP normally comprises a wired communication function and has therein a Web-based user interface, by transmission of a suitable http message to the IP address of a wired communication unit of a wireless AP, wireless communication information of a wireless AP can be set, and information set in advance can be obtained.

Alternatively, the UPnP WLAN Access Point Device V1.0 specification (detailed document can be obtained from: http://UPnP.org/standardizeddcps/wlanap.asp) can be used to set the wireless AP. More specifically, an M-Search request is transmitted in unicast mode from the communication device 350 as a wireless AP discovery packet, and a WLAN Access Point Device is detected and device description and service deception are acquired. The communication device 350 can recognize the issuer of the action request from the acquired information, and transmit the action request to the wireless AP, enabling the communication device 350 to set wireless communication information of the wireless AP and acquire information set in advance.

(2) Processing for Transmitting a Router Discovery Packet and Wireless AP Discovery Packet

Next, an explanation will be given of processing for transmitting a router discovery packet and wireless AP discovery packet.

(2-1) Processing for Transmitting a Router Discovery Packet

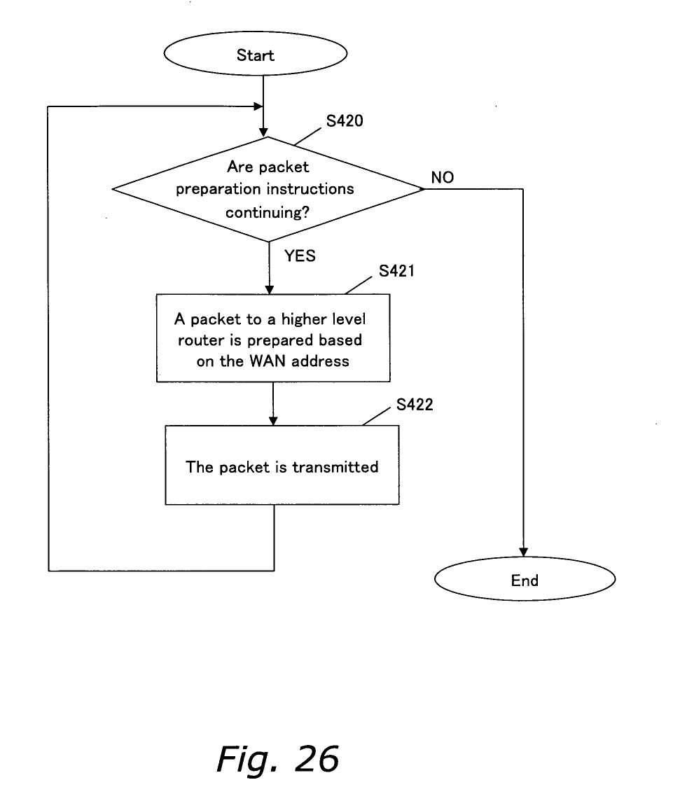

First, an explanation will be given of processing for transmitting a router discovery packet and wireless AP discovery packet executed by the discovery packet preparation unit 352. FIG. 26 shows one example of processing for transmitting a router discovery packet. The processing for transmitting a router discovery packet shown in FIG. 26 is identical to that of the third embodiment, and the processing sequence thereof is as in steps S310-312 of FIG. 21.

In step S420, the communication device 350 determines whether router discovery packet preparation instructions from the controller 351 are continuing. The communication device 350, by executing this determination, detects routers in a state where router discovery packet preparation and processing for receipt of a response to the router discovery packet are independently operated, and when a router discovery packet does not need to be transmitted, this processing can be stopped.

When instructions have been given for router discovery packet preparation, the controller 351 of the communication device 350 transmits an address that is a basis for preparing a router LAN address, that is, as a router WAN address, a destination address of the router discovery packet is transmitted to the discovery packet preparation unit 352. The discovery packet preparation unit 352 acquires the router WAN address from the controller 351.

In step S421, the discovery packet preparation unit 352 of the communication device 350 conjectures the LAN address of the higher level router according to the address received from the controller 351 to generate a router discovery packet based on the LAN address.

In step S422, the discovery packet preparation unit 352 transmits the generated router discovery packet via the packet transmission/reception unit 354 and communication unit 355.

(2-2) Processing for Transmitting a Wireless AP Discovery Packet

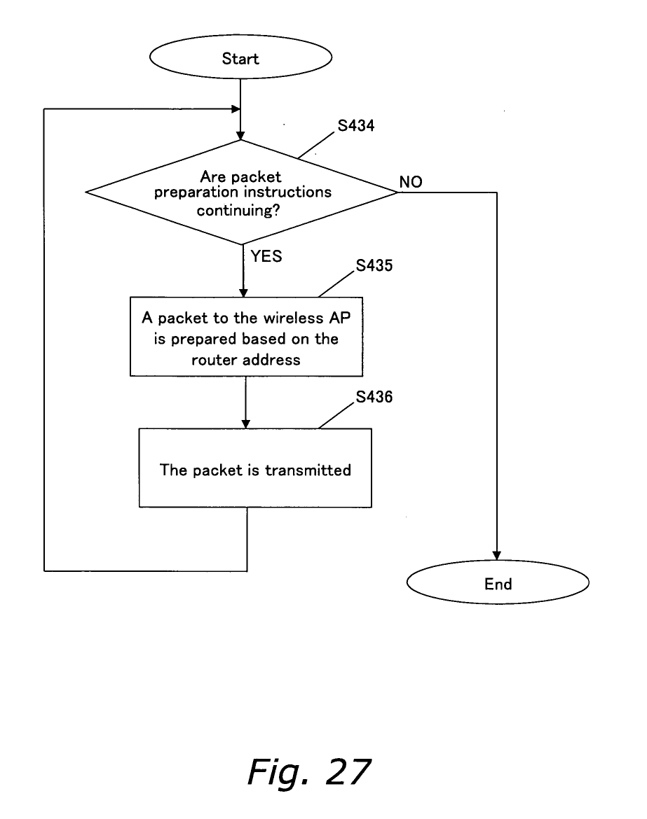

Next, an explanation will be given of processing for transmitting a wireless AP discovery packet executed by the discovery packet preparation unit 352. FIG. 27 shows one example of the processing for transmitting a wireless AP discovery packet. The processing for transmitting the wireless AP discovery packet is identical to that of the second embodiment, and the processing sequence thereof is the same as steps S204-S206 of FIG. 15.

In step S434, the communication device 350 determines whether the controller 351 has given instructions for wireless AP discovery packet preparation.

When determination is made that instructions for wireless AP discovery packet preparation are not continuing, the communication device 350 stops preparing wireless AP discovery packets and ends the processing.

In step S435, when determination is made that instructions have been made for wireless AP discovery packet preparation by the controller 351, the discovery packet preparation unit 352 of the communication device 350 conjectures an address of the wireless AP based on the IP address of the router instructed by the controller 351 to prepare the wireless AP discovery packet.

The timing at which the controller 351 gives instructions to stop preparing wireless AP discovery packets is described in the above sections on processing sequence for receiving router and wireless AP discovery packets.

In step S436, when the discovery packet preparation unit 352 conjectures an address of the wireless AP 360 and completes preparation of the wireless AP discovery packet, the packet transmission/reception unit 354 and wired communication unit 355 transmit the wireless AP discovery packet to the home network 3002.

In the above step S435, as a method for conjecture of a destination address for the wireless AP discovery packet by the discovery packet preparation unit 352, an address type (class A, class B, class C) is first determined, and bits in the address that are variable in the same network are selected, and those values are changed in order.

Effects

The communication device according to the fourth embodiment, after acquiring a router LAN address, acquires the WAN address of the router. Based on the acquired WAN address, the communication device acquires the address of a wireless AP and the address of a higher level router. Further, based on the acquired wireless AP address and router address, the communication device performs network settings, including network settings relating to wireless and network settings relating to router settings. Therefore, the router configuration can be acquired without preparing router discovery packets in which the TTL has been changed and transmitting the prepared packets into the home network.

Further, because there is no forwarding of router discovery packets in which the TTL has been changed, even in a case where a home network comprises a router not decrementing the TTL when a router discovery packet is forwarded, the home network router configuration can be learned. Further, because there is no receiving of a router response packet in response to the router discovery packet, even when there is a router that filters router response packets, the home network router configuration can be learned.

Further, in the fourth embodiment, an explanation was given of an example wherein upon completion of setting the wireless AP 360 initially detected in the home network, the whole processing ends. Alternatively, after all wireless APs connected to the home network are detected, a user can be caused to select a wireless AP to be set, and the settings for the wireless AP 360 are then executed. Alternatively, information is acquired from the selected wireless AP 360, and settings for the wireless communication unit 358 of the communication device 350 can be executed based on the acquired information. Alternatively, both settings for the wireless AP 360 and wireless communication unit 358 of the communication device 350 are executed.

This fourth embodiment discloses that after the wireless AP 360 is detected, settings for the wireless AP 360 and wireless communication unit 358 of the communication device 350 are carried out. Alternatively, the wireless communication setting unit 357 reads wireless-related information set in advance in the wireless AP 360 (encryption key, channel information, SSID and the like), and then only processing for setting the wireless communication unit 358 is performed, based on the information read by the wireless communication setting unit 357. Further, the wireless AP setting unit 356 may perform only settings for the wireless AP.

Further, in this fourth embodiment, an explanation was given of an example in which wireless settings were performed for each wireless AP every time a wireless AP 360 is detected in the home network. Alternatively, after all wireless APs 360 connected to the home network are detected, a user is caused to select a wireless AP to be set, and settings for the selected wireless AP 360 are carried out. Alternatively, information may be acquired from the selected wireless AP to execute settings of the wireless communication unit 358 of the communication device 350. Further, both settings of the wireless AP 360 and wireless communication unit 358 of the communication device 350 may be executed.

Further, in the fourth embodiment, an explanation was given of an example wherein upon completion of settings for the wireless AP initially discovered in the home network, the discovery processing for the wireless AP ends. Alternatively, without ending the processing after completion of the initial wireless AP settings, packets for discovering wireless APs are transmitted to all possible wireless APs, and settings of all wireless APs in the home network are performed.

Further, in the fourth embodiment, an explanation was given of an example where when a response to the router discovery packet has been received, instructions are given for stopping router discovery packet preparation. Alternatively, the stopping of router discovery packet preparation is carried out at time of router discovery packet transmission to all possible router addresses. With such a constitution, even when a certain router is connected to multiple routers or the like (multihoming etc.), NAT and firewall settings can be accurately executed.

### FIFTH EMBODIMENT

### Router Detection Using an ICMP and UPnP

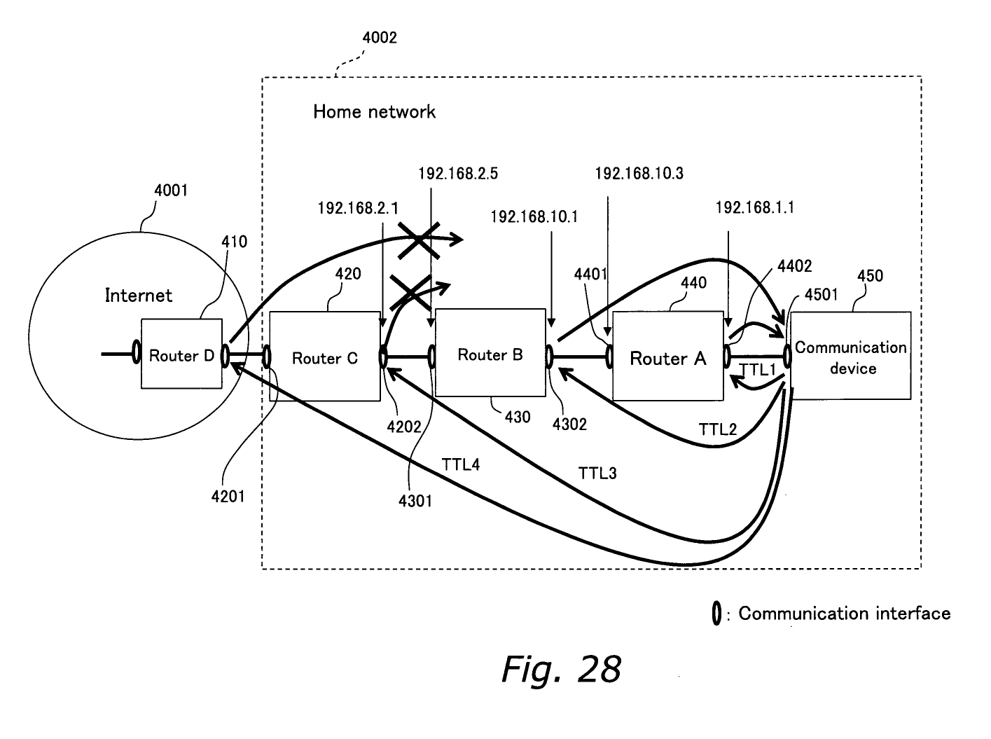

A fifth embodiment of the present invention will be explained with reference to the drawings. FIG. 28 shows the constitution of a home network for explaining the outline of the fifth embodiment.

For the first embodiment, an explanation was given of a method for changing the TTL of a router discovery packet to acquire the LAN address of a router, and performing router settings with respect to the router. Such a method can be executed without having to wait for response to transmitted router discovery packets in which the TTL has been changed. Therefore, addresses of routers in the home network to which the communication device 50 is connected can be learned extremely efficiently, enabling execution of router settings.

Among commercial routers, there are routers that filter ICMP Time Exceeded packets. For this reason, when the above method is applied to a home network comprising such a router, there will be cases where an ICMP Time Exceeded packet for a higher level router is discarded at a midway point. Therefore, routers in the home network may not be accurately detected. As a result, there is the problem that router settings are not completely made.

For example, FIG. 28 shows an example where a router 430B discards ICMP Time Exceeded packets. In this case, let us assume that the routers 420C and 410D receive router discovery packets in which the TTL is respectively set at 3 and 4, and transmit ICMP Time Exceeded packets corresponding thereto to a communication device 450. However, the ICMP Time Exceeded packets from the routers 420C and 410D are discarded by the router 430B. Therefore, the communication device 450 is unable to detect the router 420C, which is a router in the home network.

Meanwhile, in the third embodiment, explanation was given of a method for acquiring the WAN address of a router, and based on the address, a higher level router is detected and router settings are performed. Because no ICMP packets are used, this method is applicable to a home network comprising a router that filters ICMP Time Exceeded packets. However, when a router discovery packet is transmitted, because an address of the router needs to be conjectured to transmit the packet, processing efficiency is lower than that of the method according to the first embodiment.

For the fifth embodiment, an explanation will be given of a home router setting method having improved processing efficiency that is applicable to a home network comprising a router that filters ICMP Time Exceeded packets. In order to realize the above, this fifth embodiment employs both the method explained in the first embodiment of using router discovery packets in which the TTL has been changed, and the method explained in the third embodiment of acquiring the WAN address of a router, and based on the address, finding a higher level router.

Overall Constitution

An explanation will be given of the constitution of a home network according to the fifth embodiment of the present invention with reference again to FIG. 28.

In FIG. 28, an Internet 4001 and home network 4002 are connected to each other. The Internet 4001 comprises a router 410D. The home network 4002 comprises multiple routers including routers 420C, 430B, and 440A. The router 420C is disposed at the border with the Internet, and the routers 430B and 440A are disposed in such order. The router 440A has connected thereto a communication device 450 constituted by a user-operable PC or the like. The communication device 450 comprises a communication interface 4501.

The router 420C comprises a LAN side communication interface 4202 and WAN side communication interface 4201, and a local area address is allocated to the LAN side communication interface, and a global address is allocated to the WAN side communication interface. The router 430B comprises a LAN side communication interface 4302 and WAN side communication interface 4301, and the router 440A comprises a LAN side communication interface 4402 and WAN side communication interface 4401. Here, when the router 420C uses the global address to connect to the router 410D on the Internet 4001 that is to make communications, connection between the home network 4002 and Internet 4001 is established.

Communication Device Configuration

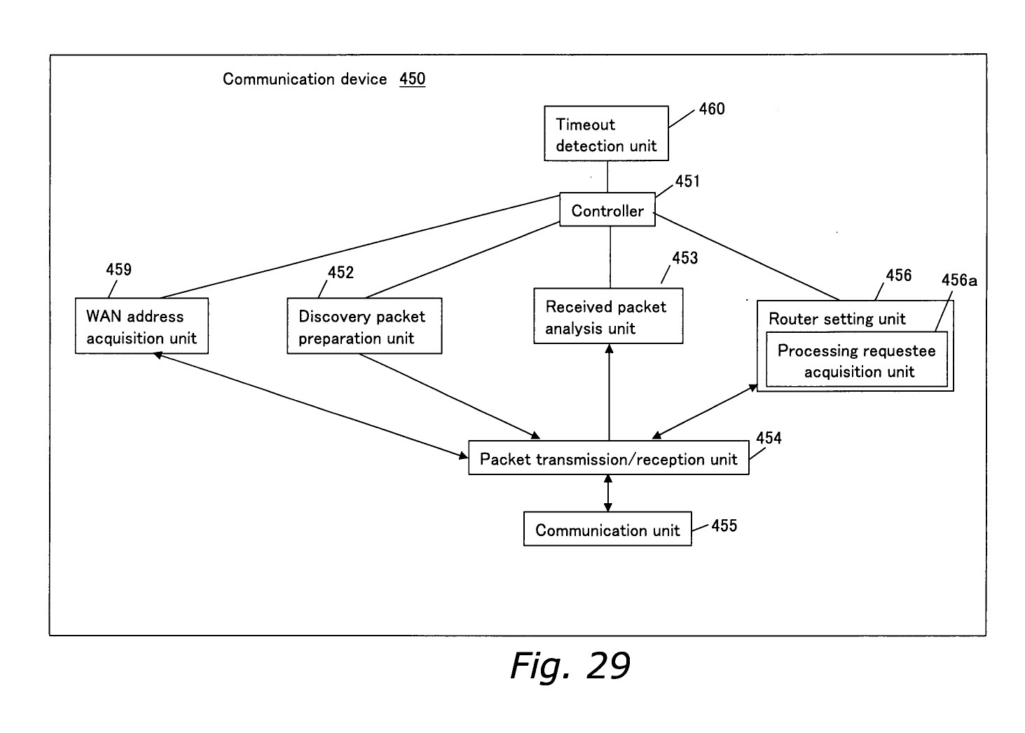

FIG. 29 shows the configuration of the communication device 450 according to the fifth embodiment. This communication device 450 comprises a controller 451, discovery packet preparation unit 452, received packet analysis unit 453, packet transmission/reception unit 454, communication unit 455, router setting unit 456, WAN address acquisition unit 459, and timeout detector 460. The controller 451 gives instructions for processing to the functional units. The discovery packet preparation unit 452 prepares packets for discovering routers (“router discovery packet”), and gives instructions for transmission. The received packet analysis unit 453 analyzes packets transmitted from the routers in response to the router discovery packets, and acquires the address of each router to learn the router configuration. The packet transmission/reception unit 454 gives instructions for packet transmission processing to the communication unit 455, analyzes the packets received by the communication unit 455, and delivers the same to a functional unit corresponding to the received packet. The communication unit 455 has a communication interface function to enable packet transmission/reception to and from the network. The router setting unit 456 executes router settings in the home network. Further, the router setting unit 456 comprises a processing requestee acquisition unit 456a for accessing the routers based on the acquired addresses to acquire a requestee for making router NAT settings and the like. The WAN address acquisition unit 459 acquires the WAN address of a router using the UPnP IGD specification. The timeout detector 460 detects timeout with respect to receipt of a response packet in response to a router discovery packet in which the TTL value has been changed.

Router Setting Operations

An explanation will be given of operations of the communication device 450 connected to the home network 4002 thus configured for executing router settings.

(1) Router Discovery Packet Transmission Processing

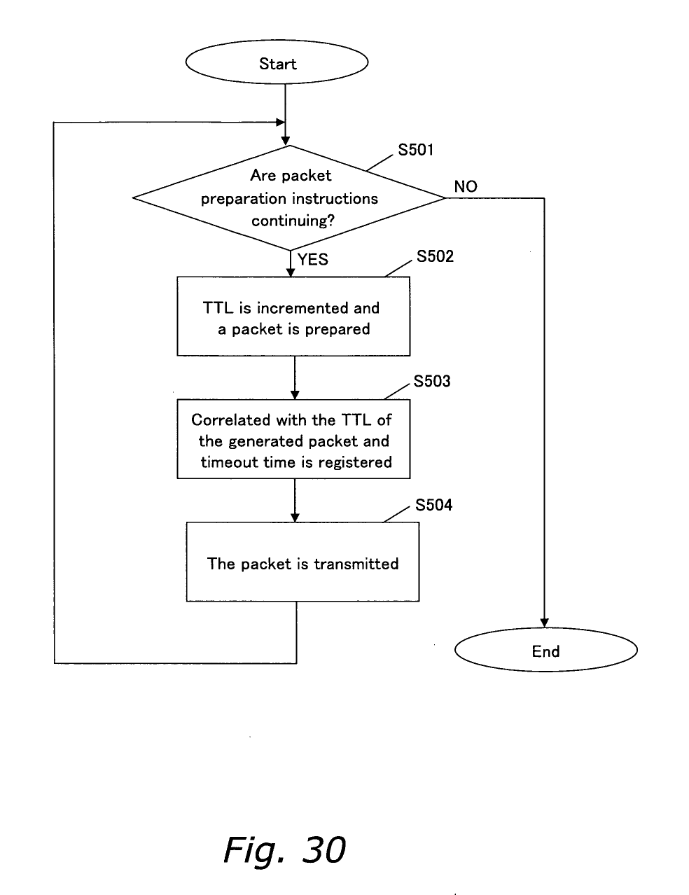

First, a standard router discovery packet transmission processing will be explained. FIG. 30 shows the processing sequence for transmitting a router discovery packet executed by the router discovery packet preparation unit 452.

When the controller 451 of the communication device 450 is to execute router settings, first, instruction is given to start processing for transmitting a router discovery packet in which the TTL has been changed.

In step S501, the discovery packet preparation unit 452 of the communication device 450 determines whether packet preparation instructions from the controller 451 are continuing.

When determination is made that the controller 451 has not given instructions for packet preparation, the discovery packet preparation unit 452 ends this sequence. Here, after instructions for packet preparation, the controller 451 gives instructions for stop when the specific conditions explained below in the processing of reception of packets from routers are satisfied.

In step S502, when determination is made that packet preparation instructions are continuing, the discovery packet preparation unit 452 prepares a router discovery packet in which the TTL has been incremented in order, starting from 1.

In step S503, when the router discovery packet is transmitted, the timeout detector 460 registers the timeout time for receiving a response packet in response to the router discovery packet. For example, the timeout detector 460 registers the timeout time in correlation with the TTL of the router discovery packet. The timeout detector 460 counts the timeout time starting from time of router discovery packet transmission, and notifies the controller 451 in case of timeout. The timeout detector 460 thus manages the timeout time, thereby determining whether a response packet has been received.

In step S504, the discovery packet preparation unit 452 prepares a router discovery packet, and thereafter instructs the packet transmission/reception unit 454 to transmit the packet. The packet transmission/reception unit 454 transmits the router discovery packet via the communication unit 455.

Here, the discovery packet preparation unit 452 can be constituted so that it transmits another router discovery packet without waiting for a response packet from a router with respect to the transmitted router discovery packet. With such a constitution, a plurality of router discovery packets are simultaneously transmitted, enabling high speed router discovery. For example, when a response packet contains information corresponding to TTL in a router discovery packet, the communication device can learn which router the response packet is from based on the information. Thus the communication device transmits router discovery packets in which the TTL has been changed one after another, allowing high speed acquisition of home network router address and configuration. Further, router settings for each router in the case of using the UPnP IGD specification must be able handle dynamic settings as when making settings at a stage when a specific application starts in the communication device. As described above, the communication device acquires home network router address and configuration at a high speed, thereby enabling dynamic router settings for each router.

The router discovery packet can be constituted so as to be transmitted to a specific global address on the Internet.

(2) Processing when Timeout is Detected

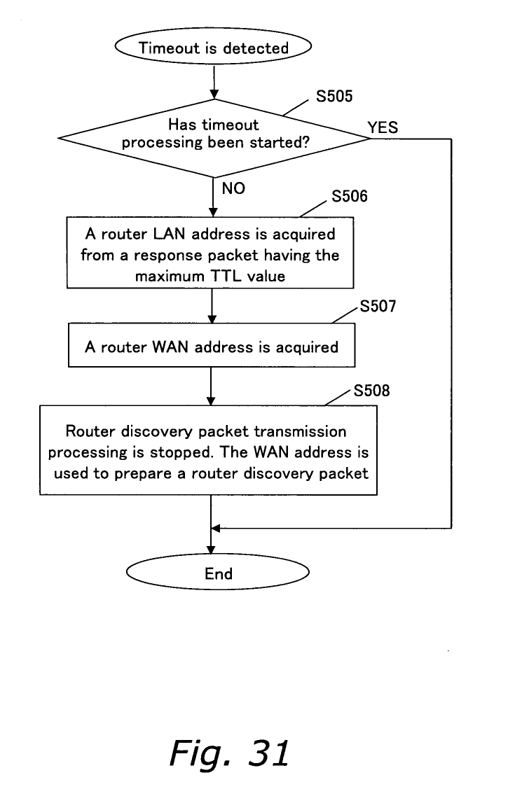

Next, with reference to FIG. 31, an explanation will be given of processing when the timeout detector 460 has detected timeout for receipt of a response packet in response to a router discovery packet.

In step S505, the timeout detector 460 of the communication device 450, upon detecting timeout, notifies the controller 451 to such effect. The controller 451, having received the timeout notice, determines whether the router discovery packet transmission processing at time of timeout process has already been started. When determination is made that the router discovery packet transmission processing at time of timeout processing has been started, the controller 451 of the communication device 450 ends this processing.

Next, when determination is made that the router discovery packet transmission processing at time of timeout processing has not been started, the communication device 450 executes the following steps (S506-S508).

In step S506, the received packet analysis unit 453 of the communication device 450 receives a response packet via the communication unit 455 and packet transmission/reception unit 454. The received packet analysis unit 453 extracts, from among the response packets currently received, a router LAN address acquired by using the response packet having the maximum TTL value.

Here, because router discovery packets in which the TTL has been changed are transmitted while the TTL is incremented in order, starting from 1, timeout arises in the order from a packet having a smaller TTL value. For example, in the example of FIG. 28, the router 430B is a router that filters ICMP messages. Therefore, any response packet from the routers 420C and 410D, which are higher level routers to the router 430B, with respect to the router discovery packets in which the TTL has been set at 3 and 4 respectively is timed out. Here, a response to the router discovery packet in which TTL=3 is timed out first. Therefore, a detected router corresponding to a TTL value that is 1 smaller than the TTL value of the response packet that is timed out first can be considered a router that filters ICMP messages. In this case, it can be understood that the router 30B detected to correspond to TTL=2, which is 1 smaller than the TTL of 3 of the response packet that was initially timed out, is filtering.

However, if acquisition of the TTL value of the timed out packet is difficult, the router detected using the packet having the maximum TTL value from among the response packets received at that time can be considered a router that filters ICMP messages.

With such a constitution, the received packet analysis unit 453 acquires the LAN address of the router 430B based on the response packet from the router 430B performing filtering.

In step S507, the controller 451 transmits the router LAN address acquired by the received packet analysis unit 453 to the WAN address acquisition unit 459, and gives instructions for acquiring the router WAN address. The WAN address acquisition unit 459 uses the UPnP IGD specification or the like as in the third embodiment to acquire information of the requestee for the UPnP action. The UPnP action is transmitted to the action requestee for the router, a response packet is received and the WAN address of the router is acquired. The WAN address acquisition unit 459 delivers the acquired WAN address to the controller 451.

In step S508, the controller 451 gives instructions to the discovery packet preparation unit 452 for stopping the processing for transmitting router discovery packets in which the TTL has been changed (processing of FIG. 30). Further, to the discovery packet preparation unit 452, the controller 451 delivers the acquired WAN address, and gives instructions for starting the processing for conjecturing an address of the higher level router based on the WAN address and transmitting a router discovery packet thereto (processing identical to that of FIG. 21 according to the third embodiment).

The processing when the timeout detector 460 detects timeout for receiving a router discovery packet response is described as above.

(3) Processing for Transmitting a Router Discovery Packet in which an Address of a Higher Level Router is Conjectured

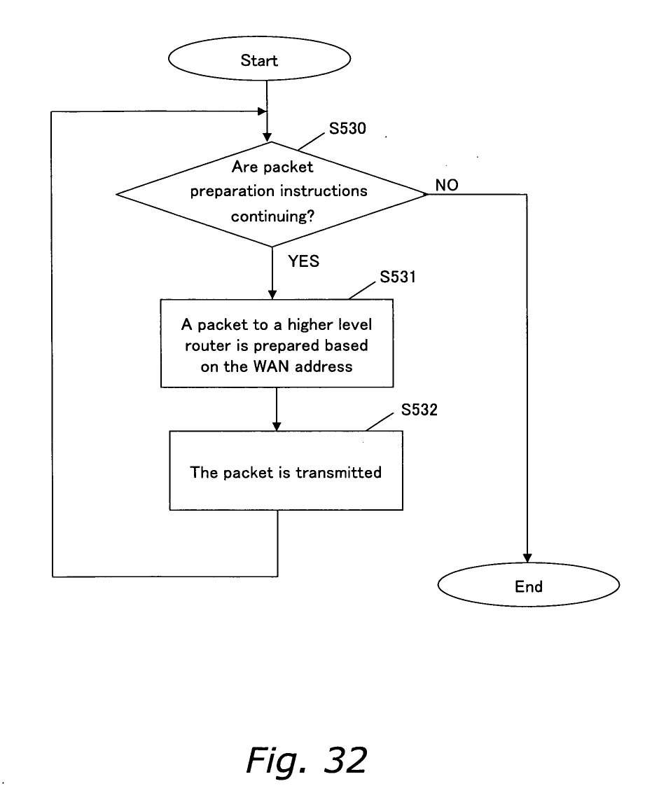

Next, with reference to FIG. 32, an explanation will be given of processing, executed by the discovery packet preparation unit 452, for transmitting a router discovery packet in which an address of a higher level router is conjectured.

In step S530, when the controller 451 has given instructions for router discovery packet preparation to acquire the WAN address, the discovery packet preparation unit 452 continues preparing router discovery packets.

In step S531, the discovery packet preparation unit 452 of the communication device 450 conjectures the LAN address of a higher level router based on the WAN address received from the controller 451. A router discovery packet is then generated based on the LAN address.

For example, when a router is used in the state in which it was shipped from a plant, a class C local address is used as the router LAN address, and the lowest 8 bits thereof are 1 or 254. For this reason, when an address of a higher level router is conjectured, the discovery packet preparation unit 452 preferentially uses an address in which the lowest 8 bits of the WAN address of the router acquired from the controller 451 have been substituted with 1 or 254 to conjecture the LAN address. With this processing, the communication device 450 is capable of detecting a higher level router at a higher speed than randomly conjecturing an address.

In step S532, the discovery packet preparation unit 452 transmits the generated router discovery packet via the packet transmission/reception unit 454 and communication unit 455.

(4) Response Packet Reception Processing

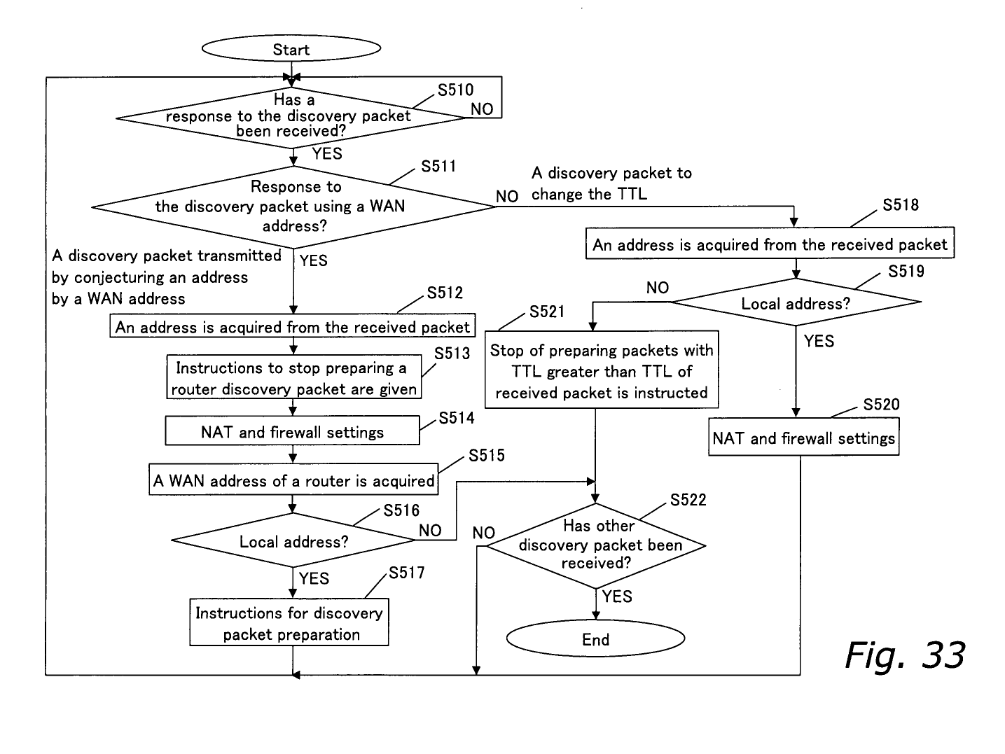

Next, with reference to FIG. 33, an explanation will be given of processing for receipt of a response packet in response to a router discovery packet.

In step 510, the controller 451 instructs the discovery packet preparation unit 452 to transmit a router discovery packet, and thereafter instructs the received packet analysis unit 453 to receive a response packet in response thereto. The received packet analysis unit 453 of the communication device 450 waits for receipt of the response packet.

In step S511, when the response packet has been received, the controller 451 determines whether the response packet is a response to a router discovery packet in which the TTL has been changed, or a response packet to a router discovery packet in which the address of a higher level router was conjectured based on a WAN address.

(4-1) Processing for Receipt of a Response Packet in Response to a Router Discovery Packet

When determination is made that the received response packet is a response packet in response to a router discovery packet in which the TTL has been changed, the communication device 450 executes the following steps (S518-521).

Steps S518-S521 in FIG. 33 are the same as the reception steps (S104-S107) of FIG. 4 according to the first embodiment. In other words, in step S518, upon receipt by the communication unit 455 of the ICMP Time Exceeded packet that is a response to the router discovery packet, the received packet is delivered by the packet transmission/reception unit 454 to the received packet analysis unit 453.

The received packet analysis unit 453 extracts a port number of the destination contained in the data unit of the ICMP Time Exceeded packet, and identifies the TTL designated at time of transmission of the router discovery packet based on such information. At the same time, the received packet analysis unit 453 extracts the source address to acquire the LAN address of the router.

In step S519, the controller 451 of the communication device 450 determines whether the LAN address of the acquired router is a global address or a local address.

In step S520, when determination is made that the LAN address of the acquired router is a local address, the communication device 450 instructs the router setting unit 456 to perform router settings via the controller 451. The router setting unit 456, having received the instructions, executes NAT and firewall settings.

In step S521, when determination is made that the LAN address of the acquired router is a global address, the communication device 450 instructs the discovery packet preparation unit 452 to stop preparing discovery packets via the controller 451 and ends this processing. Such control enables NAT and firewall settings to be made only with respect to the routers in the home network.

Described above is the processing when the received response is a response to a router discovery packet in which the TTL has been changed.

(4-2) Processing for Receipt of a Response Packet in Response to a Router Discovery Packet Transmitted after Conjecturing an Address of a Higher Level Router Address

Next, an explanation will be given of the processes (S512-S517) in the case of receiving a response to a router discovery packet transmitted after conjecture of an address of a higher level router based on the WAN address. The steps of S512-S517 are the same as steps S303-308 of FIG. 20 according to the third embodiment.

In step S512, the received packet analysis unit 453 of the communication device 450, upon receiving the response packet, analyzes the received packet and acquires the address of the router. When UPnP is used, information contained in the response is used to acquire a device description and service description, and information for action transmission is also acquired.

In step S513, when determination is made that the currently received response packet is a response to a router discovery packet prepared and transmitted by the discovery packet preparation unit 452, the controller 451 of the communication device 450 instructs the discovery packet preparation unit 452 to stop the processing for transmitting router discovery packets.

In step S514, the router setting unit 456 of the communication device 450 uses the LAN address of the acquired router to access the router. The router setting unit 456 executes NAT and/or firewall settings as in the first embodiment.

In step S515, the controller 451 transmits the LAN address acquired by the received packet analysis unit 453 to the WAN address acquisition unit 459, and gives instruction for acquisition of the WAN address of the detected router. The WAN address acquisition unit 459 uses, for example, the UPnP IGD specification to acquire the WAN address based on the LAN address of the router.

In step S516, the controller 451 of the communication device 450 determines whether the WAN address of the acquired router is a global address or local address. When determination is made that the WAN address of the acquired router is a global address, the controller 451 of the communication device 450 assumes that the higher level router of this router is a router on the Internet, and ends this processing. In other words, because assumption can be made that router settings have been completed for all the routers in the home network, the processing is ended.

In step S517, when determination is made that the WAN address of the router is a local address, the controller 451 of the communication device 450 assumes that there is a router in the home network higher than the detected router. Thus, the controller 451 delivers the WAN address of the detected router to the discovery packet preparation unit 452, and gives instructions for router discovery packet preparation.

Control returns to step S510, and the controller 451 of the communication device 450 waits for receipt of a response packet in response to the router discovery packet.

### Processing Example

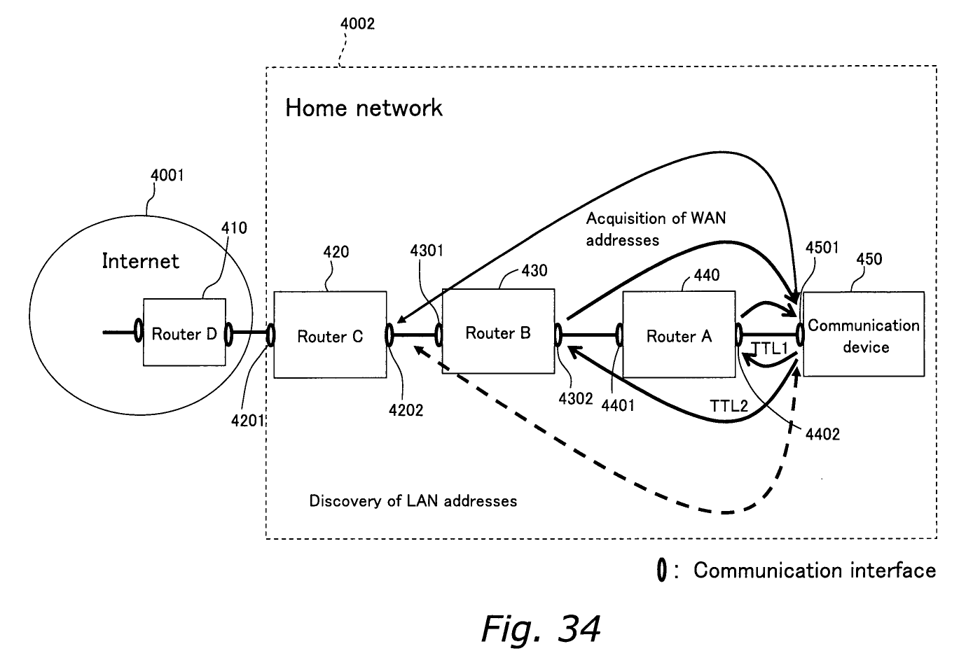

FIG. 34 is one example of an operation for performing home network settings by the method described in the fifth embodiment.

The discovery packet preparation unit 452 of the communication device 450 transmits router discovery packets in which the TTL is set in order, starting from 1. The received packet analysis unit 453 of the communication device 450 receives ICMP Time Exceeded packets from the routers 440A and 430B as responses to the transmitted router discovery packets. The received packet analysis unit 453 acquires the LAN address of the router 440A from the response packet to the router discovery packet in which TTL=1, and acquires the LAN address of the router 430B from the response packet to the router discovery packet in which TTL=2. The router setting unit 456 accesses the routers 440A and 430B based on the acquired LAN addresses to execute NAT and firewall settings.

However, because ICMP messages are filtered by the router 430B, the communication unit 455 of the communication device 450 is prevented from receiving a response packet from the routers 420C and 410D positioned higher than the router 430B. For this reason, the timeout detector 460 detects timeout of the router discovery packet in which TTL=3 (router discovery packet for detecting the router 420C). Following this, the discovery packet preparation unit 452 of the communication device 450 stops processing for transmitting router discovery packets in which the TTL has been changed. The discovery packet preparation unit 452 conjectures an address of a higher level router based on the router WAN address to start processing for transmitting a router discovery packet. At this time, the discovery packet preparation unit 452 can start the processing based on the router WAN address acquired when TTL=2 (corresponding to the router 430B).

Next, the received packet analysis unit 453 of the communication device 450 acquires the LAN address of the router 420C from the response packet corresponding to the transmitted router discovery packet. The router setting unit 456 accesses the router 420C based on the acquired LAN address to execute NAT and firewall settings. The WAN address acquisition unit 459 of the communication device 450 acquires the WAN address of the router 420C. The processing is completed when the acquired WAN address is detected to be a global address.

Effects

The communication device according to the fifth embodiment, when it has received a response packet, transmits router discovery packets in which the TTL is varied. With such a constitution, the communication device acquires router addresses based on response packets from routers, enabling high speed router settings. Further, when a response packet cannot be received, the communication device acquires a WAN address based on the LAN address acquired from the response packet received in the manner described above. The communication device repeats the process of acquiring the LAN address of routers more toward the WAN side based on the acquired WAN address. As a result, the router configuration can be learned even in a home network comprising a router that filters response packets, enabling router settings to be made.

In the fifth embodiment, NAT and firewall settings of the router were described. Application of the present method to the second and fourth embodiments enables, even in an environment where a home network comprises a router that filters ICMP messages, settings for the wireless AP 60 and/or the wireless communication unit 58 of the communication device 450 to be executed accurately and at a high speed.

### SIXTH EMBODIMENT

### Router Detection Using ICMP and UPnP

Described in the fifth embodiment was an efficient router setting method applicable also to a case where a home network comprises a router that filters ICMP messages. On the other hand, in the sixth embodiment, an explanation will be given of an efficient router setting method applicable also to a case where a home network comprises a router that does not process TTL.

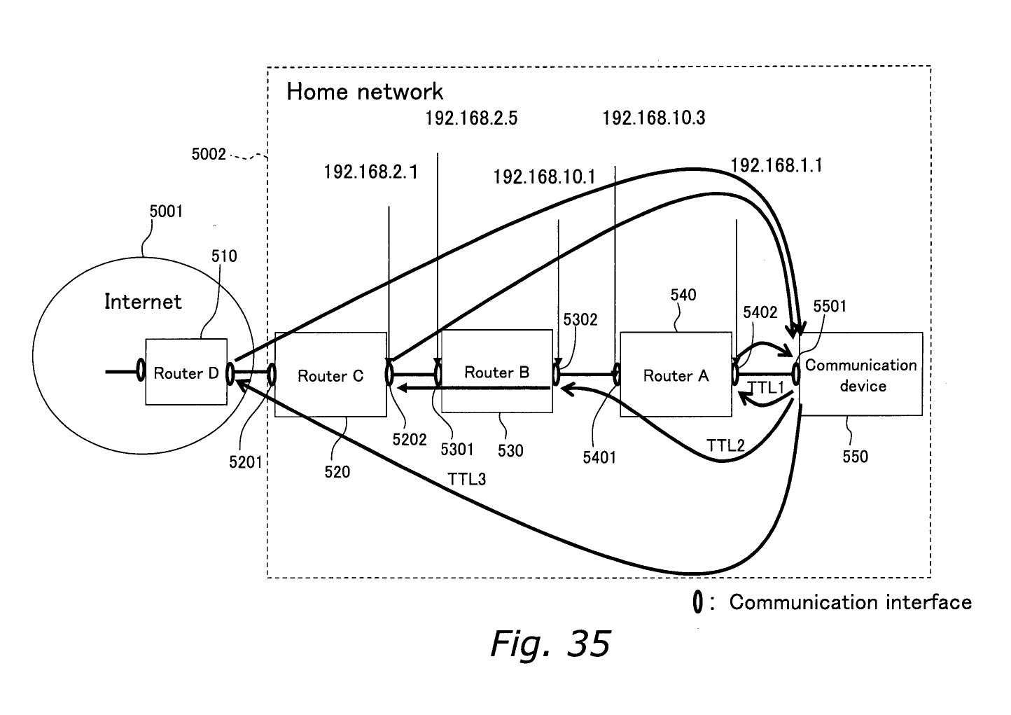

A sixth embodiment of the present invention will be explained with reference to the drawings. FIG. 35 is an example of the constitution of the home network according to the sixth embodiment of the present invention. In the following, let us assume that the router 530B of FIG. 35 does not process TTL.

In FIG. 35, as described in the first embodiment, router discovery packets in which the TTL has been changed are transmitted from the communication device 550 in order, starting from 1. At this time, the router discovery packet in which TTL=2 would, at the router 530B, become TTL=0, and an ICMP Time Exceeded packet would be transmitted from the router 530B. However, because the router 530B does not process TTL, the router discovery packet in which TTL=2 is decremented by the router 540A and transmitted to the router 520C in a state where TTL=1. Because in this router discovery packet TTL becomes 0 at the router 520C, a response to the router discovery packet in which TTL=2 is transmitted from the router 520C as an ICMP Time Exceeded packet.

As a result, when the router settings according to the first embodiment are applied to such a home network, the communication device 550 is unable to recognize the existence of the router 530B between the router 540A and router 520C, causing router settings to terminate.

In the third embodiment, an explanation was given of a method for acquiring the WAN address of a router, and based on the address, discovering a higher level router and performing router settings. Because router discovery packets in which the TTL has been changed are not used, this method can be applied to a home network comprising a router that does not process TTL. However, because at time of router discovery packet transmission, there is a need to conjecture router address to transmit the packet, processing efficiency is lower than that of the method according to the first embodiment.

For the sixth embodiment, an explanation will be given of a home router setting method applicable also to a home network comprising a router that does not process TTL, and having improved processing efficiency.

In order to realize the foregoing, the sixth embodiment employs both the method explained in the first embodiment of using router discovery packets in which the TTL has been changed, and the method explained in the third embodiment wherein a router WAN address is acquired, and based on the address, a higher level router is found.

Overall Constitution

The constitution of the home network according to the sixth embodiment of the present invention will be explained with reference again to FIG. 35.

In FIG. 35, the Internet 5001 and home network 5002 are connected to each other. The Internet 5001 comprises a router 510D. The home network 5002 comprises multiple routers including routers 520C, 530B, and 540A. The router 520C is disposed at the border with the Internet, and the routers 530B and 540A are disposed in such order. The router 540A has connected thereto a communication device 550 constituted by a user-operable PC or the like. The communication device 550 comprises a communication interface 5501.

The router 520C comprises a LAN side communication interface 5202 and WAN side communication interface 5201, and a local area address is allocated to the LAN side communication interface, and a global address is allocated to the WAN side communication interface. The router 530B comprises a LAN side communication interface 5302 and WAN side communication interface 5301, and the router 540A comprises a LAN side communication interface 5402 and WAN side communication interface 5401. Here, when the router 520C uses a global address to connect with the router 510D on the Internet 5001 that is to make communication, connection between the home network 5002 and Internet 5001 is established.

Communication Device Configuration

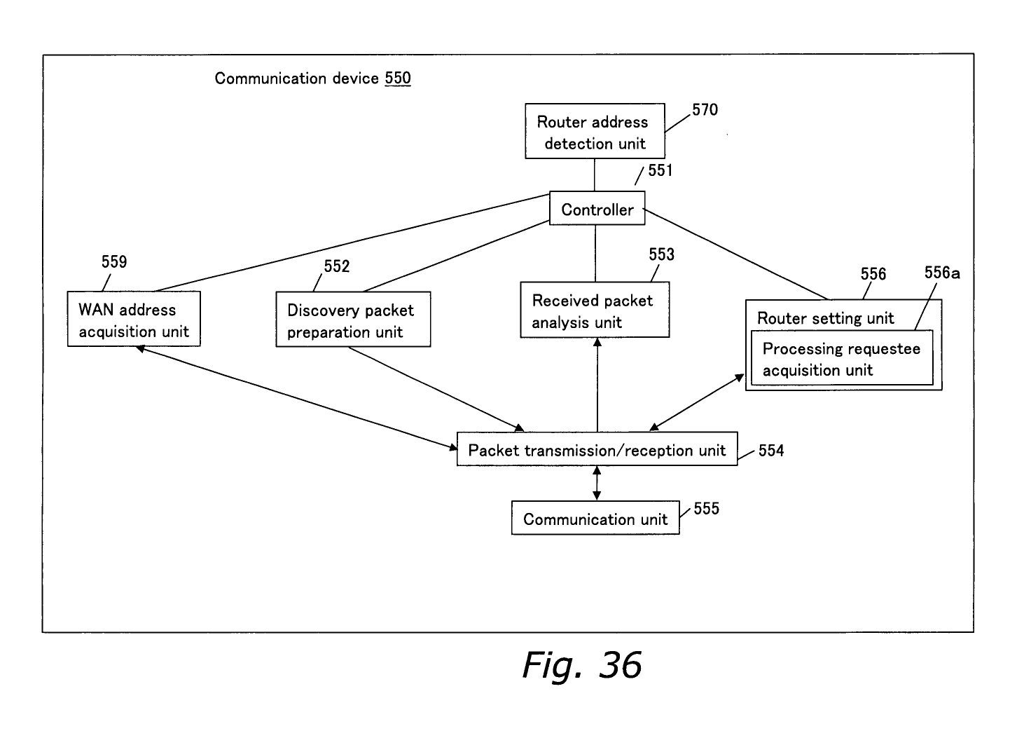

FIG. 36 shows the configuration of the communication device 550 according to the sixth embodiment. This communication device 550 comprises a controller 551, discovery packet preparation unit 552, received packet analysis unit 553, packet transmission/reception unit 554, communication unit 555, router setting unit 556, WAN address acquisition unit 559, and router address verification unit 570. The controller 551 gives instructions for processing to the functional units. The discovery packet preparation unit 552 prepares packets for discovering routers (“router discovery packet”), and gives instructions for transmission. The received packet analysis unit 553 analyzes packets transmitted from the routers in response to the router discovery packets, and acquires the address of each router to learn the router configuration. The packet transmission/reception unit 554 gives instructions for packet transmission processing to the communication unit 555, analyzes the packets received by the communication unit 555, and delivers the same to a functional unit corresponding to the received packet. The communication unit 555 has a communication interface function to enable packet transmission/reception to and from the network. The router setting unit 556 executes router settings in the home network. Further, the router setting unit 556 comprises a processing requestee acquisition unit 556a for accessing the routers based on the acquired addresses to acquire a requestee for making router NAT settings and the like. The WAN address acquisition unit 559 acquires the WAN address of a router using the UPnP IGD specification. The router address verification unit 570 verifies whether the router address acquired from the response packet of the router discovery packet in which the TTL has been changed is right—that is, it verifies whether routers for which the address has not been acquired exist.

Router Setting Operations

An explanation will be given as described below to operations of the communication device 550 for executing router settings connected to the home network 5002 thus set.

(1) Transmission Processing

(1-1) Router Discovery Packet Transmission Processing

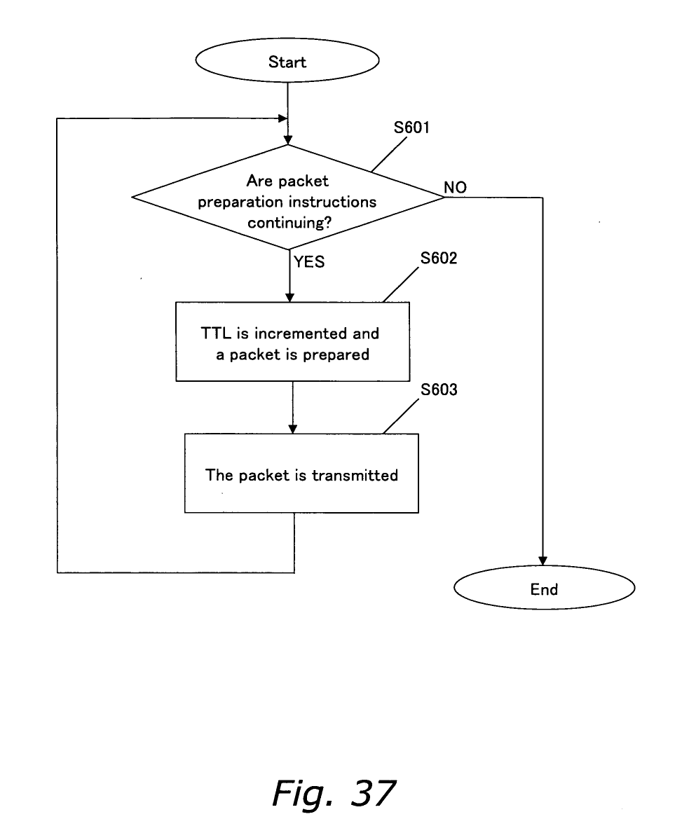

First, an explanation will be given of processing for transmitting a standard router discovery packet. FIG. 37 shows the processing sequence executed by the discovery packet preparation unit 552 for transmitting a router discovery packet prepared by changing the TTL value. This sequence is identical to that of FIG. 5 according to the first embodiment.

When the controller 551 gives instructions for discovery packet preparation, the communication device 550 starts this processing sequence for transmitting a router discovery packet.

In step S601, the discover packet preparation unit 552 of the communication device 550 determines whether the packet preparation instructions from the controller 551 are continuing.

When determination is made that the controller 551 has not given instructions for packet preparation, the discovery packet preparation unit 552 ends this sequence. Here, after instructions for packet preparation, the controller 551 gives instructions for stop when the specific conditions explained below in the processing of reception of packets from routers are satisfied.

In step S602, when determination is made that instructions have been given for packet preparation, the discovery packet preparation unit 552 prepares router discovery packets in which the TTL is incremented in order, starting from 1.

In step S603, the discovery packet preparation unit 552, upon preparing a router discovery packet, instructs the packet transmission/reception unit 554 to transmit the packet. The packet transmission/reception unit 554 transmits the router discovery packet via the communication unit 555.

Here, the discovery packet preparation unit 552 can be constituted so that it transmits another discovery packet without waiting for a response packet from a router with respect to the transmitted router discovery packet. With such a constitution, a plurality of router discovery packets are simultaneously transmitted, allowing high speed router discovery. For example, when the response packet contains information corresponding to the TTL in the router discovery packet, the communication device can learn which router the response packet is from based on the information. For this reason, the communication device transmits router discovery packets in which the TTL has been changed one after another, allowing high speed acquisition of router address and configuration in the home network. Further, router settings for each router in the case of using the UPnP IGD specification need to be able to handle dynamic settings as when performing router settings at a stage when a specific application starts in the communication device. As described above, the communication device acquires home network router address and configuration at a high speed, allowing dynamic router settings for each router.

The router discovery packet can be constituted so as to be transmitted to a specific global address on the Internet.

(1-2) Processing for Transmitting a Router Discovery Packet by Conjecturing the Address of a Higher Level Router

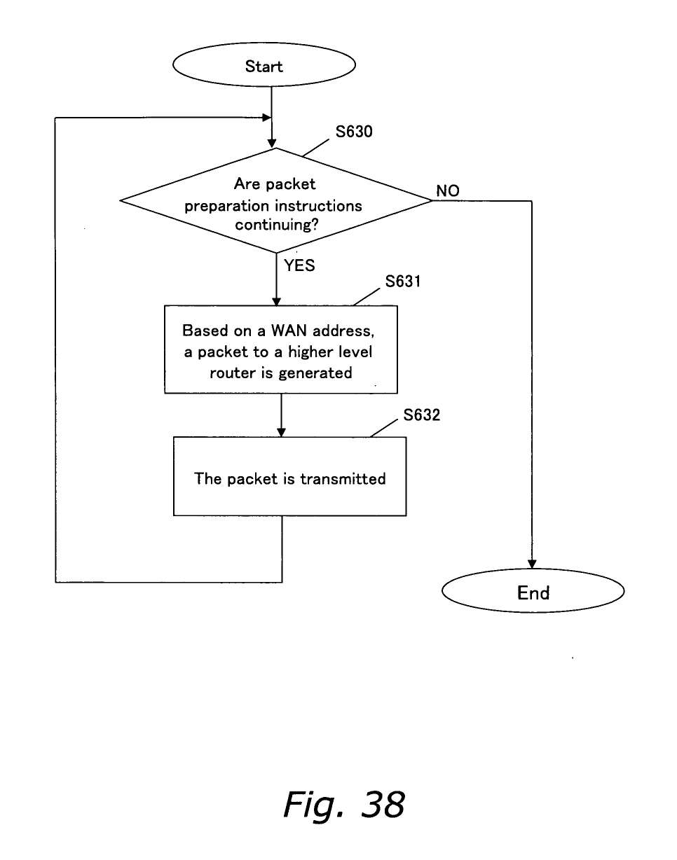

Next, with reference to FIG. 38, an explanation will be given of processing for transmitting a router discovery packet by conjecturing an address of a higher level router, as executed by the discovery packet preparation unit 552.

In step S630, when the controller 551 has given instructions for router discovery packet preparation and a WAN address has been acquired, the discovery packet preparation unit 552 continues preparing router discovery packets.

In step S631, the discovery packet preparation unit 552 of the communication device 550 conjectures the LAN address of a higher level router based on the WAN address received from the controller 551. A router discovery packet is prepared based on the LAN address.

For example, when a router is used in the state in which it was shipped from a plant, a class C local address is used as the LAN address, and the lowest 8 bits thereof are 1 or 254. For this reason, when an address of a higher level router is conjectured, the discovery packet preparation unit 552 preferentially uses an address in which the lowest 8 bits of the router WAN address acquired from the controller 551 are changed to 1 or 254.

In step S632, the discovery packet preparation unit 552 transmits the generated router discovery packet via the packet transmission/reception unit 554 and communication unit 555.

(2) Processing for Receipt of a Response Packet

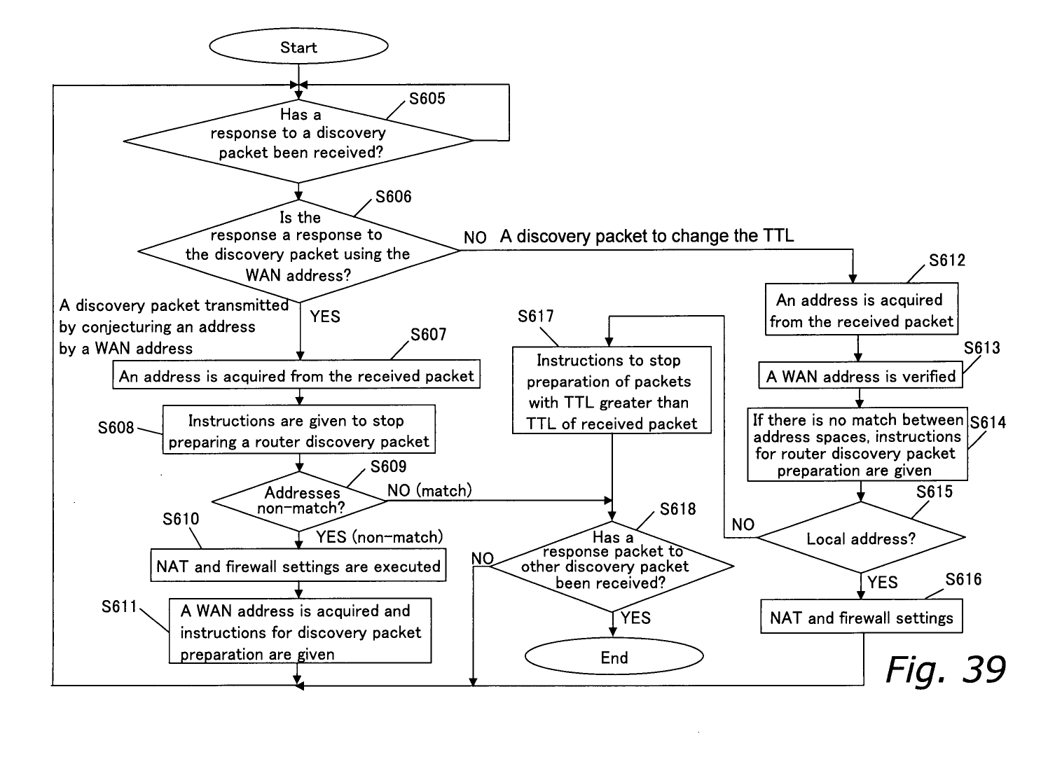

Next, an explanation will be given of processing for receipt of a response to the router discovery packet with reference to FIG. 39.

In step S605, after the controller 551 instructs the discovery packet preparation unit 552 to transmit the router discovery packet, it instructs the received packet analysis unit 553 to receive the response packet. The received packet analysis unit 553 of the communication device 550 waits for receipt of the response packet.

In step S606, when the response packet is received, the controller 551 determines whether the response packet is a response to a router discovery packet in which the TTL has been changed, or a response to a router discovery packet transmitted by conjecturing an address of a higher level router based on the WAN address.

(2-1) Processing for Receipt of a Response Packet in Response to a Router Discovery Packet in which the TTL has Been Changed

When determination is made that the received response packet is a response to a router discovery packet in which the TTL has been changed, the communication device 550 executes the following steps (S612-S617).

In step S612, the controller 555 receives an ICMP Time Exceeded packet serving as a response packet corresponding to the router discovery packet. The received packet analysis unit 553 receives an ICMP Time Exceeded packet via the communication unit 555 and packet transmission/reception unit 554.

The received packet analysis unit 553 extracts the destination port number contained in the data portion of the ICMP Time Exceeded packet, and identifies the TTL value set at time of router discovery packet transmission based on the information. Here, an explanation will be given on the assumption that the identified TTL value is N. At the same time, the received packet analysis unit 553 extracts a source address to acquire the LAN address of the router.

In step S613, the controller 551 of the communication device 550 instructs the WAN address acquisition unit 559 to acquire the WAN address of the router detected by the router discovery packet in which TTL=1. Here, the controller 551 transmits the LAN address of the router acquired by the received packet analysis unit 553 to the WAN address acquisition unit 559. The WAN address acquisition unit 559 acquires a WAN address based on the LAN address.

Further, the controller 551 of the communication device 550 transmits the WAN address of the acquired router to the router address verification unit 570, and instructs the router address detection unit 570 to verify this WAN address.

The router address verification unit 570 checks whether the address space of the LAN address of the router acquired by the router discovery packet in which TTL=N and address space of the WAN address of the router detected by the router discovery packet in which TTL=N−1 match. In other words, the LAN address and WAN address of adjacent routers are compared to check whether the acquired WAN address is a right address. Here, when determination is made that the address space of the LAN address of the router acquired by the ICMP Time Exceeded packet to the router discovery packet in which TTL=N does not match the address space of the WAN address of the router detected by the router discovery packet in which TTL=N−1, the router address verification unit 570 recognizes the existence of another router between the router that responded to the ICMP Time Exceeded packet corresponding to TTL=N and the router that responded to the ICMP Time Exceeded packet corresponding to TTL=N−1.

In step S614, when non-match of the address spaces is detected by the router address verification unit 570, the controller 551 conjectures an address based on the router WAN address, and instructs the discovery packet preparation unit 552 to perform the processing for transmitting a second router discovery packet. At this time, the controller 551 transmits the router WAN address detected by the router discovery packet designated by the TTL of N−1 to the discovery packet preparation unit 552.

In a case where N=1, the router address detection unit 570 checks whether there is match between the address space of the obtained router address and the address space of the address of the communication device 550. In case of non-match, the controller 551 instructs the discovery packet preparation unit 552 to transmit the second router discovery packet based on the address of the communication device 550.

When determination is made that there is match between the address spaces of the LAN address of the router acquired by the router discovery packet in which TTL=N and the address space of the WAN address of the router detected by the router discovery packet in which TTL=N−1, the controller 551 of the communication device 550 executes the processing for the following step S615.

In step S615, the controller 551 of the communication device 550 determines whether the LAN address of the acquired router is a global address or local address.

In step S616, when determination is made that the LAN address acquired in step S615 is a local address, the controller 551 of the communication device 550 instructs the router setting unit 556 to set the router. The router setting unit 556, having received such instructions, accesses the acquired LAN address to execute NAT and firewall settings for the router.

In step S617, when determination is made that the LAN address of the acquired router is a global address, the controller 551 of the communication device 550 instructs the discovery packet preparation unit 552 to stop preparing router discovery packets in which the TTL has been changed.

In step S618, the controller 551 of the communication device 550 determines whether there is need to receive another response to a router discovery packet, such as a response to the second router discovery packet conjecturing and transmitting the address based on the router WAN address or a response to a router discovery packet having a TTL value smaller than the TTL currently received, and if there is no need ends the processing.

On the other hand, when determination is made that another response needs to be received, control returns to step S605 and the controller 551 of the communication device 550 waits for receipt of a response packet.

Such control enables NAT and firewall settings only with respect to routers in the home network.

The foregoing described a process when the received response is a response to a router discovery packet in which the TTL has been changed.

(2-2) Processing for Receipt of a Response Packet in Response to the Router Discovery Packet Transmitted Having Conjectured an Address of a Higher Level Router

Next, an explanation will be given of steps (S607-S611) in a case where the received packet is a response to a router discovery packet transmitted by conjecturing an address of the higher level router based on a WAN address.

In step S607, the received packet analysis unit 553 of the communication device 550, upon receiving a response packet, analyzes the received packet, and acquires a router LAN address. When UPnP is used, information described in the response is used to acquire a device description and service description, as well as information for action transmission.

In step S608, when determination is made that the currently received packet is a response packet in response to a router discovery packet prepared and transmitted by the discovery packet preparation unit 552, the controller 551 of the communication device 550 instructs the discovery packet preparation unit 552 to stop the processing for transmitting the second router discovery packet.

In step S609, the controller 551 of the communication device 550 instructs the router address verification unit 570 to compare the values of the acquired router LAN address and the router LAN address acquired by the router discovery packet in which TTL=N. When the router address verification unit 570 determines that the acquired router LAN address and the router LAN address acquired by the router discovery packet in which TTL=N match, the controller 551 executes processing determining end for step S618.

When the router address verification unit 570 determines that the acquired router address and the address of the router acquired by the router discovery packet in which TTL=N do not match, the router address verification unit 570 executes the following steps (S610, S611).

In step S610, because the acquired router address does not match the router address acquired by the router discovery packet in which TTL=N, the detected router is a router in which NAT settings or firewall settings have not been performed. Therefore, the controller 551 of the communication device 550 transmits the LAN address of the acquired router to the router setting unit 556. The router setting unit 556 accesses the router based on the LAN address, and executes NAT and/or firewall settings as in the first embodiment.

In step S611, because the acquired router address does not match the router address acquired by the router discovery packet in which TTL=N, there may be another router between the communication device and the router detected by the router discovery packet in which TTL=N. For this reason, the controller 551 of the communication device 550 transmits the acquired router LAN address to the WAN address acquisition unit 559. The WAN address acquisition unit 559 acquires a router WAN address based on the LAN address. The controller 551 transmits the WAN address to the discovery packet preparation unit 552. The discovery packet preparation unit 552 acquires the detected router WAN address, and performs processing for transmitting the second discovery packet, conjecturing the address of a higher level router based on the router WAN address to prepare such router discovery packet. Upon ending these processes, the controller 551 waits for receipt of a response packet in response to the router discovery packet.

The foregoing is the processing for receipt of a response to the router discovery packet.

Example of Processing

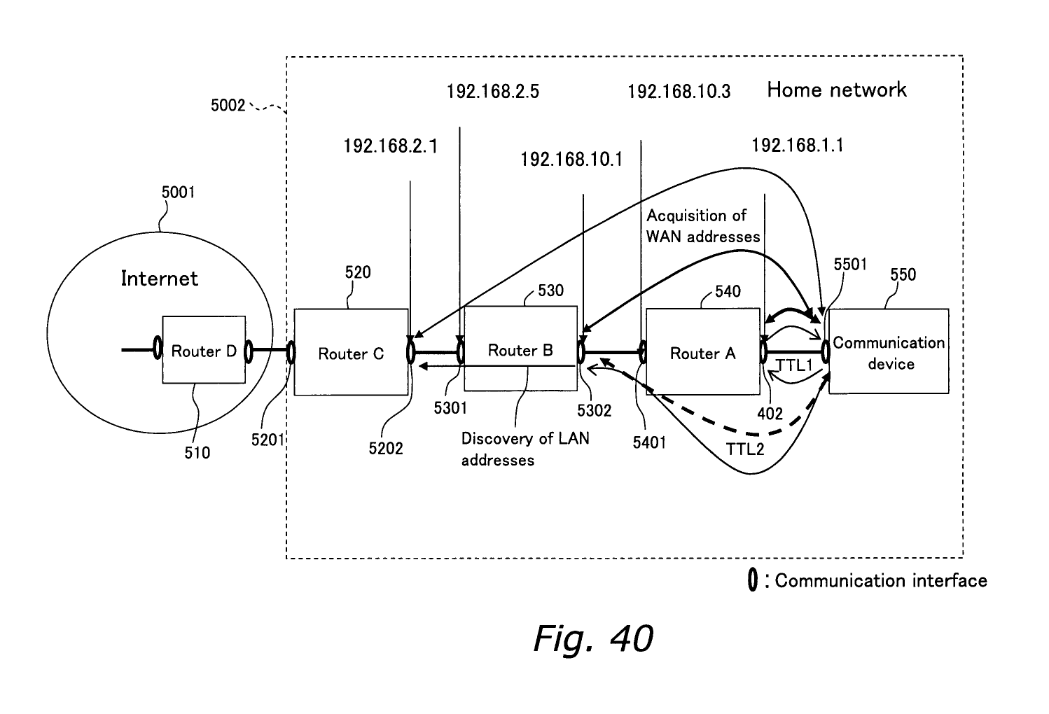

FIG. 40 shows operations in a case where a home network is set by the method described in the sixth embodiment. Here, let us assume that the router 530B does not process TTL.

The discovery packet preparation unit 552 of the communication device 550 transmits router discovery packets in which the TTL is set in order, starting from 1. The received packet analysis unit 553 acquires, as a response thereto, the LAN address of the router 540A corresponding to the router discovery packet in which TTL=1. Further, because the router 530B does not process TTL, the router discovery packet in which TTL=2 that has arrived at the router 530B is transmitted to the router 520C without TTL processing. Therefore, the received packet analysis unit 553 acquires an address of the router 520C corresponding to the router discovery packet in which TTL=2. The router setting unit 556 accesses the router 540A and router 520C based on the acquired LAN address, and respectively executes NAT and firewall settings.

Let us assume that the WAN address of the router 540A acquired in response to the router discovery packet in which TTL=1 is 192.168.10.3. The WAN address acquisition unit 559 acquires the WAN address of this router 540A based on the LAN address of the router 540A acquired from the response packet corresponding to the router discovery packet in which TTL=1. Meanwhile, let us assume that the LAN address of the router 520C acquired in response to the router discovery packet in which TTL=2 is 192.168.2.1. Therefore, the router address verification unit 570 detects non-match between network addresses.

Because of this non-match of network addresses, the communication device is capable of recognizing the existence of another router between the router 520C and router 540A. Therefore, the discovery packet preparation unit 552 of the communication device 550, based on the WAN address of the router 540A, 192.168.10.3, conjectures an address of the router 530B that is a higher level router and transmits a router discovery packet thereto. As a result, the received packet analysis unit 553 of the communication device 550 acquires the LAN address of the router 530B, 192.168.10.1 from the response packet in response to such router discovery packet. The router setting unit 556 executes NAT and firewall settings for the router 530B based on this LAN address.

Further, by acquiring the LAN address of the router 530B, the WAN address acquisition unit 559 is able to acquire the WAN address of the router 530B. The discovery packet preparation unit 552 prepares a router discovery packet based on the WAN address value and transmits the same, to acquire the LAN address of the router 520C that is a higher level router.

When the router address verification unit 570 determines that there is match between the values of the LAN address of the acquired router 520C and of the address of the router acquired in response to the router discovery packet in which TTL=2, the controller 551 determines that all unfound routers have been found.

Effects

The communication device according to the sixth embodiment determines match/non-match between the address spaces of a LAN address extracted from a router response packet and of a WAN address acquired based on the LAN address of the prior stage router. Determination is thereby made of whether the LAN address extracted from the router response packet is right. In case of match, the LAN address extracted from the router response packet can be confirmed as the right address for a communication device to access the router. Therefore, even when a home network comprises a router that forwards a packet to a subsequent router without decrementing the TTL, the communication device is capable of learning the router configuration in a home network and performing router settings.

In this sixth embodiment, NAT and firewall settings of a router were described. By applying this method according to the sixth embodiment to the second and fourth embodiments, even in an environment in which a home network comprises a router that does not process TTL, secure and high speed execution can be made of settings for the wireless AP 60 and/or the wireless communication unit 58 of the communication device 550.

Further, in the fifth and sixth embodiments, the method described in the first embodiment of transmitting a router discovery packet in which the TTL is set in order, starting from 1, is used, and when a problem in the processing for detecting address information of a router is detected, the method described in the second embodiment of conjecturing the LAN address of the router and transmitting the router discovery packet is used, to acquire the address information of the router. Such method is but one example; in an alternative constitution, the method described in the first embodiment wherein a router discovery packet in which the TTL has been changed is transmitted, with the TTL in order, starting from 1, and the method described in the second embodiment wherein a router LAN address is conjectured and a router discovery packet is transmitted are simultaneously executed from the start, and the results obtained by both methods are merged, thereby achieving effects identical to those of the fifth and sixth embodiments.

Further, in the first and sixth embodiment, to discover a router, acquire a WAN address and perform NAT and firewall settings, http and UPnP are used. This is but one example, and other protocols such as SLP, SNMP or the like may be employed.

### SEVENTH EMBODIMENT

### Application to P2P Communications

For the first through sixth embodiments, explanations were given of using router discovery packets in which the TTL has been changed and UPnP discovery packets to discover router and perform firewall and NAT settings. This seventh embodiment discloses performing firewall and NAT settings of routers in a home network using the same methods as in the first to sixth embodiments, and using a communication path set by executing such firewall and NAT settings to perform direct communications among terminals (“P2P communication”). In other words, the seventh embodiment is an application of router settings in a home network according to the first to sixth embodiments to P2P communications.

Generally, in a state where a P2P communication path has not been created, communication cannot be performed between user terminals. For this reason, even when another user terminal wishes to make P2P communications, it is unable to notify its communication counterparty. A P2P server comprises a function for resolving this, and each user terminal forms a communication path to the P2P server in advance. The P2P server relays a communication message between user terminals, allowing communication between user terminals before forming a P2P communication path.

An explanation will be given of a communication path established by a user terminal with the P2P server. With a router, generally, when communication is to be performed from the LAN side to WAN side, NAT and firewall settings are performed automatically. For this reason, when a response to the packet transmitted by the user terminal from a destination is received from the router WAN side, the same can be received by the user terminal connected on the LAN side without performing any specific settings. This automatic setting function for performing NAT and firewall settings of a router is called dynamic NAPT.

Thus, the communication path between the P2P server and a user terminal can be easily established once communication from a user terminal to the P2P server is started by dynamic NAPT of a router. Examples of methods include establishing a TCP session from a user terminal to a P2P server, transmitting a UDP packet from a user terminal to a P2P server at set time intervals and the like. Alternatively, when a user terminal establishes a communication path to a P2P server, at the same time it registers its own identification information on the P2P server, and the P2P server correlates the identification information with address information of the user terminal and manages the same. With such a constitution, when a user terminal designates identification information of a communication counterparty as a destination for a message, the P2P server relays the communication with the counterparty user terminal based on the identification information. In other words, the user terminal that is to perform P2P communications is capable of performing communications provided that it knows in advance identification information of its communication counterparty.

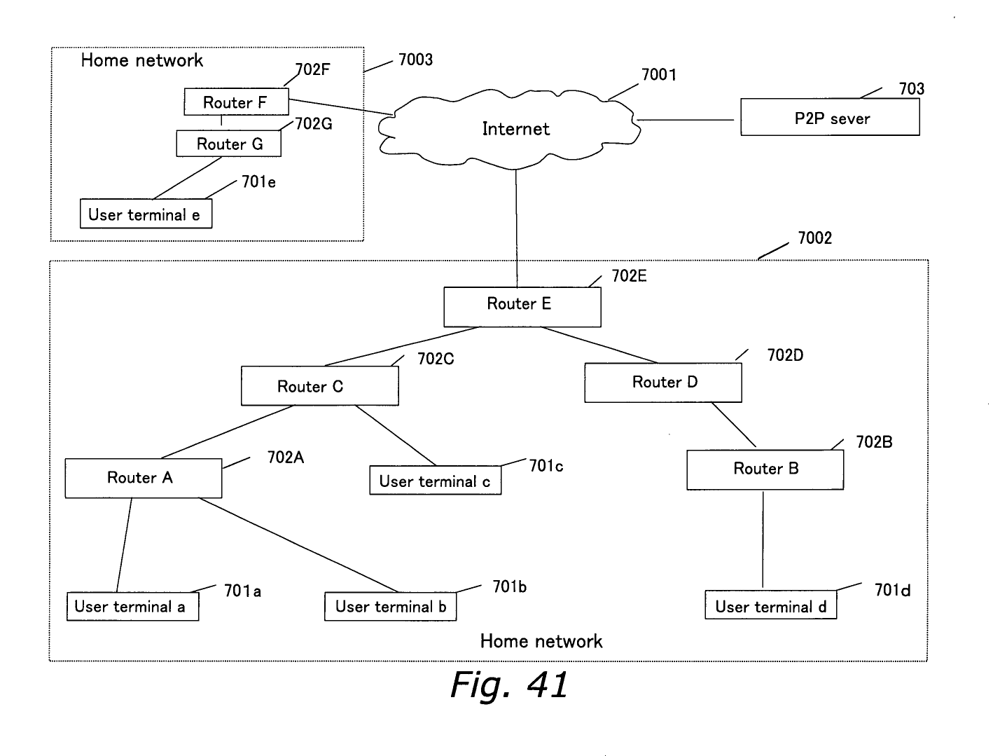

Communications from the LAN side to WAN side can be thus simply performed by dynamic NAPT as explained above. However, communication between user terminals such as user terminals (a) and (e) of FIG. 41 (described below) generally requires a communication path from the WAN side to LAN side in a router of a communication counterparty. For this reason, communication often cannot be performed just by dynamic NAPT of a router. With the present embodiment, a communication path from the WAN side to LAN side is set to enable P2P communication.

The seventh embodiment of the present invention will be explained with reference to the drawings. FIG. 41 shows a network configuration according to the seventh embodiment of the present invention.

Overall Constitution

In FIG. 41, a home network 7002 and a home network 7003 are connected via the Internet 7001. The Internet 7001 has connected thereto a P2P server 703, which assists in the formation of communication paths for P2P communication among terminals. The home network 7002 comprises user terminals (a)-(d) that perform P2P communication, and routers 702A-702E connected in multiple stages. Further, the home network 7003 comprises a user terminal (e) that performs P2P communication, and routers 702F and 702G connected in multiple stages. The user terminals for P2P according to the seventh embodiment are capable of performing P2P communication in any combination of the user terminals from 701a through 701e.

Communication Device Configuration

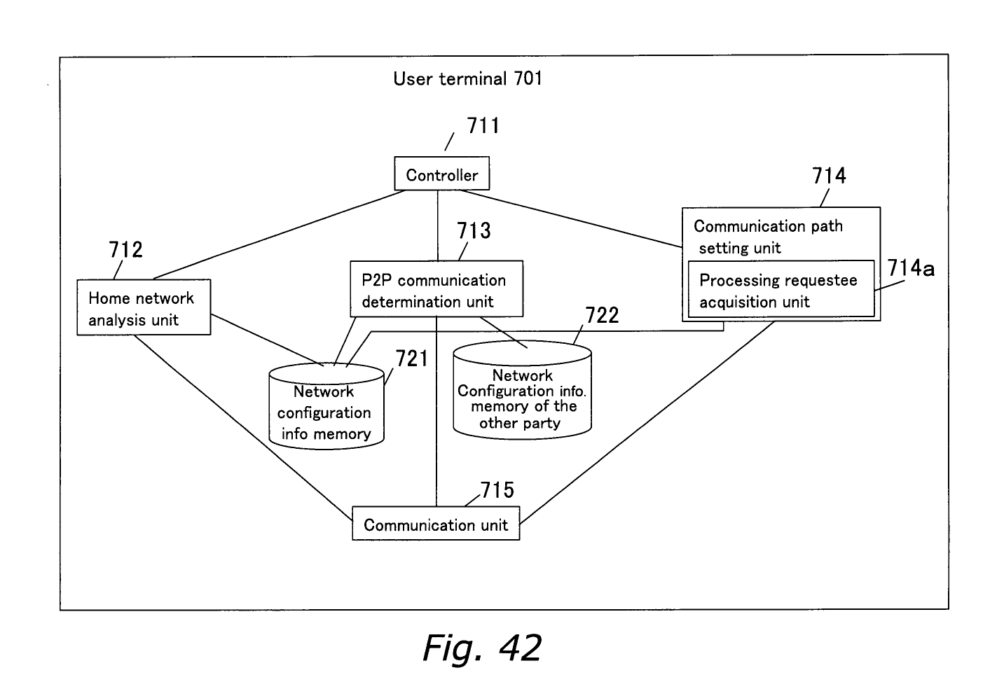

FIG. 42 is a block diagram of the user terminals 701 according to the seventh embodiment (user terminals 701a through 701e). This user terminal 701 comprises a controller 711, home network analysis unit 712, P2P communication determination unit 713, communication path setting unit 714, and communication unit 715.

The controller 711 gives instruction for processing to the functional units. The home network analysis unit 712 detects routers in the home network, and acquires and saves in the network configuration information storage the connection relationship of the detected routers and the router LAN addresses and WAN addresses. The P2P communication determination unit 713 uses the home network configuration information acquired by the home network analysis unit 712 and home network configuration information of the communication counterparty obtained via the communication unit 715 to determine whether P2P communication can be made. Further, the P2P communication determination unit 713 determines a communication path for performing P2P communications. The communication path setting unit 714, based on the results determined by the P2P communication determination unit 713, sets the communication path for the routers. The communication path setting unit 714 comprises a processing requestee acquisition unit 714a for accessing the routers based on the acquired addresses to acquire a requestee for router NAT settings and the like. The communication unit 715 executes data transmission/reception processing with routers 702, P2P server 703, and a user terminal of a counterparty for P2P communications.

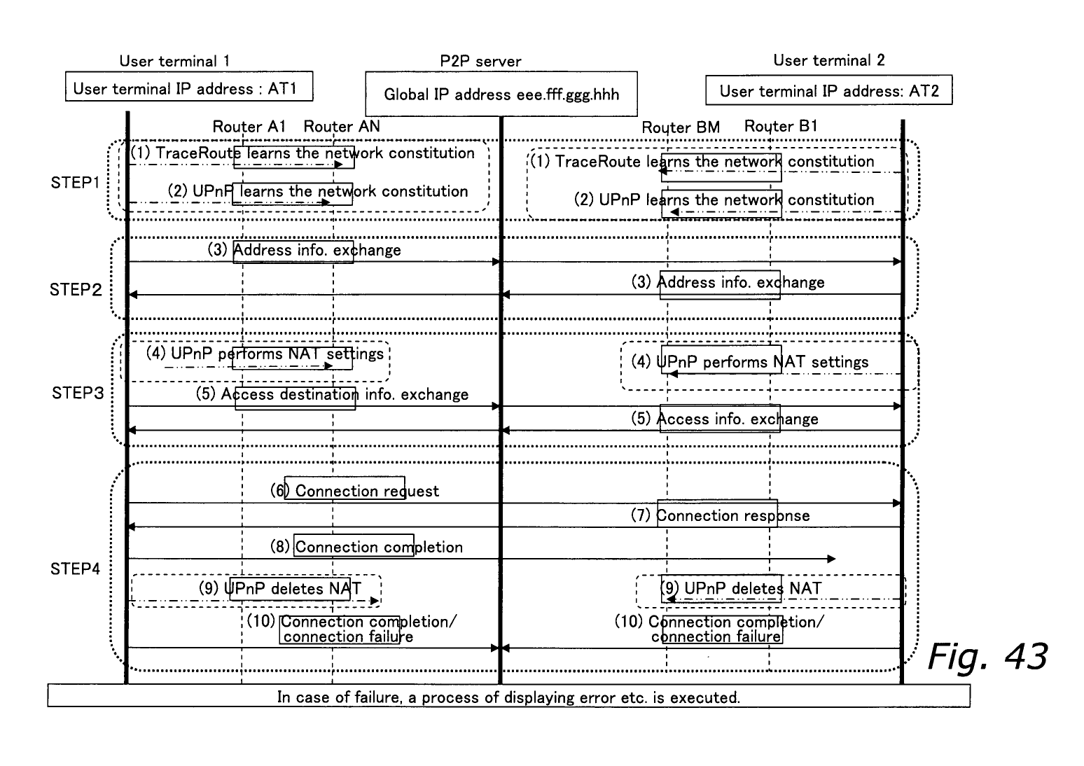

Operations of the user terminal 701 thus configured will be explained. FIG. 43 shows a sequence for P2P communication at time of connection executed by the user terminal 701.

First, a user terminal that desires to perform P2P communication (“user terminal 1”) notifies the user terminal of the counterparty with which it desires to perform P2P communications (“user terminal 2”) via the P2P server 703 that it desires to perform P2P communications. The user terminal 2, having received the notice, responds to the user terminal 1 that it accepts.

Step 1: Learning Network Configuration Information

The user terminals 1 and 2 investigate each other's home network configuration information. If the home network configuration information has already been acquired, there is no need to perform this.

The investigation of configuration information is carried out as follows. In the user terminals 1 and 2, the home network analysis unit 712, upon instruction from the controller 711, discovers routers in the home network and acquires WAN address information and information of the connection among the routers. Here, connection relationship refers to information regarding the order in which routers are connected. Such information is acquired by, for example, the following methods (1) through (4). Further, it is sufficient for the user terminals to learn the router configuration of a portion of the routers in the home network to which itself belongs, for example, the router configuration of the routers from itself to the router corresponding to a global address.

(1) Information Acquisition Method 1

As a method for discovering routers and acquiring router WAN address information and connection relationship information, the method described in the first embodiment using router discovery packets in which the TTL has been changed may be used. (See FIG. 43, (1) learning network configuration by traceroute).

More specifically, the user terminals 1 and 2 respectively acquire WAN address information and connection relationship of the routers as described below. First, the user terminals transmit router discovery packets in which the TTL has been changed to the routers in the home networks. Each user terminal receives response packets from routers in response to the router discovery packets, and acquires router LAN addresses from these response packets. The user terminals access routers based on these LAN addresses to acquire the WAN addresses. The home network analysis unit 712 of each user terminal can learn the connection relationship among the routers in the home network based on these acquired addresses.

(2) Information Acquisition Method 2

As a method for acquiring router WAN address information and connection relationship information, a method can be used that is similar to the method described in the third embodiment using a discovery packet in which a UPnP IGD specification is used. (See FIG. 43, (2) learning network configuration by UPnP.)

More specifically, first, each user terminals transmits a router discovery packet in which the TTL has been changed to routers in the home network. The user terminals receive from a router a response packet in response to the router discovery packet, and acquire the router LAN address from this response packet. The user terminals acquire a WAN address based on the LAN address. Next, based on the acquired WAN address, each user terminal repeats the process of acquiring the LAN address of a higher level router, and similarly acquires a WAN address based on the LAN address. The home network analysis unit 712 of each user terminal can learn the connection relationship of the routers in the home network based on these acquired addresses.

(3) Information Acquisition Method 3

Further, a method for acquiring router WAN address information and connection relationship information can be applied to a home network comprising a router that filters ICMP Time Exceeded packets, using a method similar to that described in the fifth embodiment having improved processing efficiency.

More specifically, first, each user terminal transmits router discovery packets in which the TTL has been changed to routers in the home network. Each user terminal counts the timeout set in the router discovery packets, and detects whether a response packet has been received in response to each router discovery packet. If a response packet has not been received, the user terminal concludes that the router detected with the TTL value smaller than the TTL value of the response packet initially timed out to be a router that filters IMCP. The user terminals acquire a WAN address based on the LAN address acquired from the response packet from the filtering router. Further, the user terminals repeat the process of acquiring the LAN address of a higher level router, and similarly acquiring a WAN address based on the LAN address. The home network analysis unit 712 of each user terminal can learn the connection relationship of the routers in the home network based on these acquired addresses.

(4) Information Acquisition Method 4

Further, a method for acquiring router WAN address information and connection relationship information can be applied to a home network comprising a router that does not process TTL, and may employ a method similar to that described in the sixth embodiment having improved processing efficiency.

More specifically, first, each user terminal transmits router discovery packets in which the TTL of the router discovery packet has been changed to routers in the home network. Each user terminal receives response packets in response to the router discovery packet from the routers, and acquires the LAN address for each router from these response packets. Each user terminal acquires a WAN address based on the LAN address.

Here, each user terminal checks whether the address spaces of the LAN address of the router acquired by the router discovery packet in which TTL=N, and the WAN address of the router detected by the router discovery packet in which TTL=N−1 match. When determination is made that there is no match, each user terminal conjectures an address based on the WAN address of the router acquired by the router discovery packet in which TTL=N−1, and transmits the router discovery packet to receive a response with respect thereto. Each user terminal acquires the LAN address of the router in which TTL=N from this response packet, and acquires the WAN address of the router based this LAN address. The home network analysis unit 712 of each user terminal is capable of learning the connection relationship of routers in the home network based on these acquired addresses.

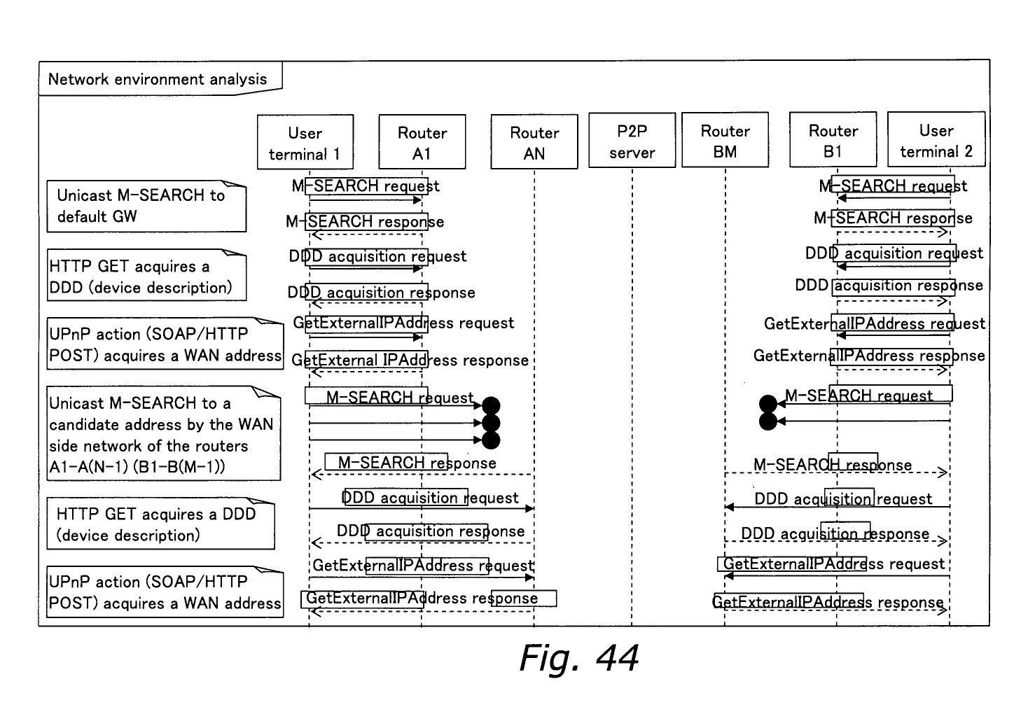

FIG. 44 shows one example in which a discovery packet using the UPnP IGD specification is used to acquire WAN address information and connection relationship information of routers in the home network. This process for discovering a router to acquire WAN address information and connection relationship information of the routers is as in the methods according to the first through sixth embodiments. A brief explanation will be given as follows. Each user terminal acquires information of a requestee for an action with respect to a router by means of M-Search request and response, and a device description request and response to the default gateway, i.e., default router. A user terminal then acquires the LAN address for the router to which it itself is connected. Then, by Get External IP Address request to and response from the router having such LAN address, a user terminal acquires the WAN address of such router. Based on the acquired WAN address, a user terminal conjectures the LAN addresses for routers constituting the home network and makes M-Search requests in unicast mode. A user terminal acquires information of the requestee for an action with respect to a router based on a response to the M-Search request, and device description acquisition request and response. A user terminal acquires the LAN address for each router. Further, each user terminal similarly acquires the WAN address of each router based on the Get External IPAddress request and response. The home network analysis unit 712 of each user terminal can learn the connection relationships of the routers in the home network based on these acquired addresses.

Step 2: Address Information Transmission

A user terminal 1, having acquired WAN address information and connection relationship information (home network configuration information) of routers in a home network connected upstream to itself (direction moving away from the user terminal, i.e., the direction closer to the Internet) instructs the P2P communication determination unit 713 to exchange configuration information.

As show in FIG. 43, (3) address information exchange, the P2P communication determination unit 713, having received the instruction, uses information stored in the network configuration information storage unit 721 to prepare an address exchange message, and transmits the same via the communication unit 715 to the P2P server 703. The P2P server 703, having received the address exchange message, refers to the destination information stored in the message, and transmits this address exchange message to the user terminal 2 that is a communication counterparty.

The P2P communication determination unit 713 of the user terminal 2 receives the address exchange message via the communication unit 715. The P2P communication determination unit 713 of the user terminal 2 stores the received information in the network configuration information storage unit 722 of the other party. Further, the P2P communication determination unit 713 prepares an address exchange message in the same manner as in the user terminal 1, and transmits the same via the communication unit 715 to the P2P server 703. This message is similarly relayed by the P2P server 703 and received by the communication device 1.

The P2P communication determination unit 713 of the user terminal 1, having received the address exchange message from the user terminal 2 in the same manner, stores the information in the network configuration information storage unit 722 of the other party.

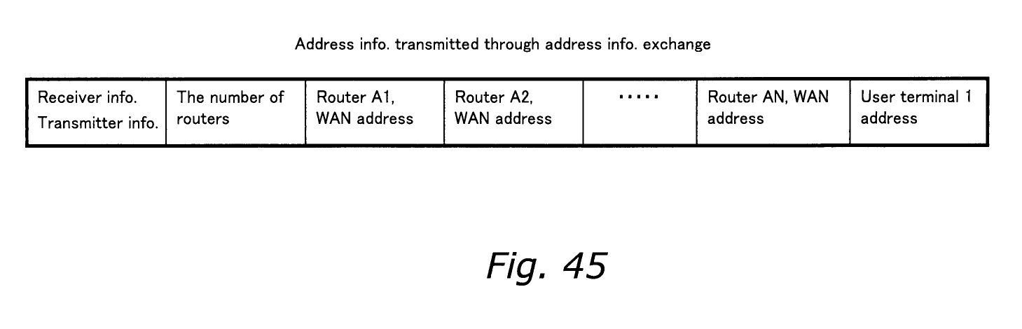

FIG. 45 shows one example of an address exchange message of the user terminal 1. The address exchange message prepared and transmitted by the user terminal 1 contains destination information to be used for the P2P server to identify the destination, WAN address information of routers in the home network, and address information of the user terminal 1.

A specific example of the address exchange message will be described. With the user terminal (a) of FIG. 41, the number of routers from the Internet 7001 is 3. Therefore, WAN addresses for the routers 702E, 702C, and 702A and the address of the user terminal (a) are contained in the address exchange message to be transmitted. Further, with the user terminal (c), the number of routers from the Internet 7001 is 2, and a WAN addresses for the routers 702E and 702C and an address of the user terminal (c) are contained in the address exchange message to be transmitted.

Step 3: Securing a Communication Path and Transmitting Access Destination Information

In step 3, (4) NAT settings using UPnP and (5) Access information exchange in FIG. 43 are performed. With such a constitution, the P2P communication determination units 713 of the user terminal 1 and user terminal 2 each determine a communication path to the other. When NAT settings have already been performed, there is no need to perform NAT settings.

This communication path determination is executed using own home network configuration information stored in the network configuration information storage unit 721 and home network configuration information of the user terminal that is a communication counterparty stored in the network configuration information storage unit 722 of the other party. This method for determining a communication path will be described in detail below.

When communication path determination of the P2P communication determination unit 713 ends, the communication path setting unit 714 performs settings so as to secure the communication path determined by the P2P communication determination unit 713. In this setting method, as in the first through sixth embodiments, LAN addresses for routers acquired at time of learning home network configuration are used to perform NAT and/or firewall settings. For example, in P2P communication between the user terminals (a) and (d), the P2P communication determination unit 713 of the user terminal (a) determines that a communication path needs to be secured between the routers 702C and 702A. In accordance with this determination, the communication path setting unit 714 of the user terminal (a) executes NAT and/or firewall settings for the routers 702C and 702A. Meanwhile, the P2P communication determination unit 713 of the user terminal (d) determines that a communication path needs to be secured between the routers 702D and 702B. In accordance with this determination, the communication path setting unit 714 of the user terminal (d) executes NAT and/or firewall settings for the routers 702D and 702B.

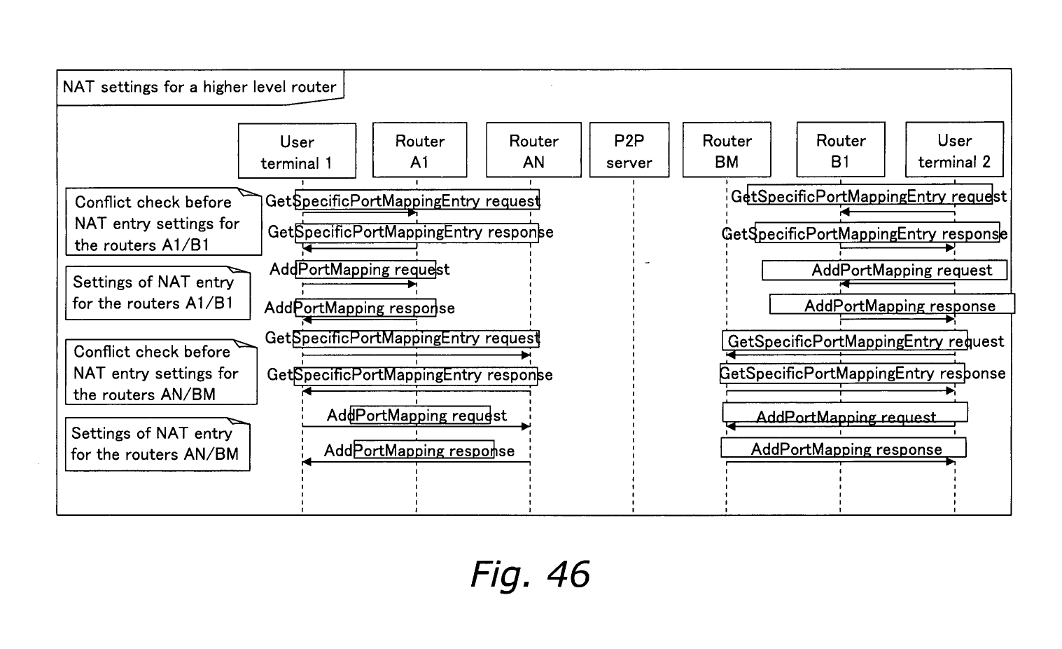

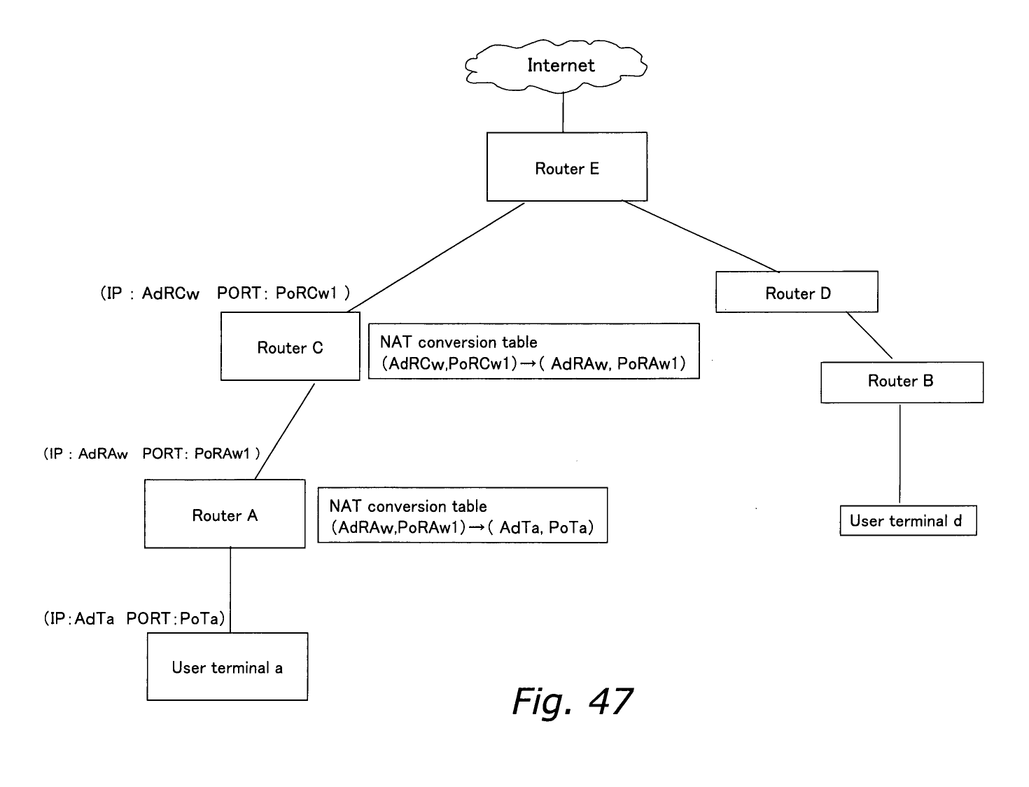

FIG. 46 shows one example of a sequence using the UPnP IGD specification to set a communication path. Further, FIG. 47 shows one example of NAT and firewall settings executed by the user terminal (a). An explanation will be given of one example of setting with reference to FIG. 47.

Let us assume that user terminal (a) performs P2P communication using a port number PoTa. The user terminal (a) sets routers A and C so as to allow a packet to reach its own IP address AdTa and port number PoTa from the user terminal (d) that is the communication counterparty. Here, let us assume that the WAN address of the router C is AdRCw, and the WAN address of the router A is AdRAw. The user terminal (a) executes NAT and firewall settings so that the packet arriving from the WAN side of the router C arrives at PoTa of the user terminal (a). For this purpose the user terminal (a) performs settings for the router C so that the packet arriving at the specific port PoRCw1 of the router C is converted into the WAN address of the router A and specific port (AdRAw, PoRAw1). Further, the user terminal (a) executes router A settings so that the packet arriving at the port PoRAw1 of the WAN address of the router A is converted into the port number PoTa of the user terminal (a). As a result of these settings, when the user terminal (d) transmits a packet to the IP address of AdRCw, port number PoRAw1, the packet arrives at the port number PoTa of the user terminal (a).

When securing the communication path is thus completed, the communication path setting unit 714 transmits an address to which a packet is to be transmitted by the other user terminal and information of the port number (access information) for P2P communication via the P2P server 703 to the other user terminal. In the example of FIG. 47, the user terminal (a) notifies the user terminal 2 of the WAN address of the router C and the port numbers (AdRCw. PoRcw1) for which NAT settings have been performed as access destination information.

Even when path settings (NAT and firewall setting) fail in a single one of the routers regarding which it has been determined that path settings are required, path settings of the remaining set routers are cancelled, and information indicating “no access destination” is transmitted at time of exchange of access destination information.

Step 4: Determination of Connection Direction and Connection Confirmation

Next, step 4 includes, as shown in FIG. 43, steps for (6) requesting connection, (7) responding to connection, (8) completing connection, (9) deleting NAT by UPnP, and (10) completing/failing to connect. When a communication path set in advance is used, (9) deleting NAT settings is unnecessary.

When exchange of access information is completed, the controller 711 of each user terminal determines connection direction. The connection direction is determined using the results of access information exchange. The results of access information exchange include the following four cases. Each case will be explained below.

Cases that

(a) “no access destination” applies to neither user terminal;

(b) “no access destination” applies to user terminal 1;

(c) “no access destination” applies to user terminal 2; and

(d) “no access destination” applies to both user terminals

The above four cases will be explained below.

In Case of (a)

In a case where “no access destination” applies to neither user terminal, P2P communication can be performed when either of the user terminals 1 and 2 starts communication. Here, an explanation will be given of a case where the user terminal 1 starts communication.

The user terminal 1 transmits a connection request message to the user terminal 2. At this time, based on access destination information message received from the user terminal 2 in advance, the connection request message is transmitted to the designated IP address and port number of the user terminal 2. This connection request message is transmitted to the user terminal 2 without passing through the P2P server. This connection request message arrives at the user terminal 2 while the destination information is converted into an address by NAT settings set at time of securing the communication path.

The user terminal 2, having received the connection request message, extracts and stores the source address and port number from the header information of the connection request message. The connection response message is transmitted to the extracted source address and port number.

Generally in routers, after destination address conversion from WAN to LAN is executed, a communication path is established for a certain period of time. In other words, after a communication path has been established, the source information of the packet to be transmitted from the LAN side to WAN side is converted by NAT settings set so as to perform communication from WAN to LAN. It is the nature of packet source information, when a user terminal receives a packet, to be converted so as to match the address port number of the user terminal that received the packet.

For example, an explanation will be given of an example of conversion with reference to FIG. 47. First, let us assume that the user terminal (a) receives a connection request message packet from the user terminal (d) via the port PoRCw1 of the router C and port number PoRAw1 of the router A at PoTa of the user terminal (a). Next, the user terminal (a) transmits a connection response from the port number PoTa to the user terminal (d) that is the message source. At this time, the source information of port number PoTa is converted by the router A (AdRAw, PoRAw1), and further converted by the router C (AdRCw, PoRCw1). As a result, when the packet is received by the user terminal (d), the source information of the user terminal (a) matches the destination information (address, port number) transmitted by the user terminal (d).

Next, upon receiving the connection response message from the user terminal 2, the user terminal 1 transmits a connection completion message. Data transmission/reception is then executed by P2P communication.

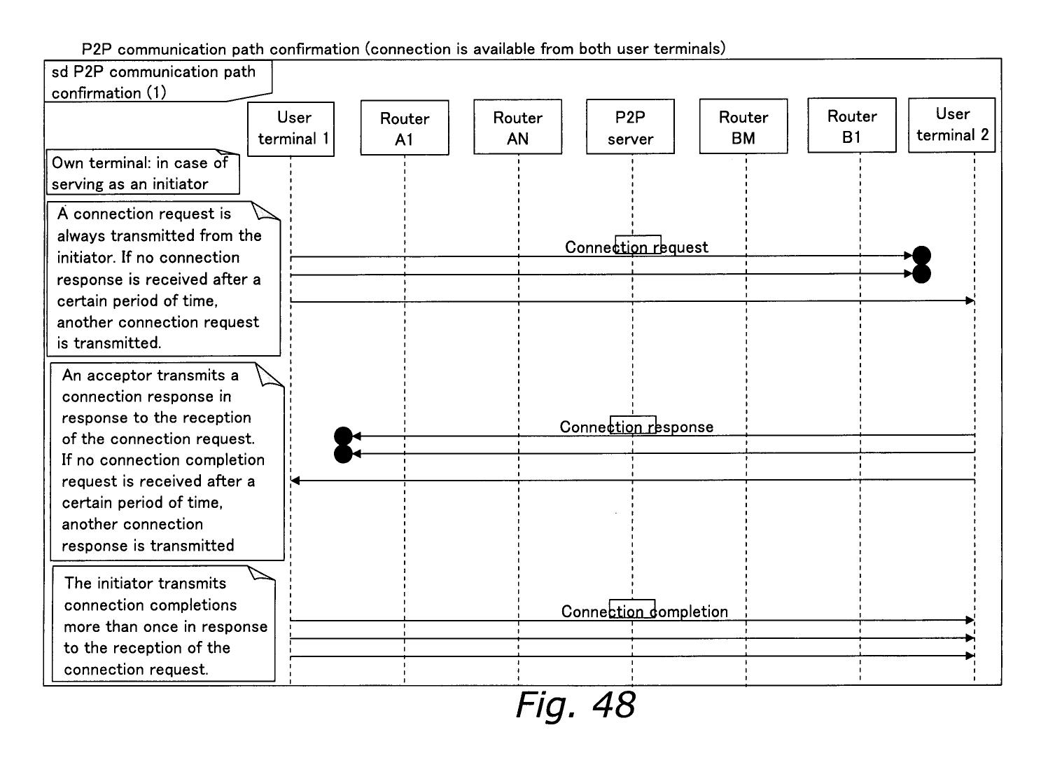

FIG. 48 shows a sequence for a case where “no access destination” does not apply to either of the user terminals, that is, a case where both terminals are capable of connection. When P2P communication is executed using a UDP, messages such as this connection request are made using a UDP. Further, in view of the possibility that the packet may be discarded, each message may be transmitted more than once. For example, as shown in FIG. 48, when the terminal 1 that is initiator starts communication, first, the user terminal 1 makes a connection request to the user terminal 2. If the connection request from the user terminal 2 has not been received within a certain period of time, the user terminal 1 retransmits the connection request to the user terminal 2. Similarly, the user terminal 2 that is an acceptor retransmits the connection response if connection completion has not been received from the user terminal 1 within a certain period of time after transmission of the connection request to the user terminal 1. In the foregoing, communication is started from the user terminal 1 as initiator. However, in the case of (a), both user terminals 1 and 2 can acquire home network configuration information and connection can be started from either user terminal. Therefore, when the user terminal 2 is initiator, communication can be started from the user terminal 2.

Further, in the case of TCP, the TCP connection process itself serves a role equivalent to the connection request message explained above.

If connection from the user terminal 1 to the user terminal 2 fails due to incomplete settings of firewall or similar reason, connection may be executed from the user terminal 2 to the user terminal 1. Further, both connection from the user terminal 1 to user terminal 2 and connection from the user terminal 2 to user terminal 1 may be tried.

The Case of (b)

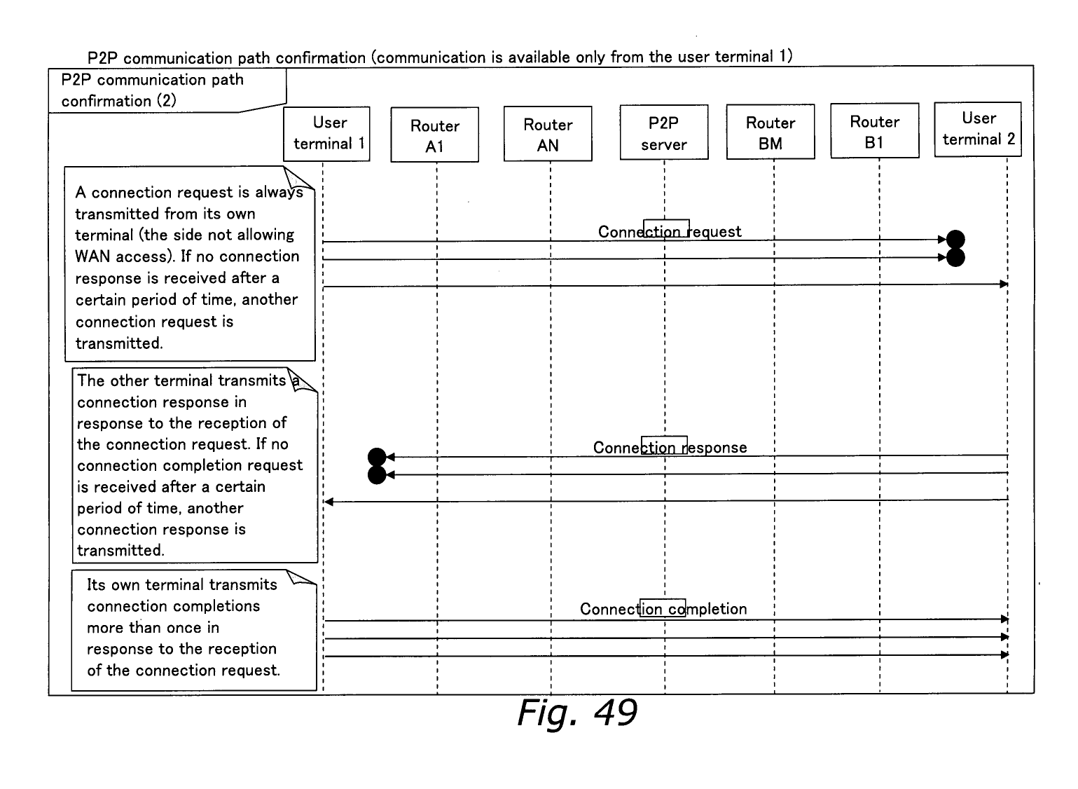

This is a case where “no access destination” applies to the user terminal 1, that is, the user terminal 1 has not acquired home network configuration information and the access destination information transmitted by the user terminal 1 to the user terminal 2 is “no access destination.” In other words, access destination address and port number are written in the destination information that the user terminal 1 received from the user terminal 2. Therefore, only connection from the user terminal 1 to user terminal 2 can be made. FIG. 49 shows a sequence for a case where “no access destination” applies to the user terminal 1. In the case of (b), the user terminal 1 executes initial access to the user terminal 2. After the user terminal 1 transmits a connection completion message and the user terminal 2 receives the connection completion message, data transmission/reception is executed by P2P between the two terminals. The user terminal 2 cannot access the user terminal 1 without access from the user terminal 1.

The Case of (c)

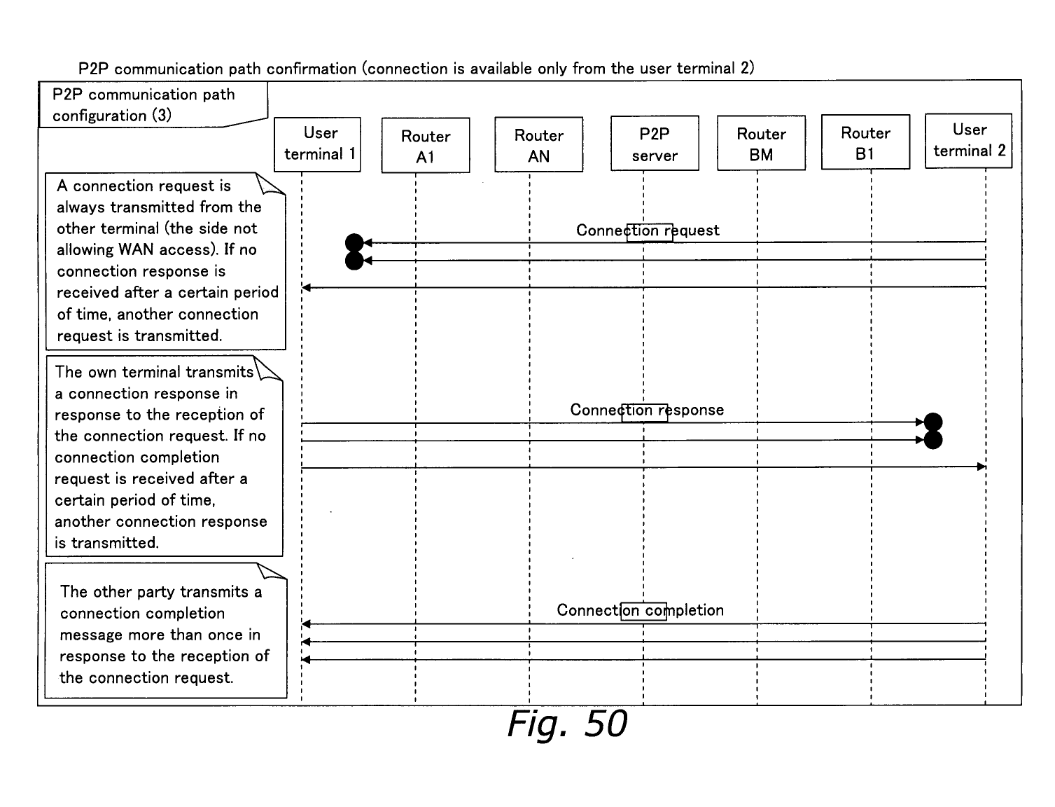

When “no access destination” applies to the user terminal 2, that is, the user terminal 2 has not acquired home network configuration information and the access information transmitted by the user terminal 2 to the user terminal 1 is “no access destination.” An access destination address and port number are written in the destination information that the user terminal 2 received from the user terminal 1. Therefore, only connection from the user terminal 2 to user terminal 1 can be made. FIG. 50 shows a sequence for a case where “no access destination” applies to the user terminal 2. In case of (c), the user terminal 2 executes initial access to the user terminal 1. After the user terminal 2 transmits a connection completion message, and the user terminal 1 receives the message, data transmission/reception is executed by P2P between the two terminals. The user terminal 1 cannot access the user terminal 2 without access from the user terminal 2.

The Case of (d)

This is a case where “no access destination” applies to both user terminals, and both user terminals transmit “no access destination” at time of exchanging access information. In other words, both user terminals are unable to acquire home network configuration information. In such a case, the controller 711 determines that P2P communication cannot be made, and stops P2P communication processing. In this case, communication can be switched to communication between the user terminals via the P2P server 703 to execute data transmission/reception between the user terminals.

The foregoing described the sequence for P2P communication connection executed by the user terminal 701. In the present embodiment, in the explanation based on FIG. 43, at time of performing P2P communications, home network configuration information is learned using router discovery packets in which the TTL is changed, and/or discovery packets using the UPnP IGD specification. Alternatively, home network configuration information may be acquired in advance, as when a user terminal is turned on, and such information is used.

Further, in the explanation with reference to FIG. 43, after address information exchange, based on the determination results of the P2P communication determination unit 713, communication path settings are performed. Alternatively, communication path settings all the way to the highest router may be performed in advance, as when a user terminal is turned on, and as a result of determination by the P2P communication determination unit 713, notification may be given to the user terminal 2 of the port number and IP addressed for which NAT settings have been made in advance in the highest router for which it is determined that communication path settings are needed, as access destination information. In this case, communication path setting are not deleted even when P2P communication fails or communication is completed.

Communication Path Determination Method

Next, an explanation will be given of a sequence for communication path determination executed by the P2P communication determination unit 713. The P2P communication determination unit 713, after exchange of address information, compares configuration information of its own home network stored in the network configuration information storage unit 621 and the information in the address information exchange message received from the user terminal of the other party to determine the communication path.

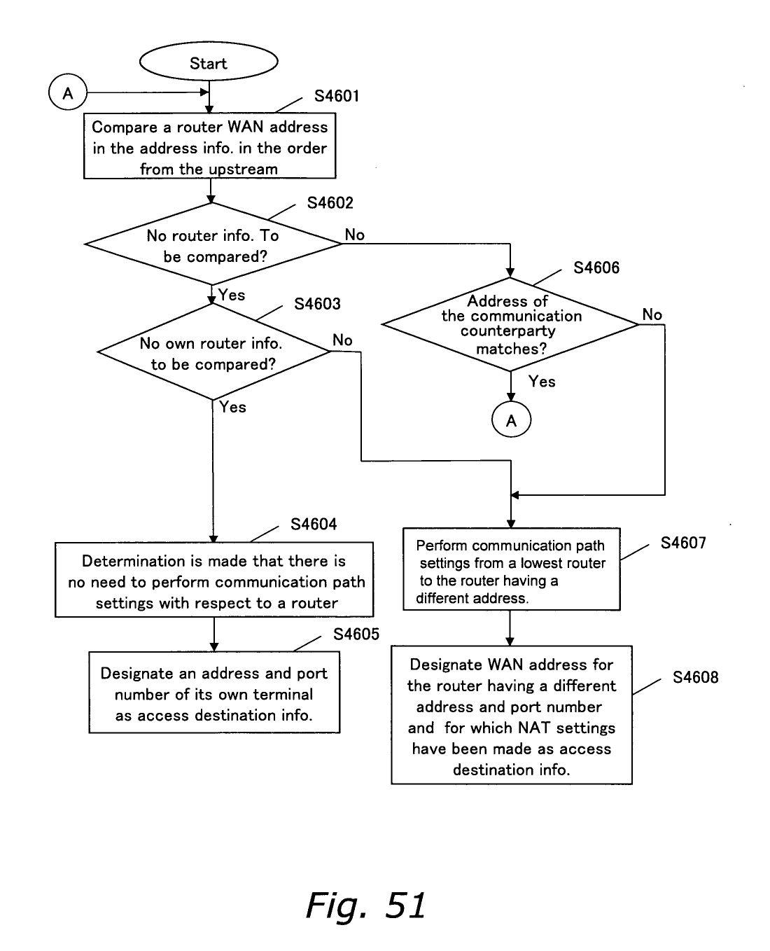

A more specific explanation will be given. FIG. 51 is one example of a sequence for communication path determination performed by the P2P communication determination unit 713. As described below, between the user terminals 1 and 2, home network configuration information is exchanged. Therefore, the user terminal 1 has configuration information of its own home network, and home network configuration information of the user terminal 2. An explanation will be given with a focus on the communication path determination method of the user terminal 1.

In step S4601, first, the P2P communication determination unit 713 of the user terminal 1 extracts the WAN address of the highest router (i.e. the router closest to the Internet) contained in the configuration information of its own home network. Similarly, the P2P communication determination unit 713 of the user terminal 1 extracts the WAN address of the highest router contained in the configuration information of the user terminal 2 as communication counterparty. Its own WAN address and the WAN address of the other party are compared. In other words, the P2P communication determination unit 713 first compares the WAN address of the highest router of its own home network and the WAN address of the highest router of the communication counterparty.

If control has returned to step S4601, the WAN addresses of the respective second routers of the user terminals 1 and 2 are compared. Thus, in order starting from the WAN address of the highest router contained in the configuration information of the user terminal 1, comparisons are made against the WAN addresses in the configuration information of the user 2 as communication counterparty, acquired through address information exchange.

In step S4602, the P2P communication determination unit 713 of the user terminal 1 determines whether WAN address information for comparison is missing from either of the user terminal 1 or user terminal 2.

In step S4603, when determination is made that WAN address information for comparison is missing from either the user terminal 1 or user terminal 2, the P2P communication determination unit 713 of the user terminal 1 determines whether the WAN address information for comparison is missing from the configuration information of the user terminal 1. If the WAN address information for comparison is missing from the configuration information of the user terminal 1, control proceeds to step S4605. In contrast, if the WAN address information for comparison is missing from the configuration information of the user terminal 2, control proceeds to step S4607.

In step S4605, if the WAN address information for comparison is missing from the configuration information of the user terminal 1, the P2P communication determination unit 713 of the user terminal 1 determines that a communication path does not need to be set.

In step S4605, when in step S4604 determination has been made that a communication path does not need to be set, the communication path setting unit 714 of the user terminal 1 makes no settings for communication path. The communication setting unit 714 of the user terminal 1 notifies the user terminal 2 of the IP address and port number of the user terminal 1 to be used as access destination information for P2P communications.

In step S4606, when in step S4602 determination is made that WAN address information for comparison is missing from the user terminal 1 or user terminal 2, the P2P communication determination unit 713 of the user terminal 1 performs the following processing. The P2P communication determination unit 713 determines whether there is match between a WAN address in the home network configuration information of the user terminal 1 and a WAN address in the home network configuration information of the user terminal 2. If, as a result when determination is made that there is a match with the P2P communication determination unit 713 of the user terminal 1, control returns to step S4601.

In step S4607, if in step S4606 no match is found between addresses, the P2P communication determination unit 713 of the user terminal 1 determines that a communication path needs to be set for routers located at a position lower than the routers with differing WAN addresses.

If in step S4603 it is found that WAN address information for comparison is missing from the configuration information of the user terminal 2, determination is made that the user terminal 2 of the communication counterparty is directly connected to the upstream router in the home network of the user terminal 2. In other words, the user terminal 2 of the communication counterparty is directly connected to a certain router. Meanwhile, the user terminal 1 is connected to the router to which the user 2 is directly connected via one or more other routers. Therefore, the P2P communication determination unit 713 of the user terminal 1 determines that a communication path needs to be set for the routers existing between the router in the home network configuration information currently subject to comparison and the user terminal 1.

In step S4608, the communication path setting unit 714 of the user terminal 1 executes NAT and firewall settings based on the determination results in step S4607. In other words, when determination is made that there is no match between addresses in step S4606, the P2P communication determination unit 713 of the user terminal 1 instructs a router located at a position lower than the routers having differing WAN addresses to execute NAT and firewall settings.

Now let us consider a case where the P2P communication determination unit 713 of the user terminal 1 determines that in step S4603 WAN addresses are missing from the configuration information of the user terminal 2. In this case, the communication path setting unit 714 executes NAT and firewall settings with respect to routers existing between the router currently subject to comparison and the user terminal 1. Because as described above the user terminal 2 of the communication counterparty is directly connected to the upstream router, one would think that if the user terminal 1 is to connect with a communication counterparty, the user terminal can make connection by dynamic NAPT without setting a communication path. However, in view of a case of a mistake in acquired configuration information due to, for example, a router that does not process ICMP messages, P2P connection reliability is enhanced by setting a communication path allowing for connection from the user terminal of the other party too.

Thereafter, the user terminal 1 notifies the user terminal 2 of the following access destination information: with respect to a router the address of which is different for the communication counterparty, or a router directly connected under a router to which the user terminal 2 as communication counterparty is connected, WAN address and port number for which NAT settings have been made. In other words, notification is given to the user terminal 2 of, from among the WAN addresses for routers acquired by the user terminal 1, the initial WAN address different from a WAN address acquired by the user terminal 2 as counterparty, and the port number set in the router having such WAN address by NAT settings. For example, the P2P communication determination unit 713 transmits to the communication device of the communication counterparty a WAN address when its own configuration information and the configuration information of the communication counterparty differ. Further, the communication path setting unit 714 transmits to the communication device of the communication counterparty the port numbers set by NAT settings with respect to the routers having different WAN addresses.

The foregoing is a sequence for communication path determination performed by the P2P communication determination 713.

Various methods for setting P2P communication are possible. For example, first, router addresses are acquired for all routers within the home network positioned from the communication device to the border router connecting the home network and wide area network. The communication device of the other party similarly acquires router addresses all the way to the border router. Router addresses are exchanged with the communication device of the other party. Next, by making determination of match/non-match of router addresses, a branch in the communication path is looked for. Thereafter, settings may be made for a communication path to the branch, and after communication path settings have been completed, the communication counterparty is notified of address information of the branch; alternatively, P2P communications may be set using the following method. First, a communication path from the communication device to the wide area network is set in advance. Next, router addresses for each router until the border router are acquired, and router addresses are exchanged with the communication device of the other party to look for a branch. P2P communications can be carried out by notifying the communication counterparty of address information of the branch.

Specific Example of the Sequence for Communication Path Determination

Next, an explanation will be given of a specific example of a sequence for communication path determination performed by the P2P communication determination unit 713. An explanation will be given of (1) a case of communication between the user terminals via the Internet, and (2) a case of communication between user terminals in the same home network.

(1) Communication Via the Internet

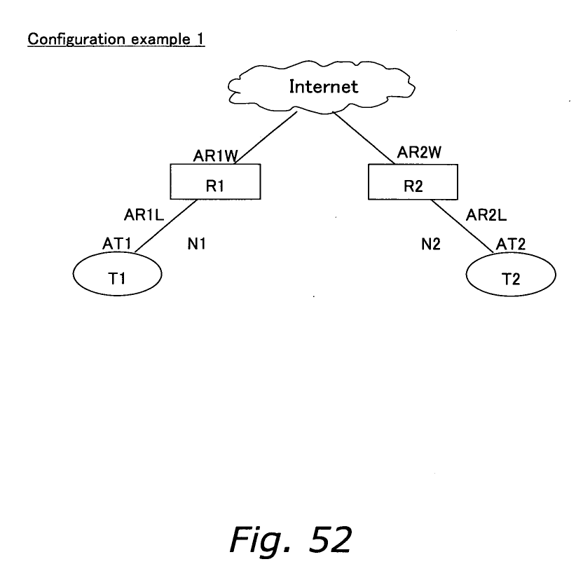

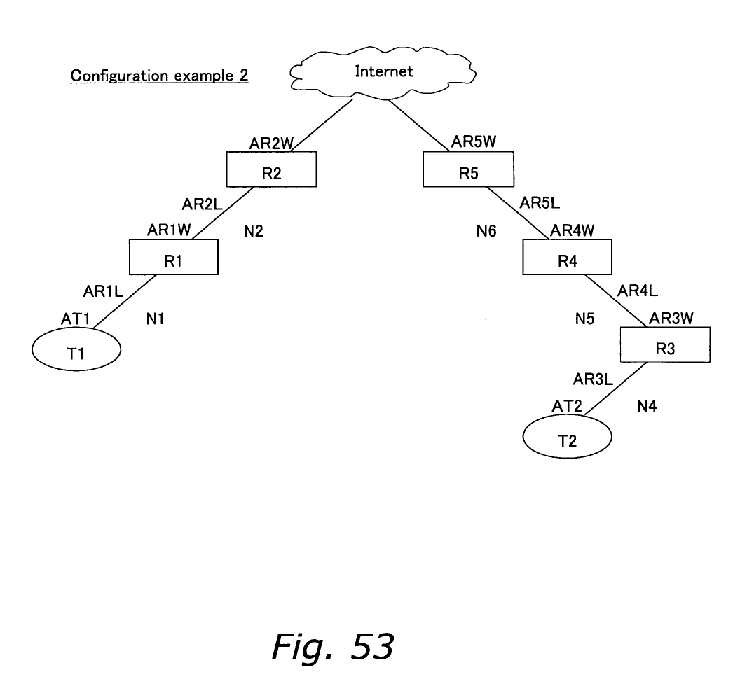

FIGS. 52 and 53 show examples of a case where the user terminal 1 (T1) and user terminal 2 (T2) communicate each other via the Internet.

(1-1) Configuration Example 1

In the configuration example 1 of FIG. 52, the user terminal 1 acquires the WAN address of the router R1 (AR1W) located between the Internet and itself as home network configuration. Meanwhile, the user terminal 2 acquires the WAN address of the router R2 (AR2W) located between the Internet and itself as home network configuration. The user terminal 1 notifies the user terminal 2 of the WAN address of the router R1 (AR1W) and its own address AT 1 by an address information exchange message. Similarly, the user terminal 2 notifies user terminal 1 of the WAN address of the router R2 (AR2W) and its own address AT 2.

The P2P communication determination unit 713 of the user terminal 1 compares the address information, and discovers that AR1W and AR2W are different, thus determining that communication path settings need to be made for the router R1. After NAT and as necessary firewall settings of the router R1 are executed by the communication path setting unit 714 of the user terminal 1, the IP address and port number of the router R1 in which NAT settings have been made are notified to the user terminal 2 as access destination information. Similarly, the P2P communication determination unit 713 of the user terminal 2 determines that communication path settings need to be made for the router R2. After the communication path setting unit 714 has made communication path settings for the router R2, the IP address and port number of the router R2 for which NAT settings have been made are notified to the user terminal 1 as access destination information.

(1-2) Configuration Example 2

Next, an explanation will be given of configuration example 2 of FIG. 53. Configuration example 2 is a case where a home network comprises multiple routers. In this case, the user terminal 1 acquires the WAN address of the router R2 (AR2W) and WAN address of the router R1 (AR1W) located between the Internet and itself as home network configuration. Meanwhile, the user terminal 2 acquires the WAN address of the router R5 (AR5W), the WAN address of the router R4 (AR4W), and the WAN address of the router R3 (AR3W) located between the Internet and itself as home network configuration. The user terminal 1 notifies the user terminal 2 of the WAN address of the router R2 (AR2W), WAN address of R1 (AR1W), and its own address (AT1) by an address exchange message. Further, the user terminal 2 notifies the WAN address of the router R5 (AR5W), WAN address of the router R4 (AR4W), WAN address of the router R3 (AR3W), and its own address AT2 by an address information exchange message.

The P2P communication determination unit 713 of the user terminal 1 compares the WAN address of the highest router (R2) of its own configuration information, and WAN address of the highest router (R5) of the address information notified from the user terminal 2, and because AR2W and AR5W differ, makes determination that a communication path needs to be set for router R2 and routers downstream thereof, i.e., the router R1. Based on this determination result, the communication path setting unit 714 of the user terminal 1 executes settings for communication path for the routers R2 and R1; thereafter an IP address and port number of the router R2 for which NAT settings have been made are notified to the user terminal 2 as access destination information. Further, the user terminal 2 also determines that a communication path needs to be set for the routers R5, R4, and R3. The communication path settings are executed for the routers R5, R4, and R3, and the IP address and port number of the router R5 for which NAT settings have been made are notified to the user terminal 1 as access destination information.

(2) In case of Communications Under the Same Router

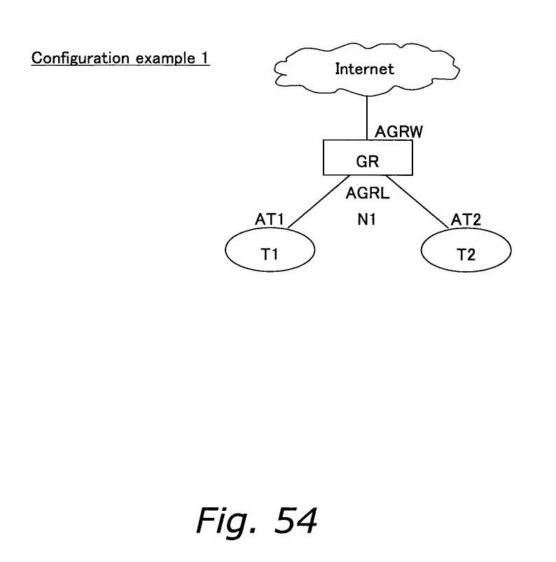

FIGS. 54-58 show examples of communications among user terminals in the same home network.

(2-1) Configuration Example 1

In the configuration example 1 in FIG. 54, the user terminal 1 acquires, as home network configuration, the WAN address (AGRW) of a router GR located between the Internet and the user terminal 1 itself. Meanwhile, the user terminal 2 acquires, as home network configuration, the WAN address (AGRW) of a router GR (GR) located between the Internet and user terminal 2 itself. The user terminal 1 (T1) notifies the user terminal 2 of the WAN address (AGRW) of the router GR (GR) and its own address AT1 by address exchange message. The user terminal 2 (T2) notifies the user terminal 1 of the WAN address (AGRW) of the router GR (GR) and its own address AT2 by address information exchange message.

The P2P communication determination unit 713 of the user terminal 1 compares the WAN address of the highest router (GR) in its own configuration information and the WAN address of the highest router (GR) in the address information notified from the user terminal 2, and because the two match, the P2P communication determination unit 713 tries to compare the subsequent addresses. However, because there is no subsequent router in its own configuration information, it determines that a communication path does not need to be set. Based on this determination, the communication path setting unit 714 notifies the user terminal 2 of the IP address of the user terminal 1 and a port number for P2P communication as access destination information. It will be appreciated that when determination is made that a communication path does not need to be set, and/or when detection is made that there is no information of a subsequent router for the user terminal 2, determination can be made that the user terminals are connected to the same router (GR in this case), verification made of whether the address of the user terminals are in the same address space, and in cases where the user terminals are not in the same address space, a determination made of connection not possible.

Further, in the user terminal 2 as well, determination is made using the same process that a communication path does not need to be set, and the communication path setting unit 714 notifies the user terminal 1 of the IP address of the user terminal 2 and port number for P2P communication as access destination information.

(2-2) Configuration Example 2

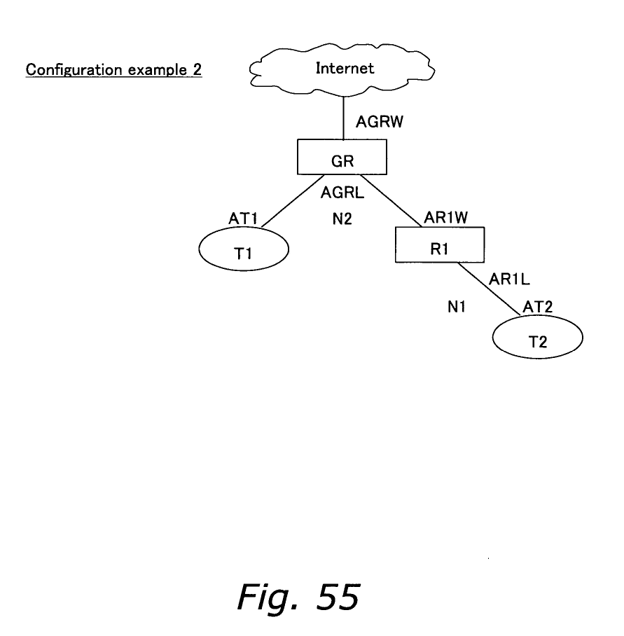

In the configuration example 2 in FIG. 55, the user terminal 1 acquires, as configuration information, the WAN address (AGRW) of a router GR located between the Internet and the user terminal 1 itself. Meanwhile, the user terminal 2 acquires the WAN address (AGRW) of a router GR (GR) and WAN address (AR1W) of the router R1 located between the Internet and the user terminal 2 itself. As in the configuration example 1, the user terminal 1 (T1) notifies the user terminal 2 of the WAN address (AGRW) of the router GR (GR) and its own address AT1 by address exchange message. The user terminal 2 (T2) notifies the user terminal 1 of the WAN address (AGRW) of the router GR (GR), WAN address (AR1W) of the router R1, and its own address AT2 by address information exchange message.

The P2P communication determination unit 713 of the user terminal 1 compares the WAN address of the highest router (GR) in its own configuration information and the WAN address of the highest router (GR) in the address information notified from the user terminal 2, and because the two match, the P2P communication determination unit 713 tries to compare the subsequent addresses. However, because there is no subsequent router in its own configuration information, determination is made that a communication path does not need to be set. Based on this determination, the communication path setting unit 714 notifies the user terminal 2 of the IP address of the user terminal 1 and a port number for P2P communication as access destination information. The P2P communication determination unit 713 of the user terminal 1 compares the WAN address of the higher level router (GR) in its own configuration information and the WAN address of the highest router (GR) in the address information notified from the user terminal 2, and because the two match, the P2P communication determination unit 713 tries to compare the subsequent addresses. However, because there is no subsequent router in its own configuration information, determination is made that a communication path does not need to be set. Based on this determination, the communication path setting unit 714 notifies the user terminal 2 of the IP address of the user terminal 1 and port number for P2P communications as access destination information.

Further, the P2P communication determination unit 713 of the user terminal 2 compares the WAN address of the highest router (GR) in its own configuration information and the WAN address of the highest router (GR) in the address information notified from the user terminal 1, and because the two match, the P2P communication determination unit 713 tries to compare the subsequent addresses. However, while a subsequent router (R1) exists in its own configuration information, there is no subsequent router information in the address information notified from the user terminal 1; thus determination is made that a communication path needs to be set. Based on this determination, the communication path setting unit 714 executes router R1 communication path settings to notify the user terminal 1 of an IP address and port number of the router R1 for which NAT settings have been made as access destination information.

(2-3) Configuration Example 3

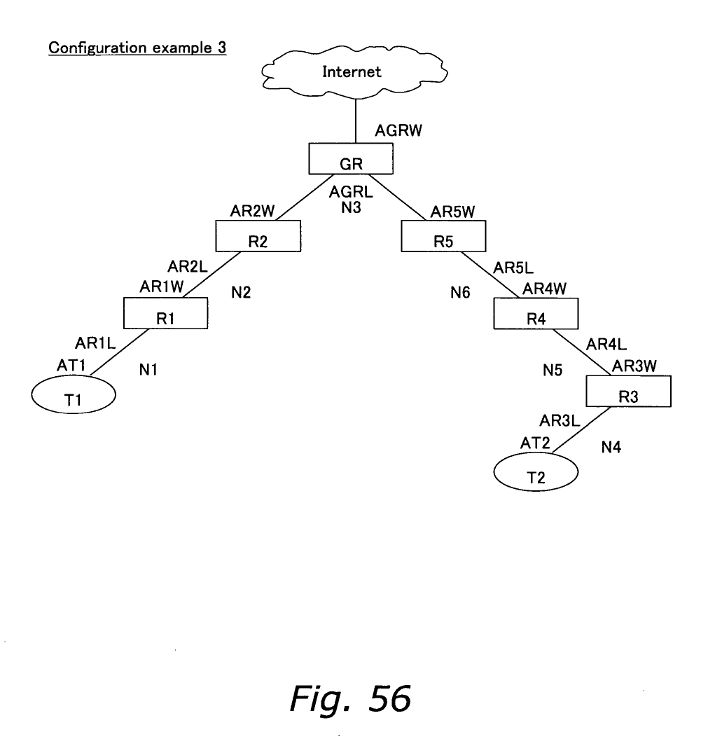

In the configuration example 3 in FIG. 56, the user terminal 1 acquires the WAN address (AGRW) of the router GR, WAN address (AR2W) of the router R2, and WAN address (AR1W) of the router R1 located between the Internet and the user terminal 1 itself. Meanwhile, the user terminal 2 acquires the WAN address (ARGW) of the router GR (GR), WAN address (AGRW) of a router R5 (R5), a WAN address (AR4W) of a router R4, and a WAN address (AR3W) of the router R3 located between the Internet and the user terminal 2 itself. The user terminal 1 (T1) notifies the user terminal 2 (T2) of the WAN address (AGRW) of the router GR (GR), the WAN address (AR2W) of the router R2, WAN address (AR1W) of the router R1, and its own address AT1 by address exchange message. The user terminal 2 (T2) notifies the user terminal 1 (T1) of the WAN address (AGRW) of the router GR (GR), WAN address (AR5W) of the router R5 (R5), WAN address (AR4W) of the router R4, WAN address (AR3W) of the router R3, and its own address AT2 by address information exchange message.

The P2P communication determination unit 713 of the user terminal 1 compares the WAN address of the highest router (GR) in its own configuration information and the WAN address of the highest router (GR) in the address information notified from the user terminal 2, and because the two match, the P2P communication determination unit 713 compares information of the subsequent routers. In the comparison of the subsequent router, the WAN address (AR2W) of the router R2 in its own configuration information comparison is compared with the WAN address (AR5W) of the router R5 notified from the user terminal 2, and it is detected that the two do not match. As a result, the P2P communication determination unit 713 determines that a communication path needs to be set for router R2 and subsequent routers, i.e., router R1.

The P2P communication determination unit 713 of the user terminal 2 similarly compares the WAN addresses of the router GR, and then compares the WAN addresses for the routers R5 and R2, detects that the two do not match, and determines that a communication path needs to be set for the router 5 and subsequent routers, i.e., routers R3 and R4.

(2-4) Configuration Example 4

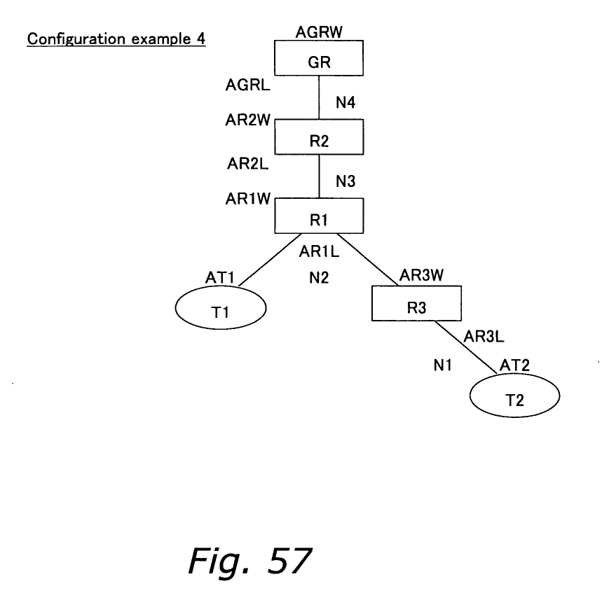

In the configuration example 4 in FIG. 57, the user terminal 1 acquires as home network configuration the WAN address (AGRW) of a router GR, WAN address (AR2W) of the router R2, and WAN address (AR1W) of the router R1, the foregoing all located between the Internet and the user terminal 1 itself. Meanwhile, the user terminal 2 acquires as home network configuration the WAN address (AGRW) of the router GR (GR), WAN address (AR2W) of router R2, WAN address (AR1W) of the router R1, and the WAN address (AR3W) of a router R3, the foregoing all located between the Internet and the user terminal 2 itself. The user terminal 1 (T1) notifies the user terminal 2 of the WAN address (AGRW) of the router GR (GR), WAN address (AR2W) of the router R2, WAN address (AR1W) of the router R1, and its own address AT1 by address exchange message. The user terminal 2 (T2) notifies the user terminal 1 of the WAN address (AGRW) of the router GR (GR), WAN address (AR2W) of the router R2, WAN address (AR1W) of the router R1, WAN address (AR3W) of the router R3, and its own address AT2 by address information exchange message.

The P2P communication determination unit 713 of the user terminal 1 compares the WAN address of the highest router (GR) in its own configuration information and the WAN address of the highest router (GR) in the address information notified from the user terminal 2, and because the two match, the P2P communication determination unit 713 compares the WAN addresses of the R2 that is the subsequent router, i.e., router R2. Because this information matches as well, the WAN addresses of the subsequent router, i.e., router R1, are compared. Because these match, the subsequent router is to be compared. However, because there is no subsequent router in its own configuration information, determination is made that a communication path does not need to be set. Based on this determination, the communication path setting unit 714 notifies the user terminal 1 of the IP address of the user terminal itself and port number for P2P communications as access destination information.

Because the WAN addresses of the router GR similarly match, the P2P communication determination unit 713 compares the WAN addresses of the router R2, and WAN addresses of the router R1 in such order. It then attempts to compare the WAN addresses of the subsequent router. However, while a subsequent router (R3) exists in its own configuration information, there is no information of a subsequent router in the address information notified from the user terminal 1; thus determination is made that a communication path to the router R3 needs to be set. Based on this determination, the communication path setting unit 714 executes router R3 path settings and notifies the user terminal 1 of the IP address and port number of the router R3 for which NAT settings have been made as access destination information.

(2-5) Configuration Example 5

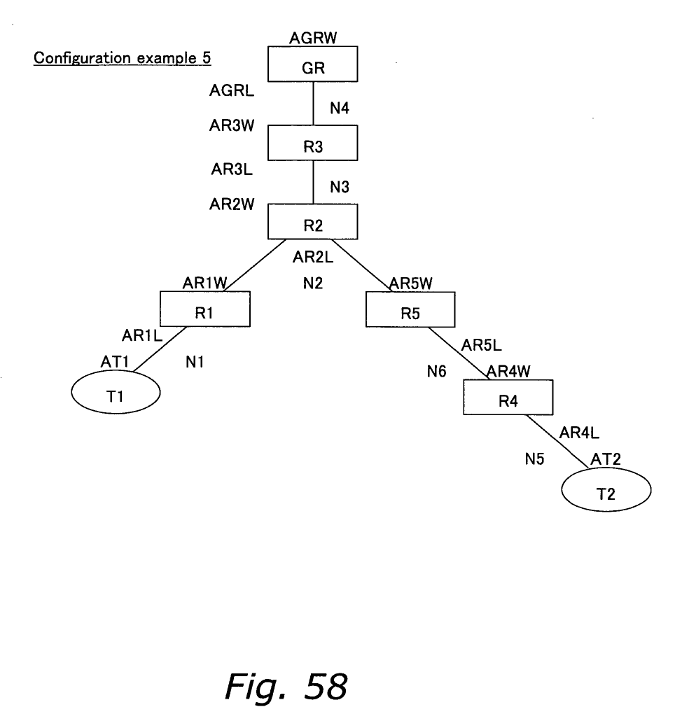

In the configuration example 5 in FIG. 58, the user terminal 1 acquires as home network configuration the WAN address (AGRW) of the router GR (GR), WAN address (AR3W) of the router R3, WAN address (AR2W) of the router R2, and WAN address (AR1W) of the router R1, the foregoing all located between the Internet and the user terminal 1 itself. Meanwhile, the user terminal 2 acquires as home network configuration the WAN address (AGRW) of the router GR (GR), WAN address (AG3W) of the router R3 (R3), WAN address (AR2W) of the router R2, WAN address (AR5W) of the router R5, and WAN address (AR4W) of a router R4, the foregoing all located between the Internet and the user terminal 2 itself. The user terminal 1 (T1) notifies the user terminal 2 of the WAN address (AGRW) of the router GR (GR), WAN address (AR3W) of the router R3, WAN address (AR2W) of the router R2, WAN address (AR1W) of the router R1, and its own address AT1 by address exchange message. Further, the user terminal 2 (T2) notifies the user terminal 1 of the WAN address (AGRW) of the router GR (GR), WAN address (AR3W) of the router R3, WAN address (AR2W) of the router R2, WAN address (AR5W) of the router R5, WAN address (AR4W) of the router R4, and its own address AT2 by address information exchange message.

The P2P communication determination unit 713 of the user terminal 1 compares the WAN address of the highest router (GR) in its own configuration information and the WAN address of the highest router (GR) in the address information notified from the user terminal 2, and because the two match, the P2P communication determination unit 713 compares the WAN addresses of the subsequent router, i.e., router R3. Because this information matches as well, the WAN addresses of the subsequent router, i.e., router R2 is compared. Because this information matches as well, information of the subsequent router is compared, and in the comparison of the WAN address (AR1W) of the router R1 and the WAN address (AR5W) of the router 5 non-match is detected. As a result, the P2P communication determination unit 713 of the user terminal 1 determines that a communication path to the router R1 needs to be set. Based on this determination, the communication path setting unit 714 executes router R1 path settings, and notifies the user terminal 2 of an IP address and port number of the router R1 for which NAT settings have been made as access destination information.

Further, the P2P communication determination unit 713 of the user terminal 2 similarly compares the WAN addresses of the highest router (GR), the WAN addresses of the router R3, and the WAN addresses of the router R2 in this order; when it compares the WAN address (AR5W) of the router R5 and WAN address (AR1W) of the router R1, non-match is detected. As a result, the P2P communication determination unit 713 of the user terminal 2 determines that a communication path needs to be set to the routers R5 and subsequent routers, i.e., router R4. Based on this determination, the communication path setting unit 714 executes path setting to the routers R5 and R4, and notifies the user terminal 1 of the IP address and port number of the router R5 for which NAT settings have been made as access destination information.

Address Information Transmitted through Address Information Exchange

Next, an explanation will be given of another example of address information transmitted through address information exchange. As address information transmitted through address information exchange, as shown in FIG. 45, own user terminal address is included. Alternatively, own terminal address is not included, and confirmation of whether address spaces match when under control of the same router is made when access destination information message is acquired.

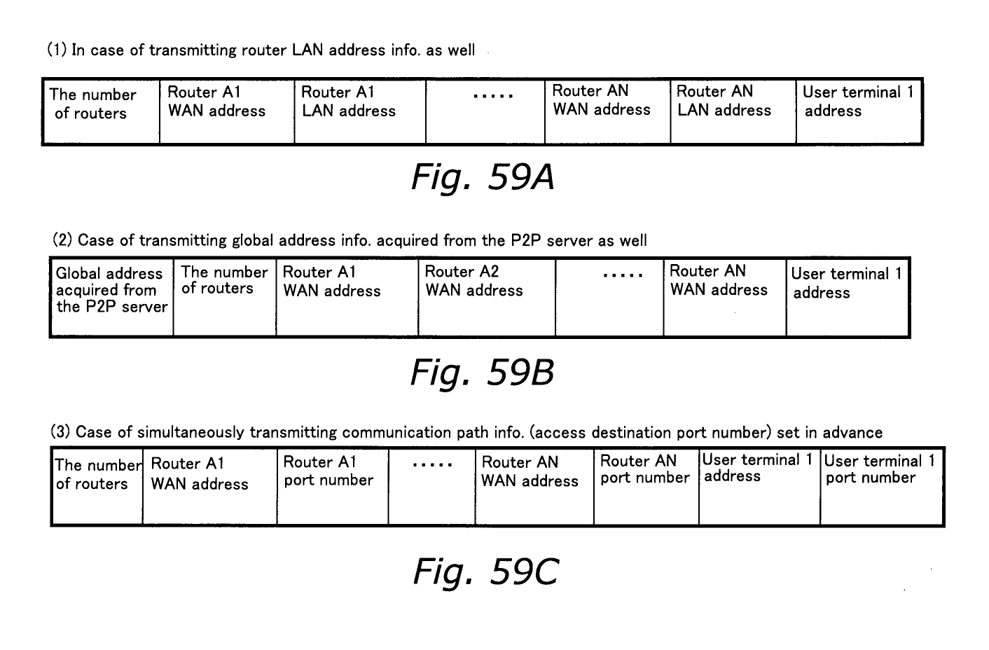

Alternatively, as shown in FIG. 59(a), router LAN address is transmitted simultaneously with an address information message, and for routers for which a WAN address has not been acquired, substitution is made by comparison with LAN address. However, match of the addresses in this case does not always mean the same router.

Further, in the address information exchange, router WAN address information is transmitted. The router WAN address information is information for identifying the router, and may be a router identification number or the like (e.g., UUID under UPnP) acquired using other protocols.

Alternatively, as shown in FIG. 59(b), a global address allocated to a user terminal is acquired using a P2P server, and notification of the same is given as address information together with the address information message. With such a configuration, before the P2P communication determination unit 713 compares the WAN addresses for the routers in order, comparison is first made for this global address. This prevents the P2P communication determination unit 713 from making mistaken determinations because the WAN address of the true highest router was not acquired.

A possible method for acquiring the global address allocated to a user terminal using a P2P server may be, for example, transmission of a message requesting global address acquisition from the user terminal to the P2P server, and transmission by the P2P server, having received this message, of a response message in which source address of the message (IP address, port number) is payload data.

Alternatively, as shown in FIG. 59(c), settings for a communication path to the highest router are made in advance, at time of turning ON a user terminal, and such settings are transmitted together with information (port number for which NAT settings have been made) of the communication path set for each router together at time of address information exchange. With such a configuration, when the P2P communication determination unit 713 determines a router for which a communication path needs to be set, because access destination is also known, no exchange phase of access destination information is needed, allowing for a high speed operation.

Effects

With this communication device, router configuration can be learned even in a network comprising routers in multiple stages, allowing communication path settings such as NAT and firewall settings. By setting a communication path in this manner, even when one or both communication devices are connected via multiple routers in their home network, P2P communication can be made between the communication devices.

### EIGHTH EMBODIMENT

### Making Communication Equipment Settings

An eighth embodiment of the present invention will be explained with reference to the drawings.

Overall Constitution

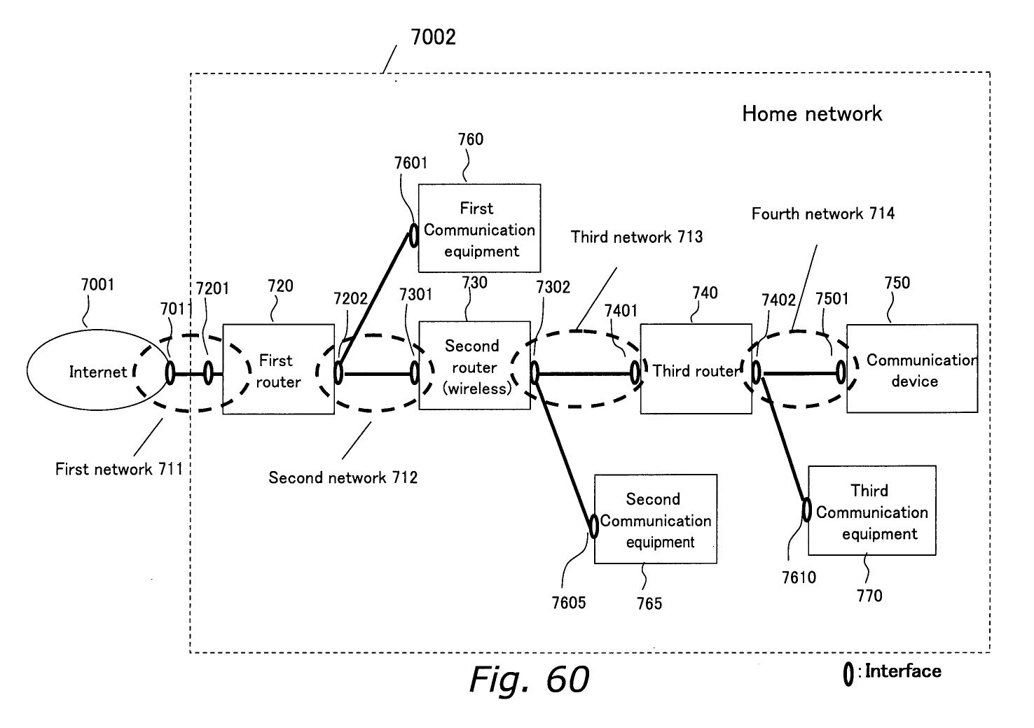

FIG. 60 shows the constitution of a home network relating to an eighth embodiment of the present invention. In a home network 7002, a plurality of routers are connected in multiple stages. A communication device 750 functions as a network configuration detection device for detecting home network state.

In FIG. 60, an Internet 7001 and home network 7002 are connected to each other. The home network 7002 comprises a first router 720, second router 730, and third router 740 connected in multiple stages, and has connected thereto the communication device 750 functioning as a network configuration detection device under the third router 740. Further, the first router 720 is connected to the Internet 7001 via the WAN side communication interface 7201, and is connected to the second router 730 via a LAN side communication interface 7202 and a first communication equipment 760 having a communication function. The LAN side communication interface 7202 of the first router 720, together with the WAN side communication interface 7301 of the second router 730 and the WAN side communication interface 7601 of the first communication equipment 760, constitutes a network with the same hierarchy level.

The second router 730 is connected to the first router 720 via the WAN side communication interface 7301, and is connected to the third router 740 and second communication equipment 765 via the LAN side communication interface 7302. The LAN side communication interface 7302 of the second router 730, the WAN side communication interface 7401 of the third router 740, and the WAN side communication interface 7605 of the second communication equipment 765 constitute a network with the same hierarchy level.

The third router 740 is connected to the second router 730 via the WAN side communication interface 7401, and via the LAN side communication interface 7402 is connected to the communication device 750 and the third communication equipment 770 having a communication function. The LAN side communication interface 7402 of the third router 740, WAN side communication interface 7501 of the communication device 750, the WAN side communication interface 7610 of the third communication equipment 770 constitute a network with the same hierarchy level.

Here, a wireless LAN network may be included; for example, if a wireless LAN interface is included as the LAN side communication interface 7302 of the second router 730, the connection between the second communication equipment 765 and second router 730 may be via a wireless LAN.

Communication Device Configuration

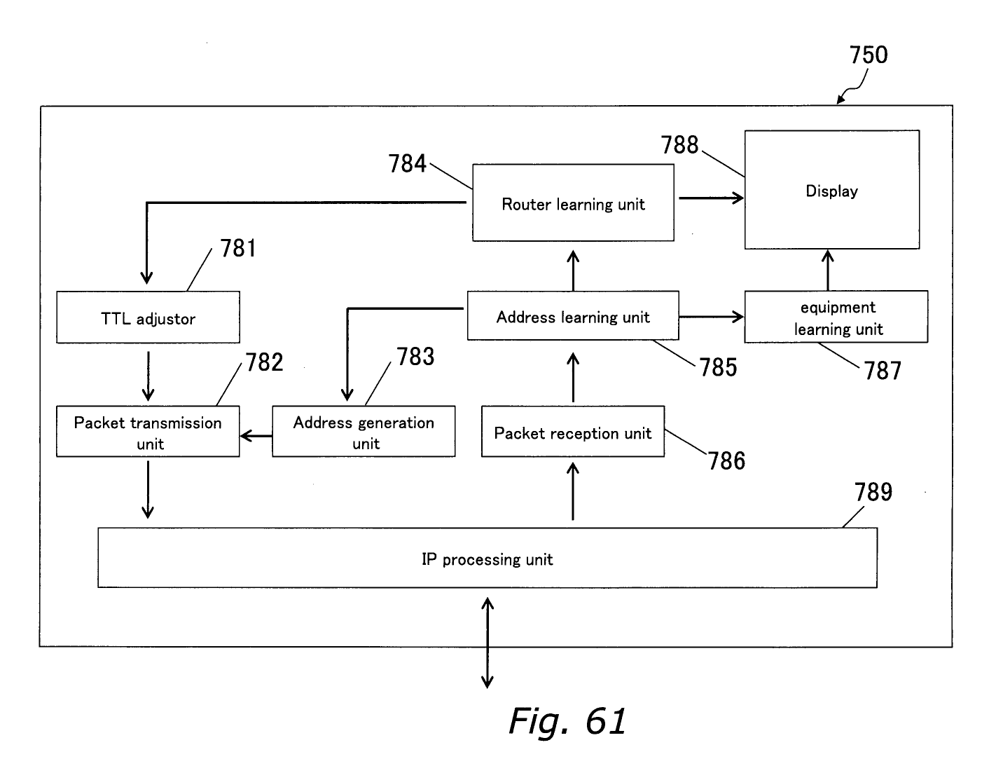

FIG. 61 is a functional block diagram showing the configuration of the communication device 750. The communication device 750 comprises a TTL adjuster 781, packet transmission unit 782, address generation unit 783, router learning unit 784, address learning unit 785, packet reception unit 786, equipment learning unit 787, display 788, and IP processing unit 789.

The TTL adjuster 781, to detect routers in the network, first prepares ICMP search packets while adjusting the TTL value. Here, to detect the routers in the home network, search packets are generated while adjusting the TTL value in the range from 1 to 3. The packet transmission unit 782 transmits a generated search packet to an address destination suitably set (e.g., an address on the Internet) via the IP processing unit 789. Here, search packets include router discovery packets for discovering routers, and equipment discovery packets for discovering a communication equipment connected to a router.

The packet reception unit 786 receives a response packet in response to a search packet transmitted from the packet transmission unit 782 via the IP processing unit 789.

The address learning unit 785 receives response packets received by the packet reception unit 786, and based on the response packets, extracts addresses for the routers and communication equipments in the home network. The address learning unit 785 transmits router addresses to the router learning unit 784 and communication equipment addresses to the equipment learning unit 787.

The address generation unit 783, based on router and communication equipment addresses extracted by the address learning unit 785, generates a packet destination address.

The router learning unit 784 learns information relating to a router based on acquired router address. Similarly, the equipment learning unit 787 learns property information relating to a communication equipment based on acquired communication equipment address. Here, the equipment learning unit 787 uses SNMP (Simple Network Management Protocol) or the like to refer to MIB (Management Information Base) information to make determination of a communication equipment.

The display 788 displays information of a router detected by the router learning unit 784 and information of a communication equipment detected by the equipment learning unit 787.

Process Flow

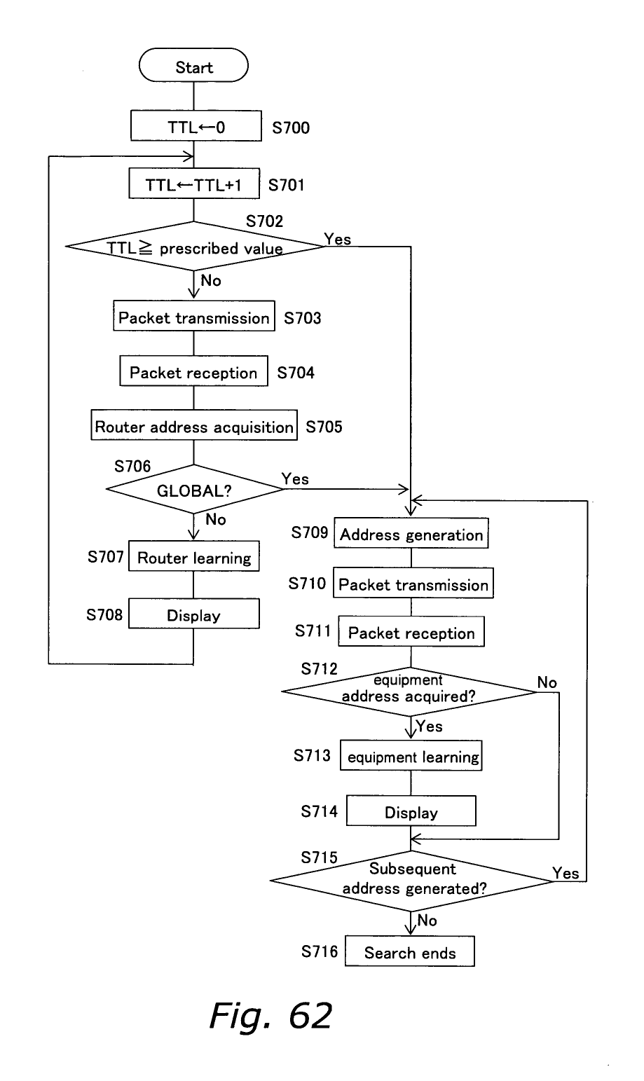

An explanation will be given below of operations of the communication device 750 connected to the home network 7002 thus configured. FIG. 62 is an example of a flowchart showing operations of the communication device 750.

(1) Learning and Displaying Routers

First, processing for learning and displaying routers will be explained.

In steps S700, S701, when this processing starts, the TTL adjustor 781 of the communication device 750 initializes the TTL value (S700), and then increments the same (S701). The TTL is a value so set as to prevent a transmission packet from entering into an infinite loop through setting error. Setting TTL indicates a packet's term of validity.

In step S702, the TTL adjustor 781 determines whether the TTL value exceeds a prescribed value. If the TTL adjustor 781 determines that the TTL is at or below a prescribed value, control proceeds to step S703. If the TTL adjustor 781 determines that the TTL value exceeds the prescribed value, router detection processing ends and control proceeds to step S709.

If in step S702 the TTL value does not exceed the prescribed value set in advance, in step S703, the packet transmission unit 782 transmits a search packet to detect a router via the IP processing unit 789. If a router that received such a search packet decrements the TTL value thereof to “0” when giving the packet passage, such router sends a Time Exceeded message packet to the source.

In steps S704, S705, the packet reception unit 786 of the communication device 750 receives the response packet returned by the router (S704). The address learning unit 785 analyzes the response packet received by the packet reception unit 786 to acquire the LAN address of the router that transmitted the response packet.

In step S706, the address learning unit 785 determines whether the acquired LAN address of the router is a global address or local address.

In steps S707, S708, when determination is made that the router LAN address is a local address, the address leaning unit 785 recognizes the router as a router existing on a network. The router learning unit 784 accesses the router to acquire router information (S707). The router learning unit 784 outputs information of a network router to the display 788, and the display 788 displays the router on the screen (S708). Here, based on the acquired LAN address of the router, the address learning unit 785 transmits to the relevant router an acquisition request packet for acquiring the router's WAN address. The address learning unit 785 receives a response packet from this router and acquires the WAN address, thus learning the router. Here, the router learning unit 784 can use SNMP or other protocol to refer to MIB information to make determination of the equipment.

Thereafter, control returns to step S701, and the TTL adjustor 781 increments the TTL value. Control repeats search packet transmission and response packet receipt to learn the routers in the network.

(2) Learning and Displaying Communication Equipment

Next, the processing for learning and displaying a communication equipment will be explained.

In step S709, when determination is made that acquired router LAN address is a global address, the address learning unit 785 recognizes this router to be a router on the Internet outside the home network. The address learning unit 785 instructs the address generation unit 782 to stop generating addresses for router search, thus stopping the router search processing. Meanwhile, the address learning unit 785 instructs the address generation unit 782 to generate an address for searching for a communication equipment connected to the router.

The address generation unit 782 generates an address of the communication equipment subject to search based on the router LAN address acquired by the address learning unit 785. The addresses used in the home network are in various classes (class A, class B, and class C); taking class C as an example, the lowest 8 bits of an acquired router LAN address are changed within the range of 1 to 254, to conjecture the address of a communication equipment connected to the router. Therefore, the address generation unit 783 conjectures and generates an address of the communication equipment based on acquired router LAN address.

When a network has address classes other than class C, i.e., class A and class B, communication equipment addresses can be conjectured in a manner suitable to such classes.

In step S710, the packet transmission unit 782 generates and transmits a search packet for detecting a communication equipment with the address generated by the address generation unit 783 as a destination.

When there exists a communication equipment corresponding to the search packet transmitted by the packet transmission unit 782 in the home network 7002, the corresponding communication equipment transmits a response packet in response to the search packet. Therefore, the packet reception unit 786 receives the response packet from the communication equipment and the address learning unit 785 acquires the communication equipment address from the response packet. In addition to ICMP packets, an ARP (Address Resolution Protocol) packet for requesting a network address in the physical layer from the IP address may be used as a packet for finding a communication equipment.

In steps S711, S712, the packet reception unit 786 receives the response packet in response to the transmitted search packet from the communication equipment (S711). Next, the address learning unit 785 determines whether the communication equipment address has been acquired from the response packet (S712). If the equipment address has been acquired, control proceeds to step S713, and if it has not been acquired, control proceeds to step S715.

In step S713, the equipment learning unit 787 acquires communication equipment information relating to the communication equipment based on the acquired communication equipment address.

In step S714, the equipment learning unit 787 outputs the acquired communication equipment information to the display 788, and the display 788 displays the communication equipment information.

In steps S715, S716, the address learning unit 785 determines whether to generate an address for a subsequent search packet (S715). Here, if determination has been made that all addresses conjectured to be addresses of communication equipments under the router have been searched, search is ended (S716). On the other hand, the address learning unit 785 instructs the address generation unit 783 to generate a subsequent address if a further address is to be generated and searched. Upon such instruction, the address generation unit 783 generates an address (S709). Thus communication equipment search is continued.

With such a configuration, the communication device 750, by transmitting to routers search packets in which the TTL value has been changed, acquires the addresses of the LAN side communication interface 7402 of the third router 740, of the LAN side communication interface 7302 of the second router 730, and of the LAN side communication interface 7202 of the first router 720 (FIG. 60).

Acquisition of Router Address

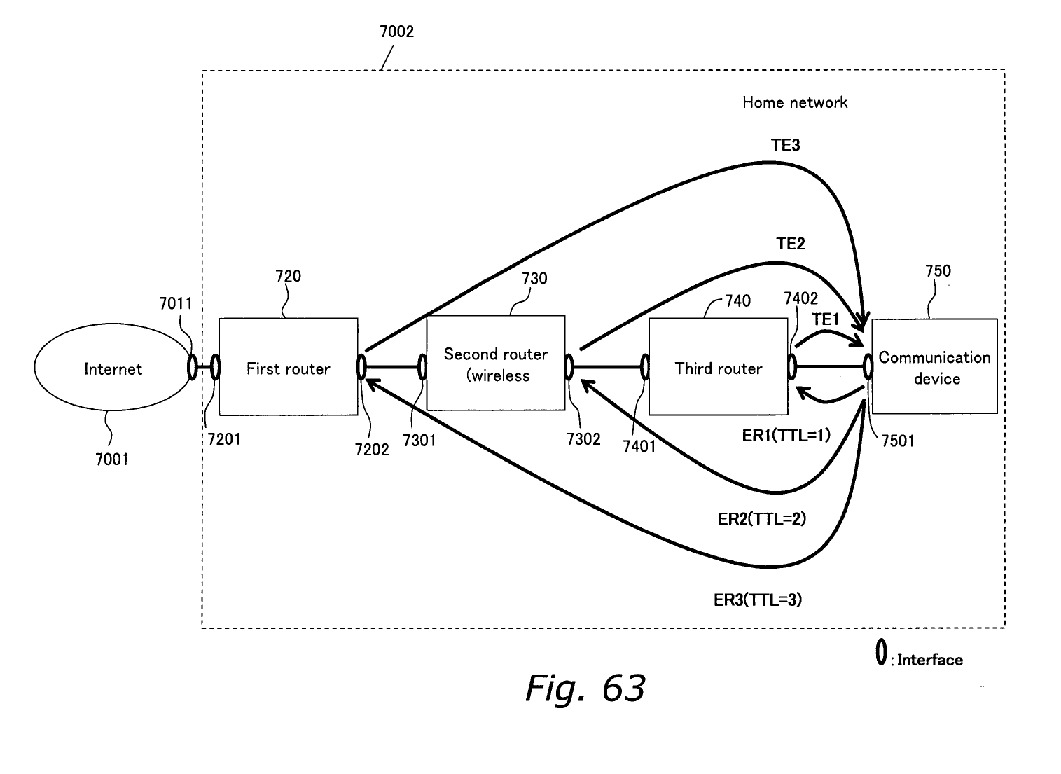

An explanation will be given of a method for acquiring router configuration in such a network with reference to FIG. 63. FIG. 63 is a diagram for explaining a method for router detection.

For example, when an ICMP Echo Request message packet ER1 in which TTL=1 is transmitted from the communication device 750, the TTL becomes 0 at time of passage through the third router 740. The third router 740 sends as a reply the ICMP Time Exceeded message packet TE1 to the communication device 750 that was the source.

Next, when ICMP Echo Request message packets ER2 and ER3 in which the TTL has been set at 2 and 3 respectively are transmitted from the communication device 750, the message packets ER2 and ER3 reach the second router 730 and first router 720 respectively. The second router 730 and first router 720 respectively reply to the communication device 750 with ICMP Time Exceeded message packets TE2 and TE3.

Alternatively, a plurality of ICMP Echo Request message packets with differing TTL can be simultaneously transmitted in parallel from the communication device 750. For example, three ICMP Echo Request message packets ER1 through ER3 with TTL at 1 through 3 respectively are simultaneously transmitted in parallel from the communication device 750. In this case, the packet ER1 in which TTL=1 arrives at the third router 740, the packet ER2 in which TTL=2 arrives at the second router 730, and the packet ER3 in which TTL=3 arrives at the first router 720. Thus ICMP Time Exceeded message packets TE1 through TE3 from the respective routers are sent as replies to the communication device 750.

The source address of the response packet TE sent from a router in reply to an ICMP Echo Request message packet ER transmitted from the communication device 750 indicates a router's LAN address.

Here, the source address of the response packet TE1 with respect to the ICMP Echo Request message packet ER1 transmitted from the communication device 750 in which TTL=1 serves as the LAN address of the third router 740. Similarly, the source addresses of the response packets TE2 and TE3 serve as the LAN addresses respectively of the second router 730 and first router 720. With such a constitution, the LAN addresses for the routers in the network can be learned.

Here, when a plurality of ICMP Echo Request message packets are to be simultaneously transmitted, the communication device 750 prepares packets by incrementing both TTL value and sequence number, and then transmits the prepared ICMP Echo Requests. The communication device 750 receives an ICMP Time Exceeded Message packet transmitted from the router, and uses the ICMP Echo Request message sequence number contained in the received packet to specify the TTL value designated at time of transmission.

Acquisition of Communication Equipment Addresses

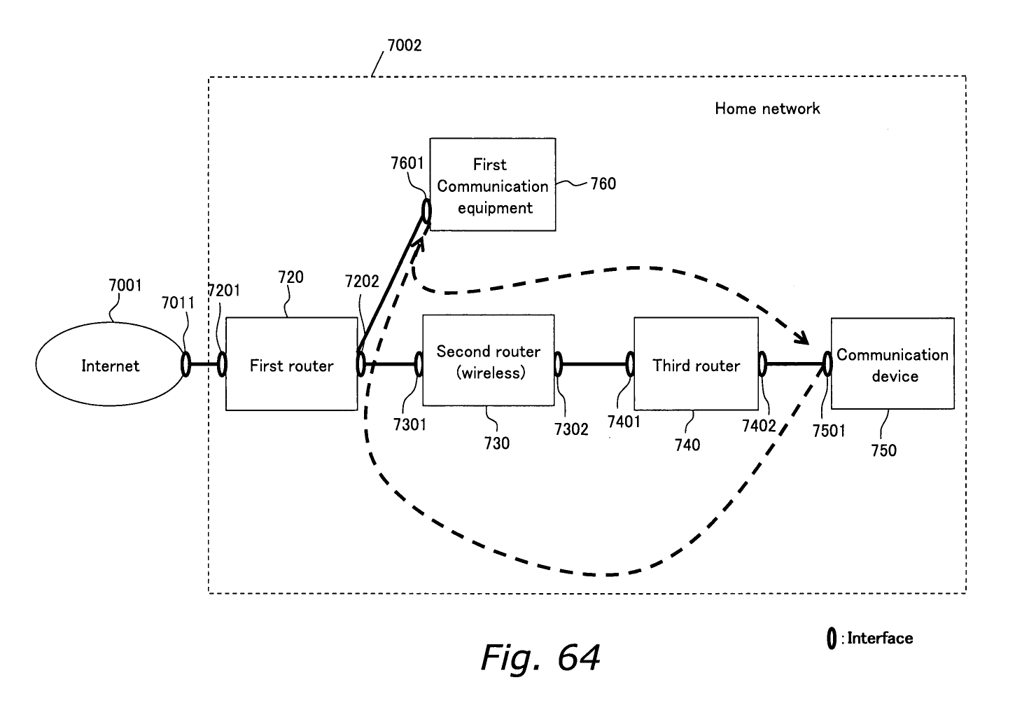

An explanation will be given of a method for acquiring communication equipment configuration in a network with reference to FIGS. 60 and 64. FIG. 64 is a diagram for explaining a method for detecting communication equipments connected to a router. FIG. 64 shows only a method for detecting the first communication equipment.

In a home network, various addresses (class A, class B, and class C) are used. For example, as an example of a case where class C addresses are used, an explanation will be given with reference to FIG. 64 of a method for detecting the address of a communication equipment connected to a router based on that router's LAN.

The address generation unit 783 of the communication device 750, using the method shown in FIG. 63, conjectures an address of a communication equipment connected to the router based on the LAN address of the router. For example, if the acquired router LAN address is a class C address, the address generation unit 783 changes the lowest 8 bits of the LAN address from 1 to 254 to conjecture and generate addresses of communication equipments that might be connected to the router. For example, an address is conjectured as described below.

As shown in FIGS. 60 and 64, the connection relationship between the first router 720 and Internet 7001 shall be a first network 711, the LAN side network of the first router 720 shall be a second network 712, the LAN side network of the second router 730 shall be a third network 713, and the LAN side network of the third router 740 shall be a fourth network 714.

The address of the first communication equipment 760 connected to the second network 712 is the same class as that of the LAN address of the first router 720. Further, the address of the communication equipment should be an address set by changing the lowest bits other than the net mask set for such address class. When the LAN address of the first router 720 is a class C address, addresses in which lowest 8 bits are changed in the range from 1 through 254 are generated. Thus the address of the first communication equipment 760 present in the second network 712 will be included. An ICMP Echo Request message packet is transmitted from the communication device 750 to an address thus generated. If the generated address is an address of the first communication equipment 760 present in the second network 712, the first communication equipment 760 properly replies with an ICMP Echo Reply message packet as a response packet. Thus this address can be identified as the address of the first communication equipment 760. Communication equipment addresses may be generated classes other than class C, i.e., class A or class B.

When the address of a communication equipment has been identified, the communication device 750 accesses the communication equipment with the identified address using SNMP or the like, and acquires property information of the communication equipment. Here, the property information indicates information related to a equipment such as equipment location, user friendly name, equipment conditions, icon state, model number and the like.

SNMP was used for acquiring property information of the communication equipment; alternatively, UPnP (Universal Plug and Play) may be used to acquire property information through device description or action requests.

If there is no ICMP Echo Reply message response in response to an ICMP Echo Request message packet transmitted from the communication device 750, the address is changed, and an ICMP Echo Request message packet is transmitted in the same manner.

Further, even if upon transmission of an ICMP Echo Request message packet from the communication device 750, address resolution fails and a message packet is not transmitted normally, the address is changed and the ICMP Echo Request message packet is transmitted.

Further, an explanation was given for a case where based on instructions from the address learning unit 785, the address generation unit 783 sequentially generates addresses, and the packet transmission unit 782 sequentially makes transmission. Alternatively, the address generation unit 783 may generate a plurality of addresses at once, and the packet transmission unit 782 simultaneously transmits search packets to the generated plurality of addresses. For example, when the LAN address of the first router 720 is class C, the address generation unit 783 generates an address in which the lowest 8 bits have been changed within the range of 1 through 254, and the packet transmission unit 782 transmits search packets to the generated addresses at once.

### Specific Example

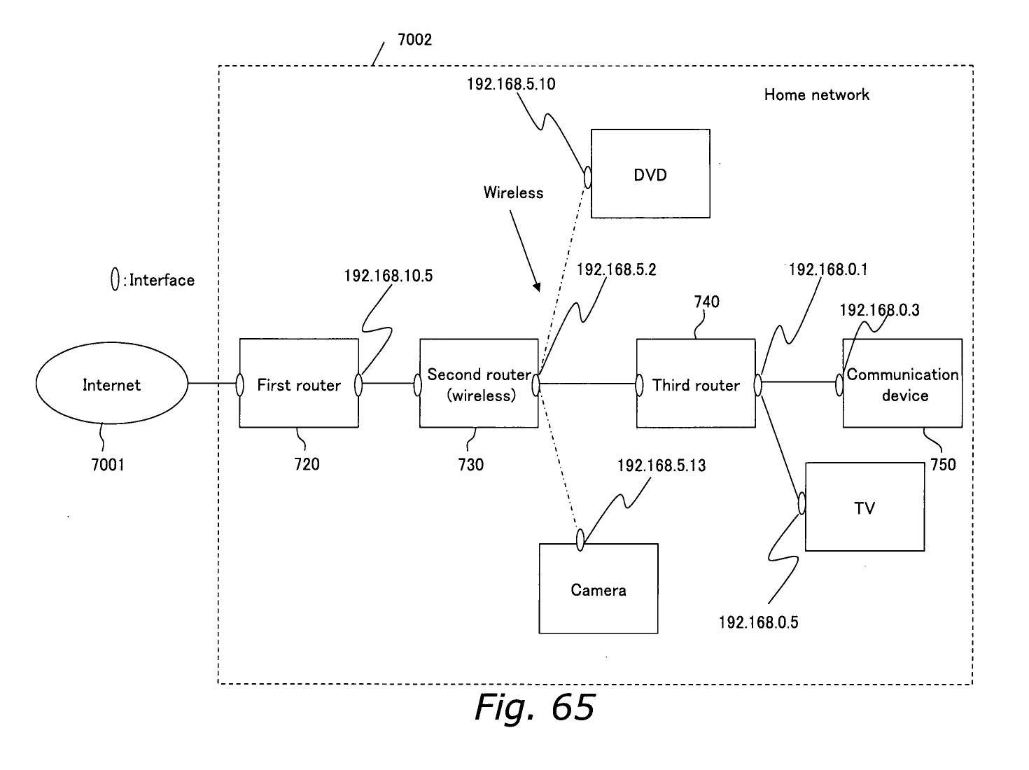

FIG. 65 is a diagram for explaining a specific configuration example of the home network. In the home network, the first, second and third routers 720, 730 and 740 are connected in multiple stages. Further, the second router 730 has connected thereto a DVD and camera, both having a communication function. The third router 740 has connected thereto a TV having a communication function.

The communication device 750, upon acquiring the LAN address of the third router 740, “192.168.0.1,” conjectures the address of a communication equipment connected to the third router 740 and transmits the search packet. The communication device 750 acquires communication equipment address “192.168.0.5” from the response packet transmitted from the TV. The communication device 750 transmits a packet requesting equipment information to the communication equipment address and receives a response packet. Thus equipment information to the effect that the communication equipment is a TV is acquired.

Further, the communication device 750, upon acquiring the LAN address of the second router 730 “192.168.5.2,” conjectures addresses of communication equipments connected to the second router 730 and transmits the search packets. The communication device 750 receives response packets from communication equipments, thereby acquiring the respective addresses “192.168.5.10” and “192.168.5.13.” Further, the communication device 750 can transmit request packets to the communication equipment addresses, thus acquiring the equipment information of each. As a result, the communication device 750 can acquire equipment information to the effect that the communication equipments connected to the second router 730 are a DVD recorder and camera. Similarly, the communication device 750 can acquire addresses and equipment information of the communication equipments connected under the first router 720.

Further, the communication device 750, upon detecting the global address of the interface 7011 by which the first router 720 is connected to the Internet, stops the router search. With such a configuration, the communication device 750 detects network configuration only of the home network.

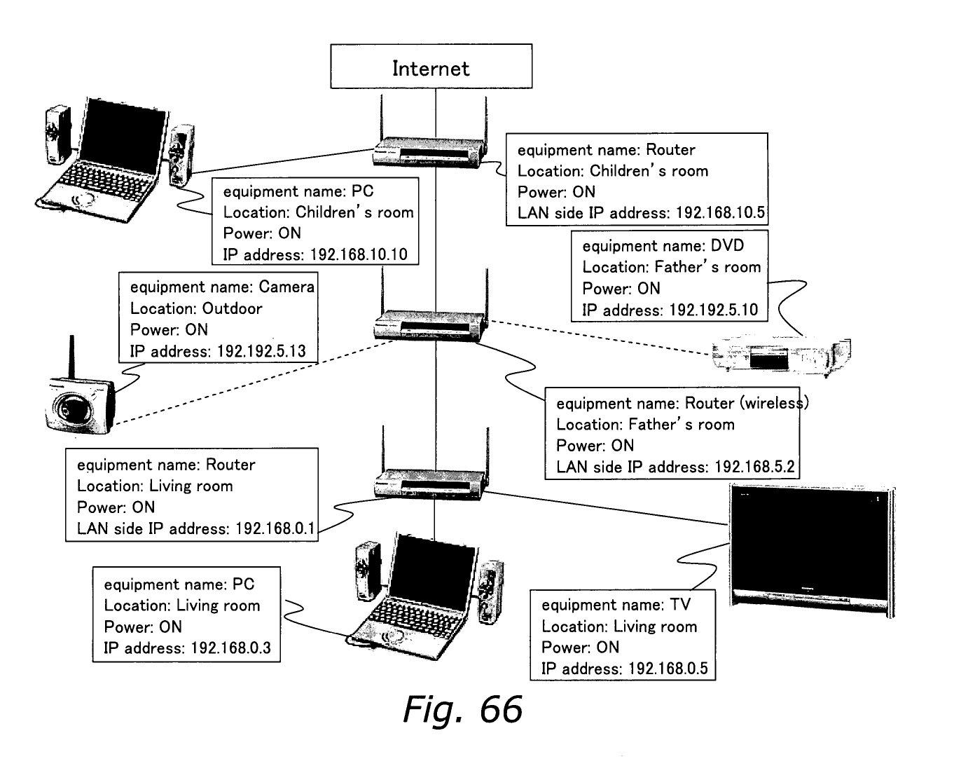

The communication device 750 displays the router and communication equipment information thus obtained on a screen, enabling a user to learn network configuration even in a network comprising routers in multiple stages. FIG. 66 shows one example of a network configuration displayed by the communication device display. As shown in FIG. 66, the connection configuration for routers and communication equipments is shown on the display screen. Further, with respect to the routers, place of installation, power ON/OFF state, and LAN side IP address are shown. Further, with respect to the communication equipments, place of installation, power ON/OFF state, and LAN side IP address are shown.

This embodiment may be configured so that, with regard to the processing for ICMP Echo Request message packets in FIG. 62, a plurality of ICMP Echo Request message packets are simultaneously transmitted to learn router LAN address.

While in the present embodiment, packets are processed one at a time, even an equipment search packet, it will be obvious that a plurality of equipment search packets can be simultaneously transmitted, and responses from equipments be awaited.

To detect routers, ICMP packets were used. Alternatively, UDP may be used. In case of using a UDP, by changing TTL and destination address or port number, control similar to ICMP can be attained.

Effects

As described above, the communication device transmits router discovery packets in which the TTL is a variable to acquire router addresses of routers in the home network. Further, the communication device transmits packets for searching communication equipments based on these router addresses to acquire addresses of communication equipments connected to a router. Further, by displaying the information acquired from accessing these routers and communication equipments, a user can learn the network configuration even for a home network comprising multiple routers.

### NINTH EMBODIMENT

The ninth embodiment of the present invention will be explained with reference to the drawings.

Overall Constitution

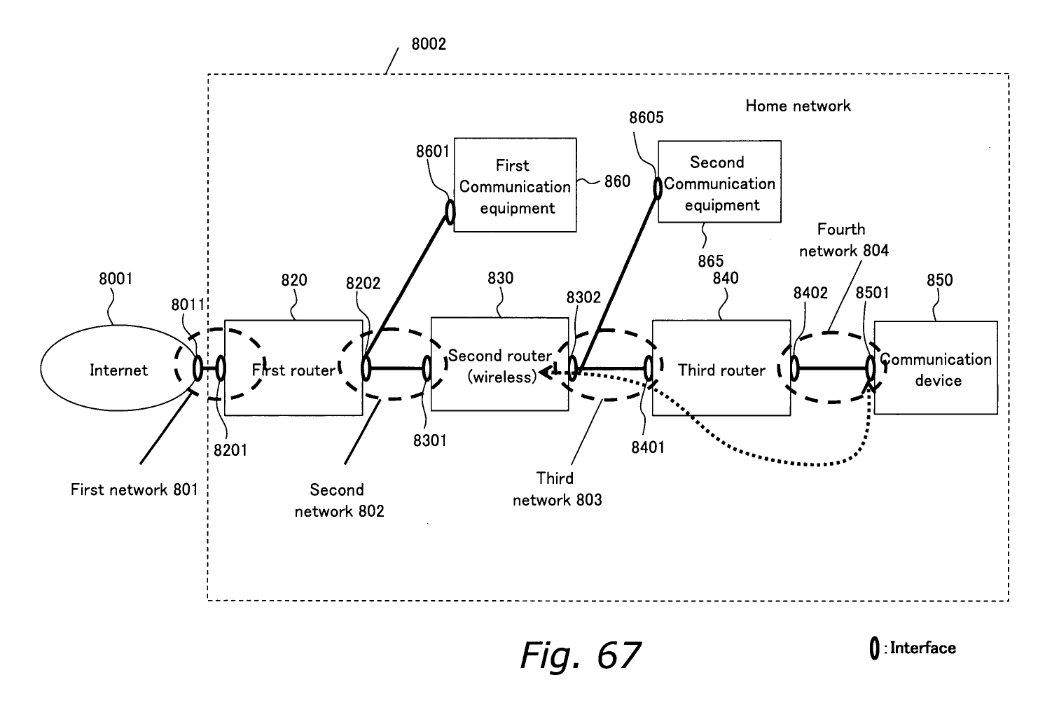

FIG. 67 is a block diagram showing the overall constitution of devices according to a ninth embodiment of the present invention; it shows the configuration of a network connected by multiple routers.

In FIG. 67, an Internet 8001 and home network 8002 are connected to each other. The home network 8002 comprises a first router 820, second router 830, and third router 840 in multiple stages, and a communication device 850 functioning as a network configuration detection device is connected under the third router 840. Further, the first router 820 has connected thereto a first communication equipment 860, and the second router 820 has connected thereto a second communication equipment 865. Here, the routers and communication equipments are connected to one another via LAN side interface communications and WAN side interface communications 8201, 8202, 8301, 8302, 8401, 8402, 8501, 8601 and 8605.

Communication Device Configuration

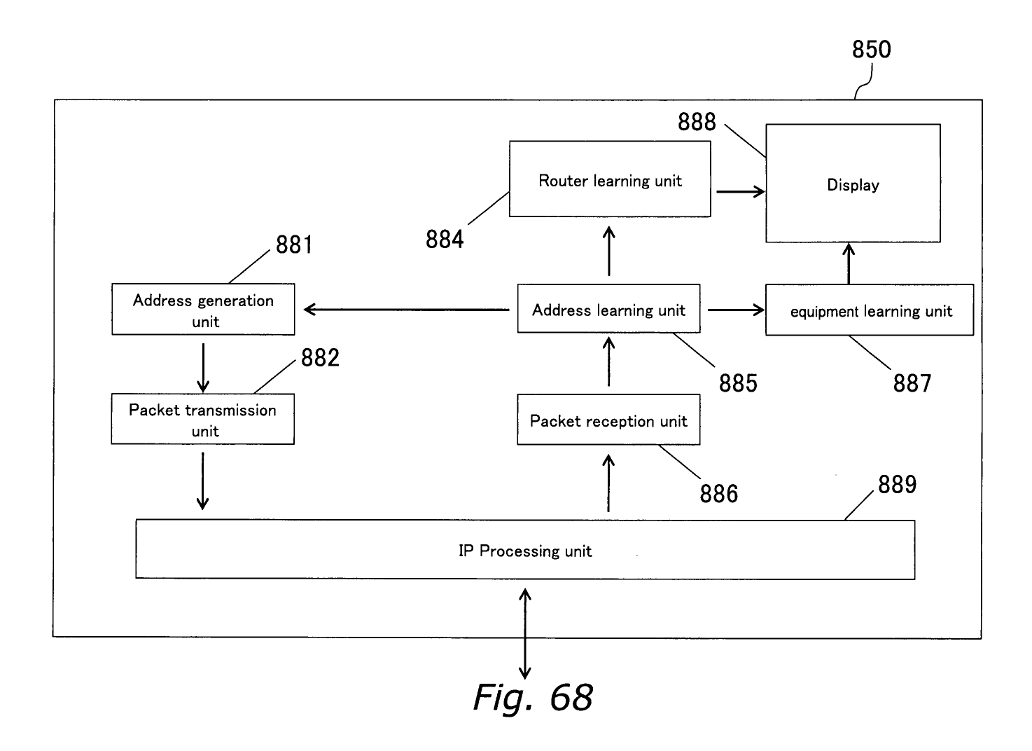

FIG. 68 is a functional block diagram showing communication device configuration. The communication device 750 is constituted by a standard computer, and constitutes a network configuration detection device by running on RAM a program, for example, for a network configuration detection method.

The communication device 750 comprises an address generation unit 881, packet transmission unit 882, packet reception unit 886, address learning unit 885, router learning unit 884, display 888, equipment learning unit 887, and IP processing unit 889.

Processing Flow

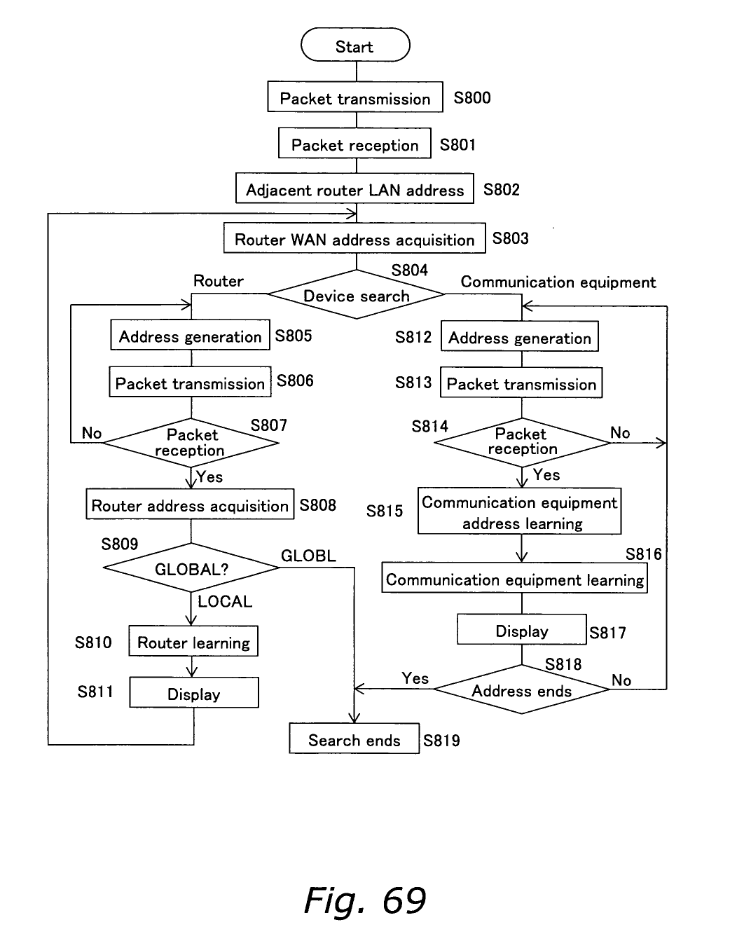

An explanation will be given below of operations of the communication device 850 connected to the home network 8002 thus configured. FIG. 69 is one example of a flowchart showing operations of the communication device 750.

(1) Learning and Displaying Routers

First, processing for learning and displaying routers will be explained.

In steps S800 though S802, to learn the LAN address of the directly connected router, the packet transmission unit 882 of the communication device 850 transmits a packet for router search (S800). The packet reception unit 886 receives a response packet in response to the transmitted packet (S801). The address learning unit 885 acquires the LAN address of the router from the response packet (S802).

In step S803, the address learning unit 885 acquires the LAN address, and acquires the WAN address of the router from the LAN address.

In step S804, the address learning unit 885 determines whether to search for a router existing on the network or for communication equipments connected under the router.

In step S805, when a router is to be searched for, based on the router WAN address, the address generation unit 881 conjectures and generates the LAN address of a higher level router located more toward the WAN address. Here, address classes used in the home network include class A, class B, and class C. When class C addresses are used, the lowest 8 bits of the router WAN address are changed within the range of 1 through 254, thus conjecturing and generating LAN addresses of a higher level router.

In step S806, to learn the LAN address of the higher level router, the packet transmission unit 882 transmits a search packet for router search to the address prepared by the address generation unit 881. Here, regarding the packet for router search, an M-SEARCH can be transmitted in unicast mode to the prepared address as a UPnP equipment search packet.

In step S807, if there is no response from the router for a certain period of time after search packet transmission, the packet reception unit 886 determines that no router exists at the prepared address. The address generation unit 881 then generates another address (S805) and the packet transmission unit 882 transmits a search packet to such generated address (S806).

In step S808, the packet reception unit 886, upon receiving a response packet, delivers the received response packet to the address learning unit 885. The address learning unit 885 acquires the LAN address of the router from the response packet.

The address generation unit 881, packet transmission unit 882, address learning unit 885 and the like repeatedly execute their respective tasks until the router being searched for is detected.

In step S809, the address learning unit 885 determines whether an acquired router LAN address is a global address or local address. When determination is made that the acquired router LAN address is a global address, the address learning unit 885 ends the search.

In step S810, when determination is made that the router LAN address acquired by the address learning unit 885 is a local address, the router learning unit 884 acquires router information based on this LAN address and learns the router.

In step S811, the router learning unit 884 transmits the acquired router information to the display 888, and the display 888 displays the router information.

Thereafter, a router address request packet is transmitted based on the acquired router LAN address to acquire the router WAN address (S803), and the subsequent processing is executed.

(2) Learning and Displaying Communication Equipment

Next, communication equipment learning and displaying will be explained.

In step S812, when the communication device 750 searches for a communication equipment (S804), based on the router WAN address acquired by the address learning unit 885, the address generation unit 881 generates an address for predicting communication equipment addresses. The address generation unit 881, as in the router search, based on the WAN address of the router, conjectures and generates addresses of communication equipments connected to the network on the same hierarchy tier as the higher level router located more to the WAN side. As in the foregoing, when the class C address is used, the lowest 8 bits of the router WAN address are changed within the range of 1 through 254, thereby conjecturing and generating addresses of communication equipments connected under the higher level router.

In step S813, to the address generated by the address generation unit 881, the packet transmission unit 882 transmits an equipment search packet for searching for a communication equipment.

In step S814, the packet reception unit 886 determines whether a response packet in response to the transmitted equipment search packet has been received. If the packet reception unit 886 has not received a response packet after a certain period of time, the address generation unit 881 generates an address for the subsequent equipment search packet. A plurality of equipment search packets can be simultaneously transmitted.

In step S815, when determination is made that the packet reception unit 886 has received a response packet in response to the transmitted equipment search packet, the address learning unit 885 acquires the communication equipment address from the response packet.

In step S816, the equipment learning unit 887 acquires and stores communication equipment property information based on the acquired communication equipment address.

In step S817, the display 888 displays the acquired communication equipment information.

In steps S818, S819, the address learning unit 885 determines whether all addresses capable of being generated for predicting communication equipment address have been generated (S818), and when determination is made that all have been generated, terminates the search (S819).

Acquisition of Router and Communication Equipment Addresses

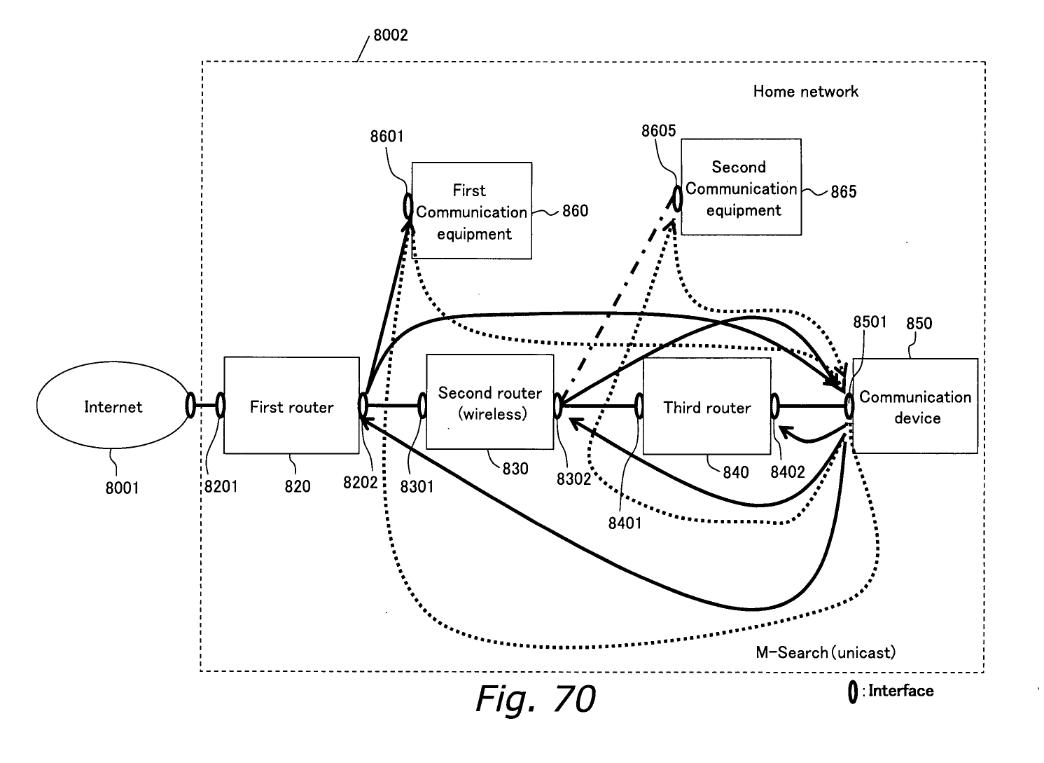

An explanation will be given of a method for acquiring router and communication equipment configuration in a network as described above, with reference to FIG. 70. FIG. 70 is a diagram for explaining a method for router detection.

The communication device 850 designates a router as a device to be searched for, and transmits in multicast mode a UPnP M-SEARCH request. If a router exists on the communication path, the router responds to the packet transmitted from the communication device 850. The communication device 850 can acquire the LAN address of the router to which the communication device 850 is directly connected from the response information. In this case, the communication device 850 acquires the address of the LAN side communication interface 8402 of the third router 840.

Next, to the LAN address of the third router 840, the communication device 850 transmits a request packet for acquiring the WAN address of the third router 840. The communication device 850 receives the response packet from the third router 840, and acquires the WAN address of the third router 840. Here, the communication device 850 makes a Get External IP Address request stipulated by UPnP IGD with respect to the third router 840. The Get Eternal IP Address response packet is transmitted from the third router 840 to the communication device 850, enabling the communication device 850 to acquire the WAN address of the third router 840 from this response packet.

To conjecture the LAN address of the second router 830, the communication device 850 generates an address in which a unit of the WAN address of the third router 840 has been changed. The LAN address of the second router 830 exists in the third network 803, which is the same network as that of the WAN side communication interface 8401 of the third router 840. The communication device 850 transmits a search packet for searching for a router to the generated address. When the communication device 850 receives a response packet from the second router 830, it thereby discovers the second router 830 in the network, for which it was searching. Further, by receiving the response packet, the communication device 850, learns that this is the LAN address of the second router 830, from the address prepared by the communication device 850.

Here, the communication device 850 transmits in unicast mode a UPnP M-SEARCH request to the generated address, and searches for the router as a device subject to search. Until the router is discovered, the communication device 850 generates LAN addresses and transmits M-SEARCH requests to the generated addresses. Thus the communication device 850, by receiving M-SEARCH responses, discovers routers in the network.

As in the case of learning router LAN address, a conjectured address is generated for the communication equipment, and the search packet for searching the communication equipment is transmitted. The communication device 850 receives the response packet with respect to the search packet, thereby recognizing that there is a communication equipment at the generated address.

Further, an explanation was given of a configuration where based on instructions from the address learning unit 885, the address generation unit 881 generates addresses sequentially, and the packet transmission unit 882 transmits packets to such addresses sequentially. Alternatively, the address generation unit 881 can generate a plurality of addresses at once, and the packet transmission unit 882 simultaneously transmits packets to the generated plurality of addresses. For example, when the LAN address of the first router 820 is a class C address, the address generation unit 881 generates addresses in which the lowest 8 bits have been changed within the range of 1 through 254 all at once, and the packet transmission unit 882 transmits search packets to the generated addresses all at once.

### Specific Example

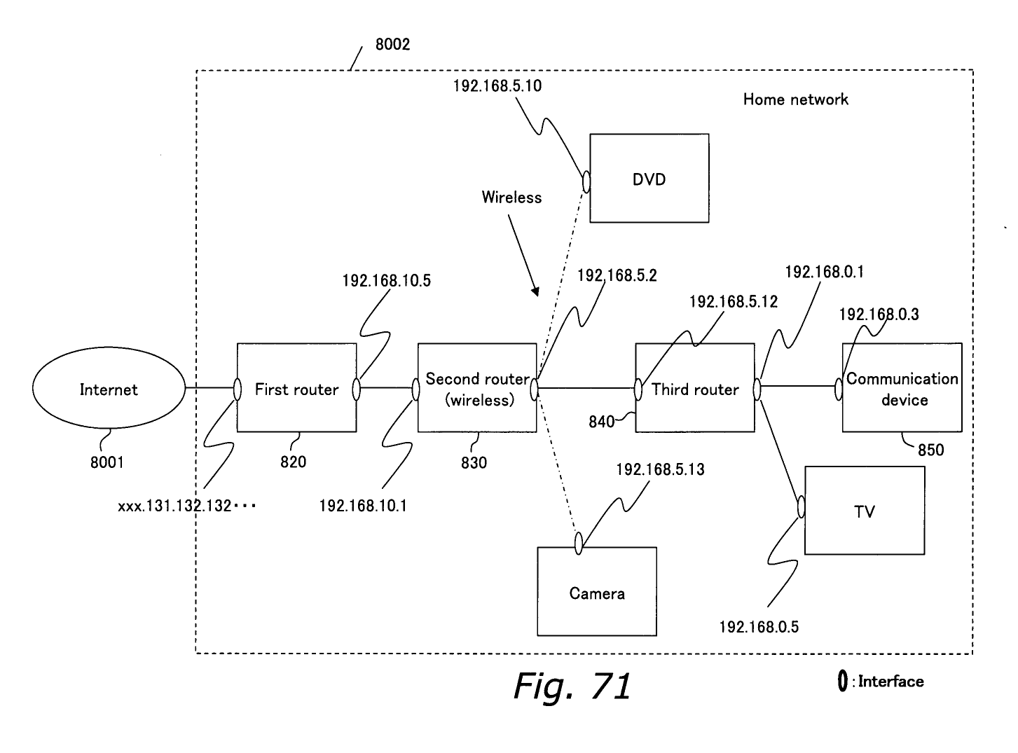

FIG. 71 is a diagram for showing a specific configuration example of a home network. As shown in FIG. 71, let us assume that the communication device 850 recognizes the LAN address “192.168.0.1” of the third router, to which it is directly connected. Here, the communication device 850 conjectures addresses of communication equipments having a communication function connected to the third router 840 and transmits search packets thereto, and acquires the address “192.168.0.5” from a response packet transmitted from a communication equipment. The communication device 850 transmits a packet requesting equipment information to this address and receives a response packet. Thus, property information to the effect, for example, that this communication equipment is a TV, can be acquired.

Further, the communication device 850 transmits a packet requesting WAN address to the third router 840, and acquires the WAN address “192.168.5.12” of the third router 840. Based on the WAN address of the third router 840, the communication device 850 conjectures the LAN address of the second router 830 and addresses of the communication equipments 210, 220 and transmits search packets thereto. The communication device 850 receives response packets from the communication equipments, thereby acquiring “192.168.5.2,” “192.168.5.10,” and “192.168.5.13.” Further, the communication device 850 transmits request packets to these communication equipment addresses, and acquires property information of each. Here, the property information includes equipment location, user friendly name, equipment status, icon state, and model number. As a result, the communication device 850 can acquire property information to the effect that communication equipments are a DVD recorder and camera.

Further, the communication device 850 transmits an address request packet to the second router 830, and acquires the WAN address “192.168.10.1” of the second router 830.

The communication device 850 conjectures the LAN address of the first router 820 based on the WAN address of the second router 830, and transmits a router search packet. The communication device 850 receives a response packet in response to this router search packet, thereby acquiring the LAN address “192.168.10.5” of the first router 820.

Further, the communication device 850 transmits an address request packet to the first router 820, and acquires the WAN address of the first router 820, “xxx.131.132.132.” The WAN address of this first router 820 is a global address. Therefore, the communication device 850 is capable of detecting that this first router 820 is connected to the Internet, thereby recognizing that the configuration of the home network was fully learned at this point.

In the present embodiment, in the sequence for transmitting and receiving search packets for searching for a router and search packets for searching for an equipment, a single packet is transmitted and received at a time; alternatively, a plurality of search packets can be simultaneously transmitted and received.

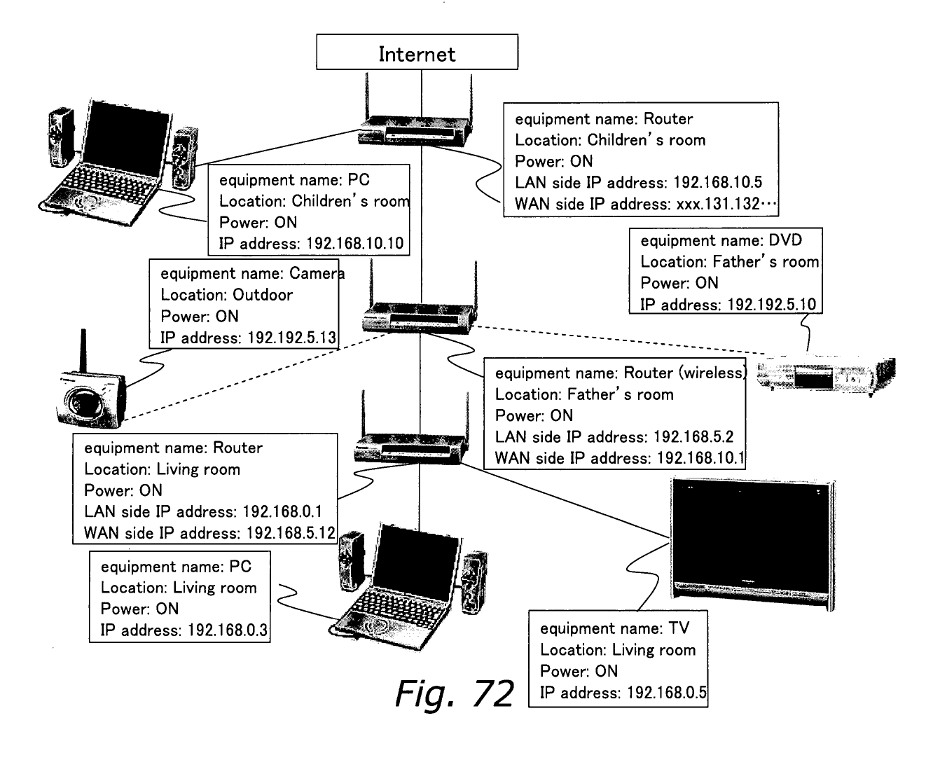

The communication device 850 displays on the screen router and communication equipment information acquired in the manner described above, enabling a user to learn network configuration even in a network comprising routers in multiple stages. FIG. 72 is one example of the network configuration displayed by the communication device display. As shown in FIG. 72, the router and communication equipment connection configuration is shown on the display.

Effects

The communication device according to this embodiment is capable of acquiring router configuration without preparing and transmitting into a home network router discovery packets in which the TTL has been changed. Further, even when a home network comprises a router that does not decrement the TTL at time of forwarding the router discovery packet, the router configuration of the home network can be learned. Further still, even when a home network comprises a router that filters response packets, the router configuration of the home network can be learned.

### TENTH EMBODIMENT

### Router Detection Using ICMP and UPnP

A tenth embodiment of the present invention will be explained with reference to the drawings.

Overall Constitution

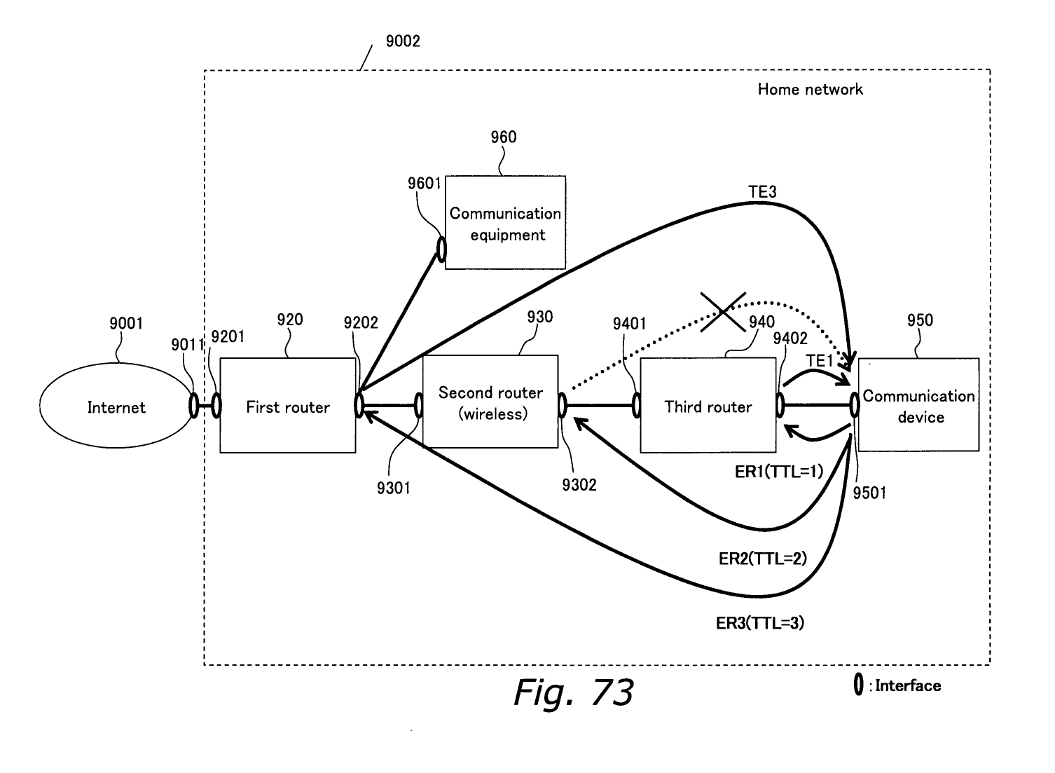

FIG. 73 shows a block diagram of the home network according to the tenth embodiment of the present invention. In FIG. 73, an Internet 9001 and home network 9002 are connected to each other. The home network 9002 comprises a first router 920, second router 930, and third router 940 in multiple stages; the third router 940 has connected thereto a communication device 950 functioning as a network configuration detection device thereunder. Further, the first router 920 has connected thereto a first communication device 960. Here, the routers and communication devices are connected to one another via the LAN side interface communications and WAN side interface communications 9201, 9202, 9301, 9302, 9401, 9402, 9501, and 9601.

Communication Device Configuration

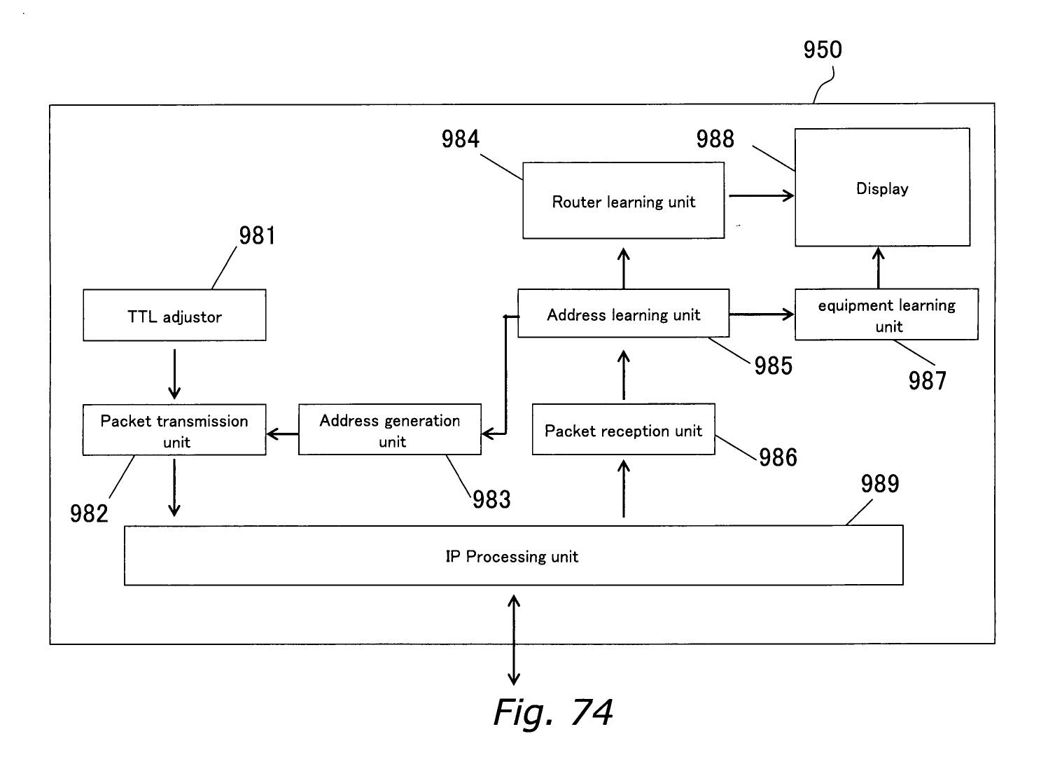

FIG. 74 is a functional block diagram showing the configuration of a communication device.

The communication device 950 comprises a TTL adjustor 981, packet transmission unit 982, address generation unit 983, router learning unit 984, address learning unit 985, packet reception unit 986, equipment learning unit 987, display 988, and IP processing unit 989.

Processing flow

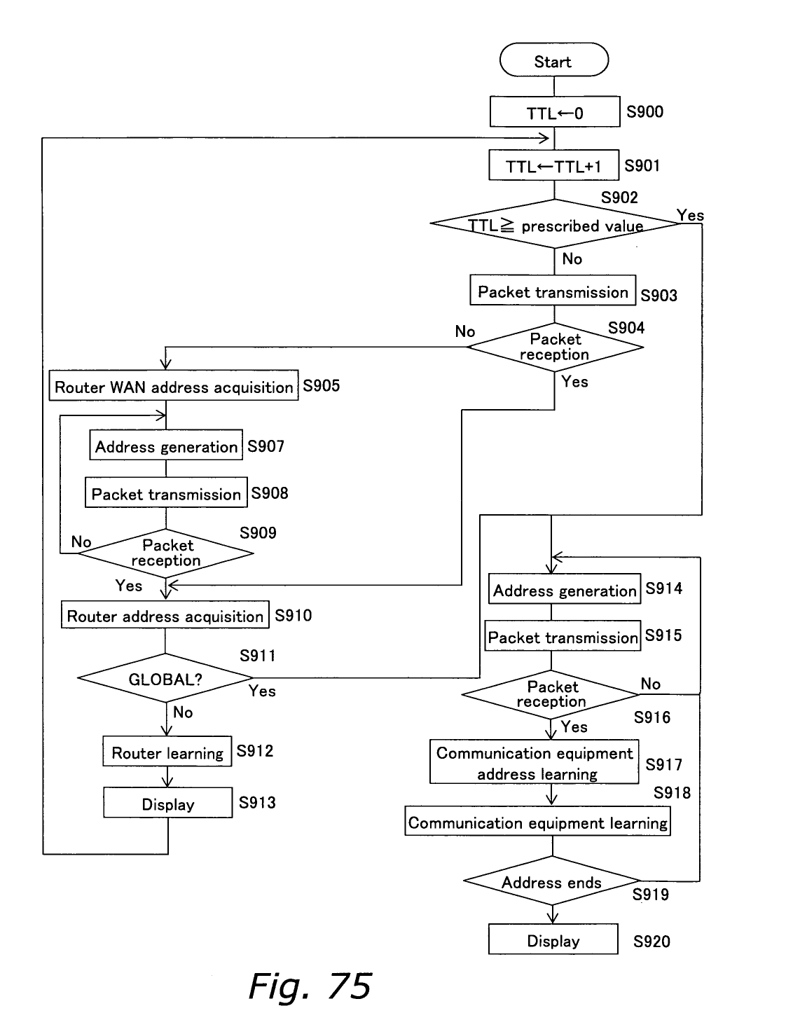

FIG. 75 is one example of a flowchart showing operations of the communication device 950.

In steps S900, S901, the TTL adjustor 981 initializes the TTL value (S900), and increments the TTL value (S901).

In step S902, the TTL adjustor 981 determines whether the TTL value exceeds a prescribed value. If the TTL value exceeds a prescribed value set in advance, the router detection processing ends, and control proceeds to step S914.

In step S903, if the TTL value does not exceed the prescribed value, the packet transmission unit 982 transmits a search packet for router detection.

In step S904, the packet reception unit 786 receives a response packet sent in response from a router. If a response packet is received, control proceeds to step S910, and if a response packet is not received, control proceeds to step S905.

In step S905, if the packet reception unit 986 determines that a Time Exceed message packet has not been sent in response after a certain period of time, the address learning unit 985 acquires the WAN address of a router at a lower level than the router from which no Time Exceed message was received.

In steps S907, S908, the address generation unit 983 generates an address for conjecturing the LAN address of the router located at a higher level than router having the WAN address acquired by the address learning unit 985 (S907), and the packet transmission unit 982 transmits a search packet to such address (S908).

In steps S909, S910, the packet reception unit 986 receives a response packet in response to the transmitted search packet (S909), and the address learning unit 985 acquires the LAN address of the router (S910).

In step S911, the address learning unit 985 determines whether the LAN address of the acquired router is a global address or local address.

In steps S912, S913, based on the LAN address of the acquired router, the router learning unit 984 acquires router information and learns this router (S912). The display 988 displays the acquired router information (S913).

In step S914, if the address learning unit 985 has determined that the LAN address of the router is a global address, this router is recognized to be a router on the Internet outside of the home network, and stops the router search. Based on the acquired router LAN address, the address generation unit 983 conjectures and generates addresses for communication equipments subject to search.

In step S915, the packet transmission unit 982 transmits a search packet for detecting a communication equipment to an address generated by the address generation unit 983. The packet reception unit 986 receives a response packet from a communication equipment existing on the network, and the address learning unit 985 acquires the address of such communication equipment.

In steps S916 through S918, the packet reception unit 986 receives a response packet in response to a search packet transmitted from the communication equipment (S916), and determines whether the communication equipment address has been acquired (S917). The address learning unit 985 acquires communication equipment address. Next, the equipment learning unit 987 acquires communication equipment information relating to the communication equipment (S918).

In steps S919, S920, the address generation unit 983 determines whether an address for a subsequent search packet is to be generated (S919). Upon termination of address generation, the display 988 displays acquired communication equipment information on the display 988 (S920).

An alternative to an ICMP packet as packet for communication equipment search is an ARP (Address Resolution Protocol) packet for requesting a physical layer network address based on an IP address.

With the present embodiment, by using ICMP and UPnP simultaneously in a network comprising a router that does not make TTL 0 and give reply, network configuration is efficiently learned. However, even with routers that do not process TTL or routers that filter ICMP packets, by using ICMP and UPnP simultaneously, network configuration is efficiently learned.

### Specific Example

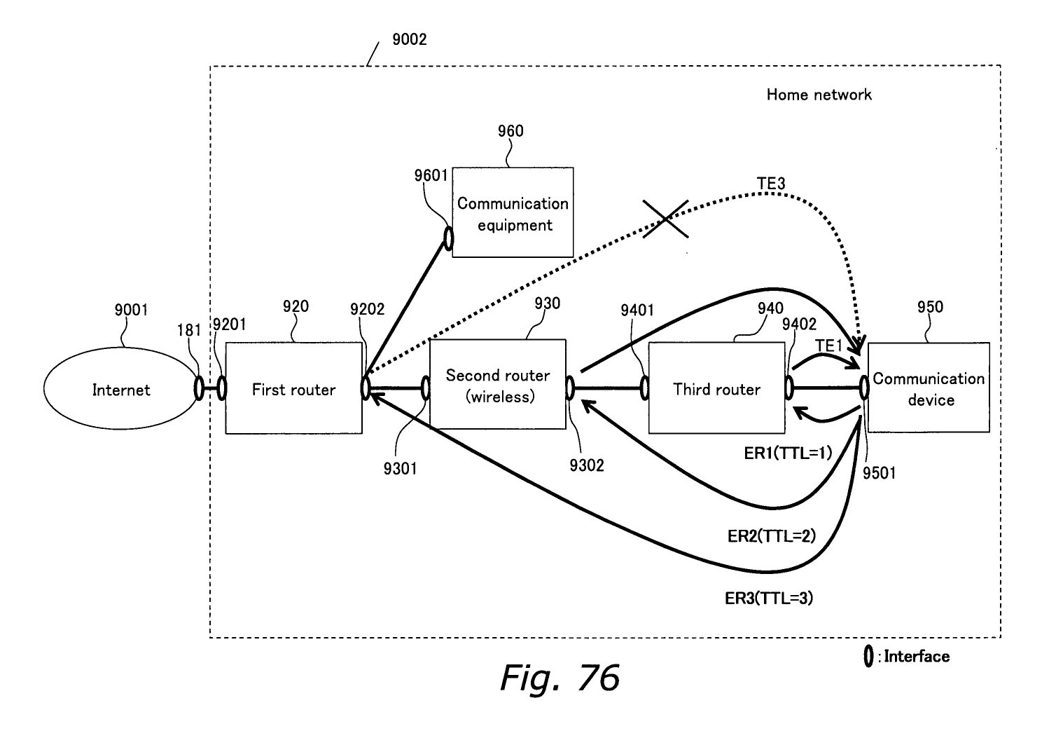

FIG. 76 is a block diagram of a network comprising a router that filters a packet. As shown in FIG. 76, if there is a first router 920 that filters ICMP packets, there is no response from the router even when an ICMP packet has been transmitted thereto. Thus, ICMP processing is carried out until a router responds to a transmitted ICMP packet (here, second router 930). The LAN address of the second router 930 learned in the ICMP processing is used to learn the WAN address of the second router 930 and the LAN address of the first router 920. Thus by using ICMP and UPnP, even when there is a router that filters ICMP packets, network configuration can be easily learned. Communication equipment search is carried out based on router addresses thus acquired.

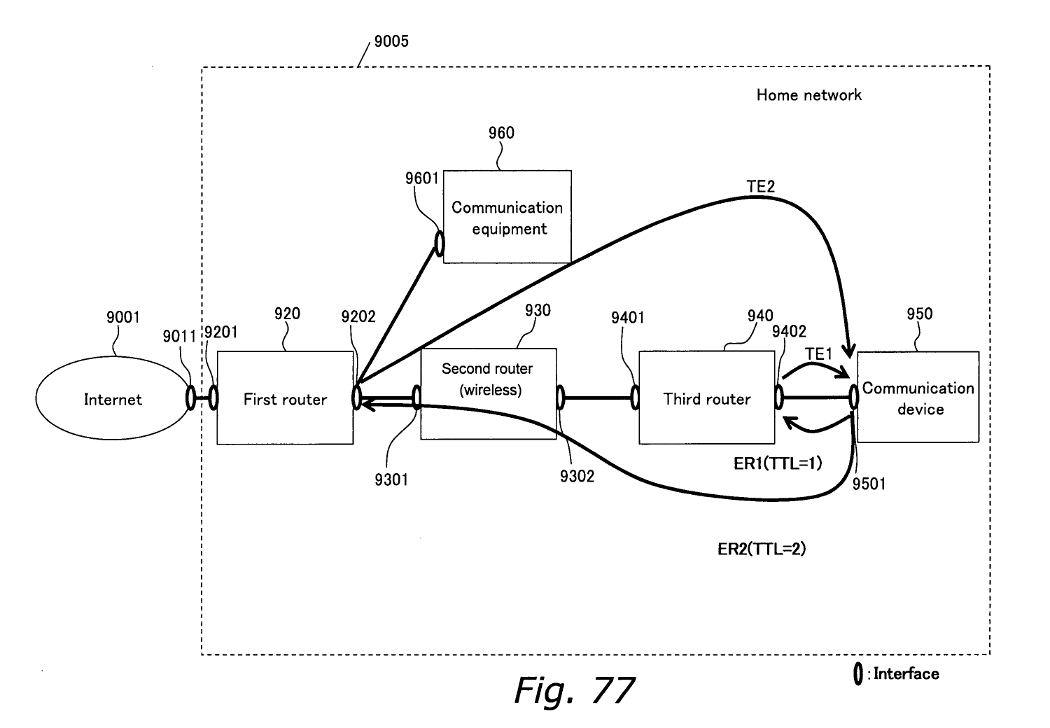

FIG. 77 is a block diagram of a network comprising a router that does not process TTL. If as shown in FIG. 77, the second router 930 does not process TTL, when an ICMP Echo Request message packet ER2 in which TTL=2 is transmitted, the packet arrives at the first router 920. If left as such, the communication device 950 will fail to learn the presence of the second router 930. For this reason, UPnP is used to verify router address. The communication device 950 thereby learns the presence of the second router 930.

The communication device 950 learns the WAN address of the third router 940 using UPnP. The communication device 950 compares the LAN address of the first router 920 acquired using ICMP with its WAN address. If no second router 930 exists between the third router 940 and first router 920, the WAN address of the third router 940 and the LAN address of the first router 920 will have the same address space. However, because of the existence of the second router 930, the address spaces are different. Thus the communication device 950 can learn that another router exists between the first router 920 and third router 940. The communication device 950 acquires the LAN address of the second router 930 using UPnP, and learns the WAN address of the second router 930. Next, the communication device 950 compares the WAN address of the second router 930 and the LAN address of the third router 940. If they have the same address space, it is learned that that no other router exists. Thus, UPnP and ICMP are used to verify router address, and the router presence can be efficiently learned even when there exists a router that does not process TTL. Communication equipment search is carried out based on the router address thus learned.

Effects

Even when a home network comprises a router that forwards a router discovery packet to the subsequent router without decrementing the TTL, a communication device can learn router and communication equipment configuration in the home network.

### OTHER EMBODIMENTS

The above embodiments disclose a configuration wherein a communication device connected to a home network comprising multiple routers can learn the configuration information of such multiple routers. However, no limitation is placed on the number of routers within a home network, and the present invention can also be applied to a home network having, for example, a single router.

The present invention includes a computer program for causing a computer to execute the above method, and a computer readable recording medium on which such program is recorded. Examples of commuter readable recording medium include flexible disk, hard disk, CD-ROM, MO, DVD-ROM, DVD-RAM, BD (Blue-ray Disc), and semiconductor memory.

The computer program is not limited to a program recorded on a recording medium, and may include programs transmitted across telecommunication lines, wireless or wired communication lines, or the Internet and other networks.

### INDUSTRIAL APPLICABILITY

With the present invention, router settings can be performed for a home network comprising multiple routers. Further, P2P communications can be made between user terminals connected in a home network comprising multiple routers.

1. A communication device in a home network connected to a wide area network and comprising a plurality of routers connected in multiple stages, such device comprising:
internal address acquisition means for acquiring a router home network address (“internal address”); and
external address acquisition means for acquiring a router wide area network address (“external address”),
wherein
external address acquisition means repeats the process of accessing a router based on the internal address acquired by internal address acquisition means and acquiring the external address of the router; and
internal address acquisition means repeats the process of acquiring the internal address of a router positioned more toward the wide area network than the router having the external address, based on the external address acquired by external address acquisition means.

2. A communication device according to claim 1 further comprising:
router discovery packet preparation means for preparing a router discovery packet having a variable as the allowed hop count number;
router discovery packet transmission means for transmitting the router discovery packet so as to pass through a plurality of routers in the home network;
router response packet reception means for receiving from the plurality of routers in response to the router discovery packet a plurality of router response packets having the respective router address; and
router address acquisition means for extracting router address from router response packets.

3. A communication device according to claim 1 further comprising relay information setting means for accessing a router based on the acquired internal address to perform relay information settings for relaying communications with another communication device connected via routers connected in multiple stages.

4. A communication device according to claim 1 further comprising second determination means for determining whether an external address newly acquired by external address acquisition means is a global address which is the external address of a gateway connecting the home network and wide area network,
wherein
when the external address is a global address, internal address acquisition means stops new acquisition of internal address, and external address acquisition means stops new acquisition of external address.

5. A communication device according to claim 1,
wherein
internal address acquisition means prepares as a router internal address a test address in which a unit of the external address acquired by external address means has been changed; and
external address acquisition means, based on the test address, accesses a router positioned more toward the wide area network than the router having the external address to acquire the external address of such router.

6. A communication device according to claim 1 further comprising:
equipment discovery packet preparation means for preparing an equipment discovery packet for detecting a communication equipment connected to any given router based on the acquired external address;
equipment discovery packet transmission means for transmitting the equipment discovery packet to at least one communication equipment;
equipment response packet reception means for receiving, in response to the equipment discovery packet, an equipment response packet having communication equipment address from at least one communication equipment; and
equipment address acquisition means for extracting equipment address from the equipment response packet.

7. A communication device according to claim 6 further comprising communication setting means for accessing a communication equipment based on the extracted equipment address and performing settings for communicating with the communication equipment at either such communication equipment or communication device itself.

8. A communication device according to claim 6 further comprising an equipment learning unit for accessing a communication equipment based on an extracted equipment address to learn address and property information of such communication equipment.

9. A communication device according to claim 8 further comprising a display for displaying communication address and property information acquired by the equipment learning unit.

10. A communication device according to claim 1 in a first home network comprising a plurality of routers connected in multiple stages further comprising:
a router configuration information transmission unit for transmitting router configuration information of some of the plurality of routers connected in multiple stages, including the router to which the communication device itself is connected, to another communication device in the first home network or another communication device in a second home network connected to the first home network via a wide area network; and
a communication determination unit for receiving router configuration information of some of the plurality of routers from the other communication device, and based on its own router configuration information and the received router configuration information, determining whether communications can be made with the other communication device,
wherein
the router configuration information is based on the internal address of each communication device acquired by internal address acquisition means and/or the external address acquired by external address acquisition means.

11. A communication device according to claim 10 further comprising relay information setting means for, based on router configuration information, performing relay information settings for relaying communications with another communication device with respect to each router.

12. A communication device according to claim 11,
wherein
router configuration information contains router addresses which are an internal and/or external address of routers in the home network from the communication device to the border router connecting the home network and wide area network; and
the communication determination unit comprises branch address extraction means for determining, in order from router addresses more toward the wide area network, match/non-match between a router address contained in its own router configuration information and a router address contained in the router configuration information of the other communication device to extract an address at the communication path branch point where non-match was initially determined, and
the communication determination unit uses the extracted branch address to determine whether communications can be made with the other communication device.

13. A communication device according to claim 11
wherein
router configuration information contains router addresses which are an internal and/or external address of routers in the home network from the communication device to the border router connecting the home network and wide area network;
the communication determination unit comprises branch address extraction means for determining, in order from router addresses more toward the wide area network, match/non-match between a router address contained in its own router configuration information and a router address contained in the router configuration information of the other communication device to extract an address at the communication path branch point where non-match was initially determined, and branch address transmission means for transmitting the extracted branch address to relay information setting means;
based on its own router configuration information, relay information setting means accesses a router corresponding to the branch address and a router positioned between such router and its own communication device to perform relay information settings; and
branch address transmission means correlates relay information of a router corresponding to the branch address with the branch address and transmits the same to the other communication device performing communications.

14. A communication device in a home network connected to a wide area network and comprising a plurality of routers connected in multiple stages, such device comprising:
router discovery packet preparation means for preparing a router discovery packet having a variable as the allowed hop count number;
router discovery packet transmission means for transmitting the router discovery packet so as to pass through a plurality of routers in the home network;
router response packet reception means for receiving, in response to the router discovery packet, a plurality of router response packets containing the respective router addresses from the plurality of routers;
router address acquisition means for extracting the respective router address from the router response packet; and
processing requestee acquisition means for accessing a router based on the respective extracted router address and acquiring processing requestee information for making settings with respect to the router and/or acquiring information from the router.

15. A communication device according to claim 14 comprising relay information setting means for making access based on the requestee information acquired by processing requestee acquisition means to perform relay information settings for relaying communications with another communication device connected via routers connected in multiple stages.

16. A communication device according to claim 14
wherein
the router address is a home network address (“internal address”);
there is further provided external address acquisition means for accessing a router based on the processing requestee information and acquiring the wide area network address of the router (“external address”); and
based on the external address acquired by external address acquisition means, router address acquisition means repeats the process of acquiring the internal address of a router positioned more toward the wide area network than the router having such external address and outputting the acquired internal address to processing requestee acquisition means.

17. A communication device according to claim 14
wherein
the router address is the internal address;
there is further provided first determination means for determining whether the internal address is a global address used in the wide area network; and
when the internal address is a global address, relay information setting means stops relay information settings for the routers.

18. A communication device according to claim 14
wherein
the router address is the internal address;
there is further provided first determination means for determining whether the internal address is a global address used in the wide area network; and
when the internal address is a global address, router discovery packet preparation means stops preparing router discovery packets for allowed hop count numbers larger than the allowed hop count number set with respect to the router having a global address.

19. A communication device according to claim 14 in a first home network comprising a plurality of routers connected in multiple stages further comprising:
a router configuration information transmission unit for transmitting router configuration information of some of the plurality of routers connected in multiple stages, including the router to which the communication device itself is connected, to another communication device in the first home network or another communication device in the second home network connected with the first home network via the wide area network; and
a communication determination unit for receiving router configuration information of some of the other routers from among the plurality of routers from the other communication device, and based on its own router configuration information and the received router configuration information, determining whether communications can be made with the other communication device.

20. A communication device according to claim 19 further comprising relay information setting means for, based on router configuration information, performing relay information settings for relaying communications with another communication device with respect to each router.

21. A communication device according to claim 20
wherein
router configuration information comprises router addresses of routers within the home network from the communication device to the border router connecting the wide area network and the home network; and
the communication determination unit comprises branch address extraction means for determining, in order from router addresses more toward the wide area network, match/non-match between a router address contained in its own router configuration information and a router address contained in the router configuration information of the other communication device to extract an address at the communication path branch point where non-match was initially determined, and
the communication determination unit uses the extracted branch address to determine whether communications can be made with the other communication device.

22. A communication device according to claim 20
wherein
the router configuration information comprises router addresses of routers within the home network from the communication device to the border router connecting the wide area network and the home network;
the communication determination unit comprises branch address extraction means for determining, in order from router addresses more toward the wide area network, match/non-match between a router address contained in its own router configuration information and a router address contained in the router configuration information of the other communication device to extract an address at the communication path branch point where non-match was initially determined, and branch address transmission means for transmitting extracted branch address to relay information setting means;
based on its own router configuration information, relay information setting means accesses the router corresponding to the branch address and a router positioned between such router and its own communication device to perform relay information settings; and
branch address transmission means correlates relay information of the router corresponding to the branch address and branch address and transmits the same to the other communication device that is to make communications.

23. A communication device in a home network connected to a wide area network and comprising a plurality of routers connected in multiple stages, such device comprising:
router discovery packet preparation means for preparing a router discovery packet having a variable as the allowed hop count number;
router discovery packet transmission means for transmitting the router discovery packet to the plurality of routers in the home network;
router response packet reception means for receiving, in response to the router discovery packet, a plurality of router response packets containing the respective router addresses from the plurality of routers;
router address acquisition means for extracting the respective router address from the router response packet;
equipment discovery packet preparation means for preparing an equipment discovery packet for detecting a communication equipment connected to any given router based on the extracted router address;
equipment discovery packet transmission means for transmitting the equipment discovery packet to at least one communication equipment;
equipment response packet reception means for receiving, in response to the equipment discovery packet, an equipment response packet having an equipment address of the communication equipment from at least one communication equipment; and
device address acquisition means for extracting a device address from the device response packet.

24. A communication device according to claim 23 further comprising communication setting means for accessing a communication equipment based on the extracted equipment address, and performing settings for communicating with the communication equipment at either the communication equipment or communication device itself.

25. A communication device described in claim 23
wherein
the router address is the internal address;
there is further provided a first determination means for determining whether the internal address is a global address;
when the internal address is a global address, equipment discovery packet preparation by equipment discovery packet preparation means, equipment response packet reception by equipment response packet reception means, equipment address extraction by equipment address acquisition means, and settings for communicating with the communication equipment by communication setting means are stopped.

26. A communication device according to claim 23
wherein
equipment discovery packet preparation means prepares a plurality of equipment discovery packets containing as an equipment address a test address in which a unit of the extracted router address has been changed; and
equipment address acquisition means extracts the respective equipment address from the plurality of equipment response packets corresponding to the plurality of equipment discovery packets prepared based on the test address.

27. A communication device according to claim 23 further comprising an equipment learning unit for accessing a communication equipment based on the extracted equipment address to learn property information of the communication equipment.

28. A communication device according to claim 25 further comprising a display for displaying communication equipment address acquired by equipment address acquisition means and communication equipment property information acquired by the equipment learning unit.

29. A communication method for a communication device in a home network connected to a wide area network and comprising a plurality of routers connected in multiple stages, such method including:
an internal address acquisition step for acquiring a router home network address (“internal address”); and
an external address acquisition step for acquiring a router wide area network address (“external address”);
wherein
in the external address acquisition step the process of accessing a router based on the internal address acquired in the internal address acquisition step, and acquiring the external address of the router is repeated; and
in the internal address acquisition step, the process of acquiring the internal address of a router positioned more toward the wide area network than the router having such external address based on the external address acquired in the external address acquisition step is repeated.

30. A communication program executed by a communication device in a home network connected to the wide area network and comprising a plurality of routers connected in multiple stages for causing the communication device to function as internal address acquisition means for acquiring a router home network address (“internal address”), and external address acquisition means for acquiring a router wide area network address (“external address”)
wherein
external address acquisition means repeats the process of accessing a router based on the internal address acquired by internal address acquisition means and acquiring the external address of the router; and
internal address means repeats the process of acquiring, based on the external address acquired by external address acquisition means, the internal address of a router positioned more toward the wide area network than the router having such external address.

31. A computer readable recording medium on which is recorded a communication program executed by a communication device in a home network connected to a wide area network and comprising a plurality of routers connected in multiple stages, causing execution of the internal address acquisition step for acquiring a router home network address (“internal address”), and the external address acquisition step for acquiring a router wide area network address (“external address”)
wherein
external address acquisition means repeats the process of accessing a router based on the internal address acquired by internal address acquisition means and acquiring the external address of the router; and
internal address means repeats the process of acquiring, based on the external address acquired by external address acquisition means, the internal address of a router positioned more toward the wide area network than the router having such external address.

32. A communication method for a communication device connected to a wide area network and comprising a plurality of routers connected in multiple stages comprising:
a router discovery packet preparation step for preparing a router discovery packet having a variable as the allowed hop count number;
a router discovery packet transmission step for transmitting the router discovery packet so as to pass through a plurality of routers in the home network;
a router response packet reception step for receiving, in response to the router discovery packet, a plurality of router response packets containing the respective router addresses from the plurality of routers;
a router address acquisition step for extracting the respective router address from the router response packet; and
a processing requestee acquisition step for accessing a router based on the extracted router address to acquire processing requestee information for making router settings and/or acquiring information from the router.

33. A communication program executed by a communication device in a home network connected to a wide area network and comprising a plurality of routers connected in multiple stages and causing the communication device to function as:
router discovery packet preparation means for preparing a router discovery packet having a variable as the allowed hop count number;
router discovery packet transmission means for transmitting the router discovery packet so as to pass through a plurality of routers in the home network;
router response packet reception means for receiving, in response to the router discovery packet, a plurality of router response packets containing the respective router addresses from the plurality of routers;
router address acquisition means for extracting the respective router address from the router response packet; and
processing requestee acquisition means for accessing a router based on the extracted router address to acquire processing requestee information for making settings with respect to the router or acquiring information from the router.

34. A computer readable recording medium on which is recorded a communication program executed by a communication device in a home network connected to a wide area network and comprising a plurality of routers connected in multiple stages, such method comprising:
a router discovery packet preparation step for preparing a router discovery packet having a variable as the allowed hop count number;
a router discovery packet transmission step for transmitting the router discovery packet so as to pass through a plurality of routers in the home network;
a router response packet reception step for receiving, in response to the router discovery packet, a plurality of router response packets containing the respective router addresses from the plurality of routers;
a router address acquisition step for extracting the respective router address from the router response packet; and
a processing requestee acquisition step for accessing a router based on the extracted router address to acquire processing requestee information for making settings with respect to a router and/or acquiring information from a router.

35. A communication method for a home network connected to a wide area network and comprising a plurality of routers connected in multiple stages, such method comprising:
a router discovery packet preparation step for preparing a router discovery packet having a variable as the allowed hop count number;
a router discovery packet transmission step for transmitting the router discovery packet to a plurality of routers in the home network;
a router response packet reception step for receiving, in response to the router discovery packet, a plurality of router response packet containing each router address from the plurality of routers;
a router address acquisition step for extracting the respective router address from the router response packet;
an equipment discovery packet preparation step for preparing an equipment discovery packet for detecting a communication equipment connected to any given router based on the extracted router address;
an equipment discovery packet transmission step for transmitting the equipment discovery packet to at least one communication equipment;
an equipment response packet reception step for receiving, in response to the equipment discovery packet, an equipment response packet having an equipment address of the communication equipment from at least one communication equipment; and
an equipment address acquisition step for extracting an equipment address from the equipment response packet.

36. A communication program executed by a communication device in a home network connected to a wide area network and comprising a plurality of routers connected in multiple stages, such program causing the communication device to function as:
router discovery packet preparation means for preparing a router discovery packet having a variable as the allowed hop count number;
router discovery packet transmission means for transmitting the router discovery packet to a plurality of routers in the home network;
router response packet reception means for receiving, in response to the router discovery packet, a plurality of router response packets containing the respective router addresses from the plurality of routers;
router address acquisition means for extracting the respective router address from the router response packet;
equipment discovery packet preparation means for preparing an equipment discovery packet for detecting a communication equipment connected to any given router based on the extracted router address;
equipment discovery packet transmission means for transmitting the equipment discovery packet to at least one communication equipment;
equipment response packet reception means for receiving, in response to the equipment discovery packet, an equipment response packet having an equipment address of a communication equipment from at least one communication equipment; and
equipment address acquisition means for extracting an equipment address from the equipment response packet.

37. A computer readable recording medium on which is recorded a communication program executed by a communication device in a home network connected to a wide area network and comprising a plurality of routers connected in multiple stages, such program causing the execution of:
a router discovery packet preparation step for preparing a router discovery packet having a variable as the allowed hop count number;
a router discovery packet transmission step for transmitting the router discovery packet to a plurality of routers in the home network;
a router response packet reception step for receiving, in response to the router discovery packet, a plurality of router response packets containing the respective router address from the plurality of routers;
a router address acquisition step for extracting the respective router address from the router response packet;
an equipment discovery packet preparation step for preparing an equipment discovery packet for detecting a communication equipment connected to any given router based on the extracted router address;
an equipment discovery packet transmission step for transmitting the equipment discovery packet to at least one communication equipment;
an equipment response packet reception step for receiving, in response to the equipment discovery packet, an equipment response packet having an equipment address of a communication equipment from at least one communication equipment; and
an equipment address acquisition step for extracting an equipment address from the equipment response packet.
